(19) United States
(12) Patent Application Publication
(10) Pub. No.: US 2025/0119955 A1
(43) Pub. Date: Apr. 10, 2025

(54) METHOD AND APPARATUS FOR UPLINK TRANSMISSION TO TRANSMISSION AND RECEPTION POINT WITH REDUCED FUNCTIONALITY IN A WIRELESS COMMUNICATION SYSTEM

(71) Applicant: ASUS Technology Licensing Inc., Taipei City (TW)

(72) Inventors: Chun-Wei Huang, Taipei City (TW); Yi-Hsuan Kung, Taipei City (TW); Yu-Hsuan Guo, Taipei City (TW)

(21) Appl. No.: 18/902,465

(22) Filed: Sep. 30, 2024

Related U.S. Application Data
(60) Provisional application No. 63/542,484, filed on Oct. 4, 2023.

(51) Int. Cl. H04W 74/0833; H04W 72/23

(52) U.S. Cl. CPC H04W 74/0833; H04W 72/23

(57) ABSTRACT

Methods, systems, and apparatuses are provided for uplink transmission to transmission and reception point with reduced functionality in a wireless communication system, wherein a method comprises receiving a Physical Downlink Control Channel (PDCCH) order from a first Transmission/Reception Point (TRP) of a serving cell, wherein a field in the PDCCH order indicates an association between a Physical Random Access Channel (PRACH) transmission and the first TRP with Downlink (DL) and Uplink (UL) functionality or an association between the PRACH transmission and a second TRP, of the serving cell, without DL functionality or with reduced DL functionality, and performing the PRACH transmission in response to the PDCCH order, wherein a transmit power of the PRACH transmission is determined based on the field.

### CROSS-REFERENCE TO RELATED APPLICATIONS

The present application claims priority to and the benefit of U.S. Provisional Patent Application Ser. No. 63/542,484, filed Oct. 4, 2023, which is fully incorporated herein by reference.

### FIELD

This disclosure generally relates to wireless communication networks and, more particularly, to a method and apparatus for uplink transmission to transmission and reception point with reduced functionality in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for uplink transmission to transmission and reception point with reduced functionality in a wireless communication system, wherein a method comprises receiving a Physical Downlink Control Channel (PDCCH) order from a first Transmission/Reception Point (TRP) of a serving cell, wherein a field in the PDCCH order indicates an association between a Physical Random Access Channel (PRACH) transmission and the first TRP with Downlink (DL) and Uplink (UL) functionality or an association between the PRACH transmission and a second TRP, of the serving cell, without DL functionality or with reduced DL functionality, and performing the PRACH transmission in response to the PDCCH order, wherein a transmit power of the PRACH transmission is determined based on the field.

In various embodiments, a method for a UE in a wireless communication system comprises receiving a PDCCH order from a first TRP of a serving cell, wherein a field in the PDCCH order is related to a PRACH transmission initiated by the PDCCH order to the first TRP with DL and UL functionality or to a second TRP, of the serving cell, without DL functionality or with reduced DL functionality, and performing the PRACH transmission in response to the PDCCH order, wherein a transmit power of the PRACH transmission is determined based on the field.

In various embodiments, a method for a UE in a wireless communication system comprises receiving one or more DL signals indicating a first Transmission Configuration Indicator (TCI) state and a second TCI state, receiving a PDCCH order in a serving cell via the first TCI state, wherein a field in the PDCCH order indicates an association between a PRACH transmission and the first TCI state or an association between the PRACH transmission and the second TCI state, and performing the PRACH transmission in response to the PDCCH order, wherein a transmit power of the PRACH transmission is determined based on the field.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 6.1.3.47-1: Unified TCI state activation/deactivation MAC CE, from 3GPP TS 38.321, V17.5.0 (2023 June).

FIG. 6 is a reproduction of FIG. 6.1.3.15-1: TCI State Indication for UE-specific PDCCH MAC CE, from 3GPP TS 38.321, V17.5.0 (2023 June).

FIG. 7 is an example diagram showing that for a UL only TRP, both TRP1 and TRP2 are intra-cell TRPs (i.e., TRP1 and TRP2 are in a same serving cell), and the UE may receive DL from TRP1 (e.g., DL) while transmitting UL to TRP2 (e.g., UL2), in accordance with embodiments of the present invention.

FIG. 8 is a flow diagram of a method of a UE comprising receiving configuration of a UL only TRP and receiving a PDCCH order from a network node, and performing PRACH transmission in response to the PDCCH order, in accordance with embodiments of the present invention.

FIG. 9 is a flow diagram of a method of a UE comprising receiving a PDCCH order from a first TRP of a serving cell, wherein a field in the PDCCH order indicates an association between a PRACH transmission and the first TRP with DL and UL functionality or an association between the PRACH transmission and a second TRP, of the serving cell, without DL functionality or with reduced DL functionality, and performing the PRACH transmission in response to the PDCCH order, wherein a transmit power of the PRACH transmission is determined based on the field, in accordance with embodiments of the present invention.

FIG. 10 is a flow diagram of a method of a UE comprising receiving a PDCCH order from a first TRP of a serving cell, wherein a field in the PDCCH order is related to a PRACH transmission initiated by the PDCCH order to the first TRP with DL and UL functionality or to a second TRP, of the serving cell, without DL functionality or with reduced DL functionality, and performing the PRACH transmission in response to the PDCCH order, wherein a transmit power of the PRACH transmission is determined based on the field, in accordance with embodiments of the present invention.

FIG. 11 is a flow diagram of a method of a UE comprising receiving one or more DL signals indicating a first TCI state and a second TCI state, receiving a PDCCH order in a serving cell via the first TCI state, wherein a field in the PDCCH order indicates an association between a PRACH transmission and the first TCI state or an association between the PRACH transmission and the second TCI state, and performing the PRACH transmission in response to the PDCCH order, wherein a transmit power of the PRACH transmission is determined based on the field.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] 3GPP TS 38.331, V17.5.0 (2023-06), 3rd Generation Partnership Project; Technical Specification Group Radio Access Network; NR; Radio Resource Control (RRC) protocol specification (Release 17); [2] 3GPP TS 38.321, V17.5.0 (2023-06), 3rd Generation Partnership Project; Technical Specification Group Radio Access Network; NR; Medium Access Control (MAC) protocol specification (Release 17); [3] 3GPP TS 38.214, V17.6.0 (2023-06), 3rd Generation Partnership Project; Technical Specification Group Radio Access Network; NR; Physical layer procedures for data (Release 17); [4] 3GPP TS 38.213, V17.6.0 (2023-06), 3rd Generation Partnership Project; Technical Specification Group Radio Access Network; NR; Physical layer procedures for control (Release 17); and [5]3GPP TS 38.212, V17.5.0 (2023-03), 3rd Generation Partnership Project; Technical Specification Group Radio Access Network; NR; Multiplexing and channel coding (Release 17). The standards and documents listed above are hereby expressly and fully incorporated herein by reference in their entirety.

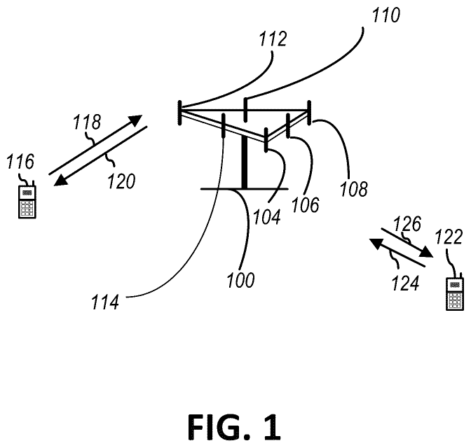

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

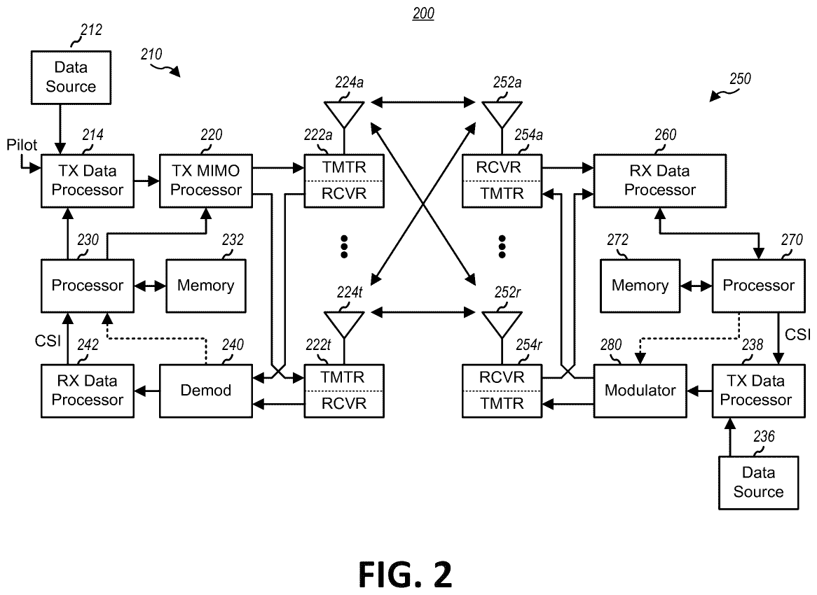

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T}“detected” symbol streams.

The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

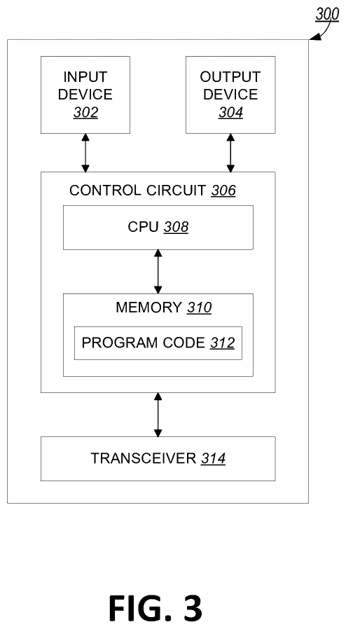

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the N_{R} system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

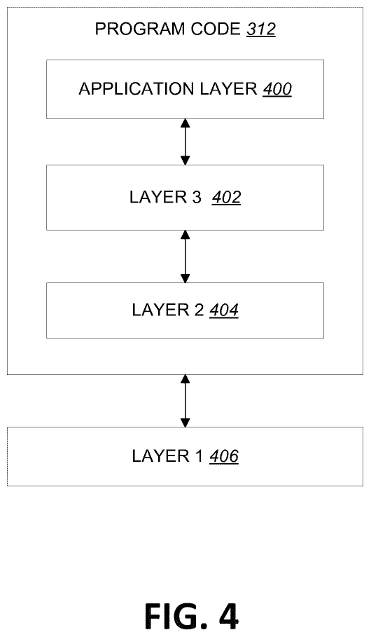

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In [1] 3GPP TS 38.331, V17.5.0 (2023 June), RRC parameters related to this disclosure are quoted below:

### TCI-State

The IE TCI-State associates one or two DL reference signals with a corresponding quasi-colocation (QCL) type.

TCI-State information element

-- ASN1START
-- TAG-TCI-STATE-START

| | |
|---|---|
| TCI-State ::= | SEQUENCE { |
| tci-StateId | TCI-StateId, |
| qcl-Type1 | QCL-Info, |
| qcl-Type2 | QCL-Info |

```
OPTIONAL, -- Need R
  ...,
  [[
```

| | |
|---|---|
| additionalPCI-r17 | AdditionalPCIIndex-r17 |

OPTIONAL, -- Need R

| | |
|---|---|
| pathlossReferenceRS-Id-r17 | PathlossReferenceRS-Id-r17 |

OPTIONAL, -- Cond JointTCI1

| | |
|---|---|
| ul-powerControl-r17 | Uplink-powerControlId-r17 |

OPTIONAL -- Cond JointTCI
]]
}

| | |
|---|---|
| QCL-Info ::= | SEQUENCE { |
| cell | ServCellIndex |

OPTIONAL, -- Need R

| | |
|---|---|
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}
-- TAG-TCI-STATE-STOP
-- ASN1STOP

QCL-Info field descriptions

bwp-Id
The DL BWP which the RS is located in. If the field is absent, the RS is located in the DL BWP in which the TCI-State is
applied by the UE.
cell
The UE's serving cell in which the referenceSignal is configured. If the field is absent, the referenceSignal is configured
in the serving cell in which the TCI-State is applied by the UE. The RS can be located on a serving cell other than the
serving cell for which the TCI-State is applied by the UE only if the qcl-Type is configured as typeC or typeD. If the
referenceSignal is set to csi-rs and unifiedTCI-State Type is configured, either both cell and bwp-Id are present or both
cell and bwp-Id are absent. See TS 38.214 [19] clause 5.1.5.
referenceSignal
Reference signal with which quasi-collocation information is provided as specified in TS 38.214 [19] clause 5.1.5.
qcl-Type
QCL type as specified in TS 38.214 [19] clause 5.1.5.

TCI-State field descriptions

additionalPCI
Indicates the physical cell IDs (PCI) of the SSBs when referenceSignal is configured as SSB for both QCL-Type1 and
QCL-Type2. In case the cell is present, the additionalPCI refers to a PCI value configured in the list configured using
additionalPCI-ToAddModList in the serving cell indicated by the field cell. Otherwise, it refers to a PCI value configured
in a list additionalPCI-ToAddModList configured in the serving cell where the TCI-State is applied by the UE. When this
field is present the cell for qcl-Type1 and qcl-Type2 is configured with same value, if present.
pathlossReferenceRS-Id
The ID of the reference signal (e.g. a CSI-RS or an SS block) used for PUSCH, PUCCH and SRS path loss estimation.
This field refers to an element in the list configured using pathlossReferenceRSToAddModList in the serving cell and UL
BWP where the TCI State is applied by the UE.
qcl-Type1, qcl-Type2
QCL information for the TCI state as specified in TS 38.214 [19] clause 5.1.5.
tci-StateId
ID number of the TCI state.
ul-PowerControl
Configures power control parameters for PUCCH, PUSCH and SRS for this TCI state. The field is present here only if
ul-powerControl is not configured in any BWP-Uplink-Dedicated of this serving cell. This field refers to an element in the
list configured using uplink-PowerControlToAddModList in the serving cell where the dl-OrJointTCI-StateToAddModList
is configured.

### TCI-UL-State

The IE TCI-UL-State indicates the TCI state information for UL transmission.

TCI-UL-State information element

-- ASN1START
-- TAG-TCI-UL-STATE-START

| TCI-UL-State-r17 ::= | SEQUENCE { | |
|---|---|---|
| tci-UL-StateId-r17 | TCI-UL-StateId-r17, | |
| servingCellId-r17 | ServCellIndex | OPTIONAL, |

-- Need R

| | | |
|---|---|---|
| bwp-Id-r17 | BWP-Id | OPTIONAL, |

-- Cond CSI-RSorSRS-Indicated

| | |
|---|---|
| referenceSignal-r17 | CHOICE { |
| ssb-Index-r17 | SSB-Index, |
| csi-RS-Index-r17 | NZP-CSI-RS-ResourceId, |
| srs-r17 | SRS-ResourceId |

},

| | | |
|---|---|---|
| additionalPCI-r17 | AdditionalPCIIndex-r17 | OPTIONAL, |

-- Need R

| | | |
|---|---|---|
| ul-powerControl-r17 | Uplink-powerControlId-r17 | OPTIONAL, |

-- Need R

| | | |
|---|---|---|
| pathlossReferenceRS-Id-r17 | PathlossReferenceRS-Id-r17 | OPTIONAL, |

-- Cond Mandatory
...
}
-- TAG-TCI-UL-STATE-STOP
-- ASN1STOP

TCI-UL-State field descriptions

additionalPCI
Indicates the physical cell IDs (PCI) of the SSBs when referenceSignal is configured as SSB. In case the servingCellId
is present, the additionalPCI refers to a PCI value configured in the list configured using additionalPCI-ToAddModList in
the serving cell indicated by the field servingCellId. Otherwise, it refers to a PCI value configured in the list configured
using additionalPCI-ToAddModList in the serving cell where the ul-TCI-StateList is applied by the UE.
bwp-Id
The DL BWP which the CSI-RS is located in or UL BWP where the SRS is located in.
servingCellId
The UE's serving cell in which the referenceSignal is configured. If the field is absent, the referenceSignal is configured
in the serving cell in which the TCI-UL-State is applied by the UE.
pathlossReferenceRS-Id
The ID of the reference Signal (e.g. a CSI-RS or a SS block) used for PUSCH, PUCCH and SRS path loss estimation.
This field refers to an element in the list configured using pathlossReferenceRSToAddModList in the serving cell and UL
BWP where the UL TCI State is applied by the UE.
ul-powerControl
Configures power control parameters for PUCCH, PUSCH and SRS for this TCI state. The field is present here only if
ul-powerControl is not configured in any BWP-Uplink-Dedicated of this serving cell. This field refers to an element in the
list configured using uplink-PowerControlToAddModList in the serving cell where the ul-TCI-ToAddModList is
configured.

### RACH-ConfigDedicated

The IE RA CH-ConfigDedicated is used to specify the dedicated random access parameters.

RACH-ConfigDedicated information element

-- ASN1START
-- TAG-RACH-CONFIGDEDICATED-START

| | |
|---|---|
| RACH-ConfigDedicated ::= | SEQUENCE { |

| | |
|---|---|
| cfra | CFRA |

OPTIONAL, -- Need S

| | |
|---|---|
| ra-Prioritization | RA-Prioritization |

```
OPTIONAL, -- Need N
  ...,
  [[
```

| | |
|---|---|
| ra-PrioritizationTwoStep-r16 | RA-Prioritization |

OPTIONAL, -- Need N

| | |
|---|---|
| cfra-TwoStep-r16 | CFRA-TwoStep-r16 |

OPTIONAL -- Need S
]]
}

| | |
|---|---|
| CFRA ::= | SEQUENCE { |

| occasions | | SEQUENCE { |
|---|---|---|
| | rach-ConfigGeneric | RACH-ConfigGeneric, |
| | ssb-perRACH-Occasion | ENUMERATED {oneEighth, oneFourth, oneHalf, one, two, four, |

eight, sixteen}
OPTIONAL -- Cond Mandatory
}
OPTIONAL, -- Need S

| resources | | CHOICE { |
|---|---|---|
| | ssb | SEQUENCE { |

| | |
|---|---|
| ssb-ResourceList | SEQUENCE (SIZE(1..maxRA-SSB-Resources)) OF CFRA-SSB- |

Resource,

| | |
|---|---|
| ra-ssb-OccasionMaskIndex | INTEGER (0..15) |

| }, | |
|---|---|
| csirs | SEQUENCE { |

| | |
|---|---|
| csirs-ResourceList | SEQUENCE (SIZE(1..maxRA-CSIRS-Resources)) OF CFRA-CSIRS- |

Resource,

| | |
|---|---|
| rsrp-ThresholdCSI-RS | RSRP-Range |

}

```
  },
  ...,
[[
  totalNumberOfRA-Preambles INTEGER (1..63)
```

| | |
|---|---|
| OPTIONAL -- | Cond Occasions |

]]
}

| | |
|---|---|
| CFRA-TwoStep-r16 ::= | SEQUENCE { |

| occasionsTwoStepRA-r16 | | SEQUENCE { |
|---|---|---|
| | rach-ConfigGenericTwoStepRA-r16 | RACH-ConfigGenericTwoStepRA-r16, |
| | ssb-PerRACH-OccasionTwoStepRA-r16 | ENUMERATED {oneEighth, oneFourth, oneHalf, one, |

two, four, eight, sixteen}

}
OPTIONAL, -- Need S

| msgA-CFRA-PUSCH-r16 | | MsgA-PUSCH-Resource-r16, |
|---|---|---|
| msgA-TransMax-r16 | | ENUMERATED {n1, n2, n4, n6, n8, n10, n20, n50, n100, |
| n200} | OPTIONAL, -- Need S | |
| resourcesTwoStep-r16 | | SEQUENCE { |
| | ssb-ResourceList | SEQUENCE (SIZE(1..maxRA-SSB-Resources)) OF CFRA-SSB- |

Resource,

| | |
|---|---|
| ra-ssb-OccasionMaskIndex | INTEGER (0..15) |

```
  },
  ...
}
```

| | |
|---|---|
| CFRA-SSB-Resource ::= | SEQUENCE { |

| | |
|---|---|
| ssb | SSB-Index, |
| ra-Preamble Index | INTEGER (0..63), |

```
  ...,
  [[
```

| | | |
|---|---|---|
| msgA-PUSCH-Resource-Index-r16 | INTEGER (0..3071) | OPTIONAL -- Cond 2StepCFRA |

]]
}

| | |
|---|---|
| CFRA-CSIRS-Resource ::= | SEQUENCE { |

| | |
|---|---|
| csi-RS | CSI-RS-Index, |
| ra-OccasionList | SEQUENCE (SIZE(1..maxRA-OccasionsPerCSIRS)) OF INTEGER (0..maxRA- |

Occasions-1),

| | |
|---|---|
| ra-PreambleIndex | INTEGER (0..63), |

...
}
-- TAG-RACH-CONFIGDEDICATED-STOP
-- ASN1STOP

CFRA-CSIRS-Resource field descriptions

csi-RS
The ID of a CSI-RS resource defined in the measurement object associated with this serving cell.
ra-OccasionList
RA occasions that the UE shall use when performing CF-RA upon selecting the candidate beam identified by this CSI-
RS. The network ensures that the RA occasion indexes provided herein are also configured by prach-
ConfigurationIndex and msg1-FDM. Each RACH occasion is sequentially numbered, first, in increasing order of
frequency resource indexes for frequency multiplexed PRACH occasions; second, in increasing order of time resource
indexes for time multiplexed PRACH occasions within a PRACH slot and Third, in increasing order of indexes for
PRACH slots.
ra-PreambleIndex
The RA preamble index to use in the RA occasions associated with this CSI-RS.

CFRA field descriptions

occasions
RA occasions for contention free random access. If the field is absent, the UE uses the RA occasions configured in
RACH-ConfigCommon in the first active UL BWP.
ra-ssb-OccasionMaskIndex
Explicitly signalled PRACH Mask Index for RA Resource selection in TS 38.321 [3]. The mask is valid for all SSB
resources signalled in ssb-ResourceList.
rach-ConfigGeneric
Configuration of contention free random access occasions for CFRA. The UE shall ignore
preambleReceivedTargetPower, preambleTransMax, powerRampingStep, ra-ResponseWindow signaled within this
field and use the corresponding values provided in RACH-ConfigCommon.
ssb-perRACH-Occasion
Number of SSBs per RACH occasion.
totalNumberOfRA-Preambles
Total number of preambles used for contention free random access in the RACH resources defined in CFRA, excluding
preambles used for other purposes (e.g. for SI request). If the field is absent but the field occasions is present, the UE
may assume all the 64 preambles are for RA. The setting should be consistent with the setting of ssb-perRACH-
Occasion, if present, i.e. it should be a multiple of the number of SSBs per RACH occasion.

CFRA-SSB-Resource field descriptions

msgA-PUSCH-Resource-Index
Identifies the index of the PUSCH resource used for MSGA CFRA. The PUSCH resource index indicates a valid
PUSCH occasion (as specified in TS 38.213 [13], clause 8.1A) and the associated DMRS resources corresponding to a
PRACH slot. The PUSCH resource indexes are sequentially numbered and are mapped to valid PUSCH occasions
corresponding to a PRACH slot which are ordered, first, in increasing order of frequency resource indexes for frequency
multiplexed PUSCH occasions; second, in increasing order of DMRS resource indexes within a PUSCH occasion,
where a DMRS resource index DMRS_{id} is determined first in an ascending order of a DMRS port index and then in an
ascending order of a DMRS sequence index, third in increasing order of time resource indexes for time multiplexed
PUSCH occasions within a PUSCH slot and fourth, in increasing order of indexes for PUSCH slots. For the case of
contention free 2-step random access type, if this field is absent, the UE shall use the value 0.
ra-PreambleIndex
The preamble index that the UE shall use when performing CF-RA upon selecting the candidate beams identified by
this SSB.
ssb
The ID of an SSB transmitted by this serving cell.

RACH-ConfigDedicated field descriptions

cfra
Parameters for contention free random access to a given target cell. If this field and cfra-TwoStep are absent, the UE
performs contention based random access.
cfra-TwoStep
Parameters for contention free 2-step random access type to a given target cell. Network ensures that cfra and cfra-
TwoStep are not configured at the same time. If this field and cfra are absent, the UE performs contention based
random access. This field may only be present if msgA-ConfigCommon is configured on the BWP.
ra-prioritization
Parameters which apply for prioritized random access procedure to a given target cell (see TS 38.321 [3], clause 5.1.1).
ra-PrioritizationTwoStep
Parameters which apply for prioritized 2-step random access type procedure to a given target cell (see TS 38.321 [3],
clause 5.1.1).

### RACH-ConfigGeneric

The IE RACH-ConfigGeneric is used to specify the random-access parameters both for regular random access as well as for beam failure recovery.

RACH-ConfigGeneric information element

-- ASN1START
-- TAG-RACH-CONFIGGENERIC-START

| | |
|---|---|
| RACH-ConfigGeneric ::= | SEQUENCE { |
| prach-ConfigurationIndex | INTEGER (0..255), |
| msg1-FDM | ENUMERATED {one, two, four, eight}, |
| msg1-FrequencyStart | INTEGER (0..maxNrofPhysicalResourceBlocks-1), |
| zeroCorrelationZoneConfig | INTEGER (0..15), |
| preambleReceivedTargetPower | INTEGER (−202..−60), |
| preambleTransMax | ENUMERATED {n3, n4, n5, n6, n7, n8, n10, n20, n50, n100, |

n200},

| | |
|---|---|
| powerRampingStep | ENUMERATED {dB0, dB2, dB4, dB6}, |
| ra-ResponseWindow | ENUMERATED {sl1, sl2, sl4, sl8, sl10, sl20, sl40, sl80}, |

```
  ...,
  [[
```

| | |
|---|---|
| prach-ConfigurationPeriodScaling-IAB-r16 | ENUMERATED {scf1, scf2, scf4, scf8, scf16, scf32, scf64} |

OPTIONAL, -- Need R

| | |
|---|---|
| prach-ConfigurationFrameOffset-IAB-r16 | INTEGER (0..63) |

OPTIONAL, -- Need R

| | |
|---|---|
| prach-ConfigurationSOffset-IAB-r16 | INTEGER (0..39) |

OPTIONAL, -- Need R

| | |
|---|---|
| ra-ResponseWindow-v1610 | ENUMERATED { sl60, sl160} |

OPTIONAL, -- Need R

| | |
|---|---|
| prach-ConfigurationIndex-v1610 | INTEGER (256..262) |

```
OPTIONAL -- Need R
  ]],
  [[
```

| | |
|---|---|
| ra-ResponseWindow-v1700 | ENUMERATED {sl240, sl320, sl640, sl960, sl1280, |

sl1920, sl2560} OPTIONAL -- Need R
]]
}
-- TAG-RACH-CONFIGGENERIC-STOP
-- ASN1STOP

RACH-ConfigGeneric field descriptions

msg1-FDM
The number of PRACH transmission occasions FDMed in one time instance. (see TS 38.211 [16], clause 6.3.3.2).
msg1-FrequencyStart
Offset of lowest PRACH transmission occasion in frequency domain with respective to PRB 0. The value is configured
so that the corresponding RACH resource is entirely within the bandwidth of the UL BWP. (see TS 38.211 [16], clause
6.3.3.2).
powerRampingStep
Power ramping steps for PRACH (see TS 38.321 [3],5.1.3).
prach-ConfigurationFrameOffset-IAB
Frame offset for ROs defined in the baseline configuration indicated by prach-ConfigurationIndex and is used only by
the IAB-MT. (see TS 38.211 [16], clause 6.3.3.2).
prach-ConfigurationIndex
PRACH configuration index. For prach-ConfigurationIndex configured under beamFailureRecoveryConfig, the prach-
ConfigurationIndex can only correspond to the short preamble format, (see TS 38.211 [16], clause 6.3.3.2). If the field
prach-ConfigurationIndex-v1610 is present, the UE shall ignore the value provided in prach-ConfigurationIndex (without
suffix).
prach-ConfigurationPeriodScaling-IAB
Scaling factor to extend the periodicity of the baseline configuration indicated by prach-ConfigurationIndex and is used
only by the IAB-MT. Value scf1 corresponds to scaling factor of 1 and so on. (see TS 38.211 [16], clause 6.3.3.2).
prach-ConfigurationSOffset-IAB
Subframe/Slot offset for ROs defined in the baseline configuration indicated by prach-ConfigurationIndex and is used
only by the IAB-MT. (see TS 38.211 [16], clause 6.3.3.2).
preambleReceivedTargetPower
The target power level at the network receiver side (see TS 38.213 [13], clause 7.4, TS 38.321 [3], clauses 5.1.2, 5.1.3).
Only multiples of 2 dBm may be chosen (e.g. −202, −200, −198, . . . ).
preambleTransMax
Max number of RA preamble transmission performed before declaring a failure (see TS 38.321 [3], clauses 5.1.4,
5.1.5).
ra-ResponseWindow
Msg2 (RAR) window length in number of slots. The network configures a value lower than or equal to 10 ms when Msg2
is transmitted in licensed spectrum and a value lower than or equal to 40 ms when Msg2 is transmitted with shared
spectrum channel access (see TS 38.321 [3], clause 5.1.4). UE ignores the field if included in SCellConfig. If ra-
ResponseWindow-v1610 or ra-ResponseWindow-v1700 is signalled, UE shall ignore the ra-ResponseWindow (without
suffix). The field ra-ResponseWindow-v1700 is applicable to SCS 480 kHz and SCS 960 KHz.
zeroCorrelationZoneConfig
N-CS configuration, see Table 6.3.3.1-5 in TS 38.211 [16].

### ControlResourceSet

The IE ControlResourceSet is used to configure a time/frequency control resource set (CORESET) in which to search for downlink control information (see TS 38.213 [13], clause 10.1). For the UE not supporting multipleCORESET in FR1, in order to receive MBS multicast in CFR within the UE's active BWP, if a CORESET is not configured within the PDCCH-ConfigMulticast, the CORESET other than CORESET #0 configured within the UE's active BWP for scheduling unicast can be used for scheduling MBS multicast, and the CORESET is expected to be included completely within the CFR and the parameters configured in the CORESET are expected to be supported by the UE for MBS multicast.

ControlResourceSet information element

-- ASN1START
-- TAG-CONTROLRESOURCESET-START

| | |
|---|---|
| ControlResourceSet ::= | SEQUENCE { |
| controlResourceSetId | ControlResourceSetId, |
| frequencyDomainResources | BIT STRING (SIZE(45)), |
| duration | INTEGER (1..maxCoReSetDuration), |
| cce-REG-MappingType | CHOICE { |
| interleaved | SEQUENCE { |
| reg-BundleSize | ENUMERATED {n2, n3, n6}, |
| interleaverSize | ENUMERATED {n2, n3, n6}, |
| shiftIndex | INTEGER (0..maxNrofPhysicalResourceBlocks-1) |

OPTIONAL -- Need S
},

| | |
|---|---|
| nonInterleaved | NULL |

},

| | |
|---|---|
| precoderGranularity | ENUMERATED {sameAsREG-bundle, allContiguousRBs}, |
| tci-StatesPDCCH-ToAddList | SEQUENCE(SIZE (1..maxNrofTCI-StatesPDCCH)) OF TCI-StateId |

OPTIONAL, -- Cond NotSIB-initialBWP

| | |
|---|---|
| tci-StatesPDCCH-ToReleaseList | SEQUENCE(SIZE (1..maxNrofTCI-StatesPDCCH)) OF TCI-StateId |

OPTIONAL, -- Cond NotSIB-initialBWP

| | |
|---|---|
| tci-PresentInDCI | ENUMERATED {enabled} |

OPTIONAL, -- Need S

| | |
|---|---|
| pdcch-DMRS-ScramblingID | INTEGER (0..65535) |

```
OPTIONAL, -- Need S
  ...,
  [[
```

| | |
|---|---|
| rb-Offset-r16 | INTEGER (0..5) |

OPTIONAL, -- Need S

| | |
|---|---|
| tci-PresentDCI-1-2-r16 | INTEGER (1..3) |

OPTIONAL, -- Need S

| | |
|---|---|
| coresetPoolIndex-r16 | INTEGER (0..1) |

OPTIONAL, -- Need S

| | |
|---|---|
| controlResourceSetId-v1610 | ControlResourceSetId-v1610 |

```
OPTIONAL -- Need S
  ]],
  [[
```

| | |
|---|---|
| followUnifiedTCI-State-r17 | ENUMERATED {enabled} |

OPTIONAL -- Need R
]]
}
-- TAG-CONTROLRESOURCESET-STOP
-- ASN1STOP

ControlResourceSet field descriptions

cce-REG-MappingType
Mapping of Control Channel Elements (CCE) to Resource Element Groups (REG) (see TS 38.211 [16], clauses 7.3.2.2
and 7.4.1.3.2).
controlResourceSetId
Identifies the instance of the ControlResourceSet IE. Value 0 identifies the common CORESET configured in MIB and
in ServingCellConfigCommon (controlResourceSetZero) and is hence not used here in the ControlResourceSet IE.
Other values identify CORESETs configured by dedicated signalling or in SIB1 or SIB20. The controlResourceSetId is
unique among the BWPs of a serving cell.
If the field controlResourceSetId-v1610 is present, the UE shall ignore the controlResourceSetId field (without suffix).
coresetPoolIndex
The index of the CORESET pool for this CORESET as specified in TS 38.213 [13] (clauses 9 and 10) and TS 38.214
[19] (clauses 5.1 and 6.1). If the field is absent, the UE applies the value 0.
duration
Contiguous time duration of the CORESET in number of symbols (see TS 38.211 [16], clause 7.3.2.2).
followUnifiedTCI-State
When set to enabled, for PDCCH reception on this CORESET, the UE applies the “indicated” DL only TCI or joint TCI
as specified in TS 38.214 [19], clause 5.1.5.
frequencyDomainResources
Frequency domain resources for the CORESET. Each bit corresponds a group of 6 RBs, with grouping starting from the
first RB group in the BWP or MBS CFR where the CORESET is configured. When at least one search space is
configured with freqMonitorLocation-r16, only the first _{NRBG, set0}^{size} bits are valid (see TS 38.213 [13], clause 10.1). The
first (left-most/most significant) bit corresponds to the first RB group in the BWP or MBS CFR where the CORESET is
configured, and so on. A bit that is set to 1 indicates that this RB group belongs to the frequency domain resource of
this CORESET. Bits corresponding to a group of RBs not fully contained in the bandwidth part within which the
CORESET is configured are set to zero (see TS 38.211 [16], clause 7.3.2.2).
interleaverSize
Interleaver-size (see TS 38.211 [16], clause 7.3.2.2).
pdcch-DMRS-ScramblingID
PDCCH DMRS scrambling initialization (see TS 38.211 [16], clause 7.4.1.3.1). When the field is absent the UE applies
the value of the physCellId configured for this serving cell.
precoderGranularity
Precoder granularity in frequency domain (see TS 38.211 [16], clauses 7.3.2.2 and 7.4.1.3.2).
rb-Offset
Indicates the RB level offset in units of RB from the first RB of the first 6RB group to the first RB of BWP (see 38.213
[13], clause 10.1).
reg-BundleSize
Resource Element Groups (REGs) can be bundled to create REG bundles. This parameter defines the size of such
bundles (see TS 38.211 [16], clause 7.3.2.2).
shiftIndex
When the field is absent the UE applies the value of the physCellIdconfigured for this serving cell (see TS 38.211 [16],
clause 7.3.2.2).
tci-PresentInDCI
This field indicates if TCI field is present or absent in DCI format 1_1 and DCI format 4_2. When the field is absent the
UE considers the TCI to be absent/disabled. In case of cross carrier scheduling, the network sets this field to enabled
for the ControlResourceSet used for cross carrier scheduling in DCI format 1_1 in the scheduling cell if
enableDefaultBeamForCCS is not configured (see TS 38.214 [19], clause 5.1.5).
tci-PresentDCI-1-2
Configures the number of bits for “Transmission configuration indicator” in DCI format 1_2. When the field is absent the
UE applies the value of 0 bit for the “Transmission configuration indicator” in DCI format 1_2 (see TS 38.212 [17],
clause 7.3.1 and TS 38.214 [19], clause 5.1.5). In case of cross carrier scheduling, the network configures this field for
the ControlResourceSet used for cross carrier scheduling in DCI format 1_2 in the scheduling cell if
enableDefaultBeamForCCS is not configured (see TS 38.214 [19], clause 5.1.5).
tci-StatesPDCCH-ToAddList
A subset of the TCI states defined in pdsch-Config, either with tci-States ToAddModList or dl-OrJointTCI-StateList,
included in the BWP-DownlinkDedicated corresponding to the serving cell and to the DL BWP to which the
ControlResourceSet belong to. They are used for providing QCL relationships between the DL RS(s) in one RS Set
(TCI-State) and the PDCCH DMRS ports (see TS 38.213 [13], clause 6.). The network configures at most maxNrofTCI-
StatesPDCCH entries. The QCL relationships defined herein do not apply to MBS broadcast.

### SearchSpace

The IE SearchSpace defines how/where to search for PDCCH candidates. Each search space is associated with one ControlResourceSet. For a scheduled SCell in the case of cross carrier scheduling, except for nrofCandidates, all the optional fields are absent (regardless of their presence conditions). For a scheduled SpCell in the case of the cross carrier scheduling, if the search space is linked to another search space in the scheduling SCell, all the optional fields of this search space in the scheduled SpCell are absent (regardless of their presence conditions) except for nrofCandidates.

SearchSpace information element

-- ASN1START
-- TAG-SEARCHSPACE-START

| | |
|---|---|
| SearchSpace ::= | SEQUENCE { |

| | |
|---|---|
| searchSpaceId | SearchSpaceId, |
| controlResourceSetId | ControlResourceSetId |

| | |
|---|---|
| OPTIONAL, | -- Cond SetupOnly |

| | |
|---|---|
| monitoringSlotPeriodicityAndOffset | CHOICE { |
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639), |
| sl1280 | INTEGER (0..1279), |
| sl2560 | INTEGER (0..2559), |

}

| | |
|---|---|
| OPTIONAL, | -- Cond Setup4 |

| | |
|---|---|
| duration | INTEGER (2..2559) |

| | |
|---|---|
| OPTIONAL, | -- Need S |

| | |
|---|---|
| monitoringSymbolsWithinSlot | BIT STRING (SIZE(14)) |

| | |
|---|---|
| OPTIONAL, | -- Cond Setup |

| | |
|---|---|
| nrofCandidates | SEQUENCE { |
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8}, |

}

| OPTIONAL, | -- Cond Setup | |
|---|---|---|
| searchSpaceType | | CHOICE { |
| common | | SEQUENCE { |
| | dci-Format0-0-AndFormat1-0 | SEQUENCE { |
| | ... | |
| | } | |
| OPTIONAL, | -- Need R | |
| | dci-Format2-0 | SEQUENCE { |
| | nrofCandidates-SFI | SEQUENCE { |
| | aggregationLevel1 | ENUMERATED {n1, n2} |
| OPTIONAL, | -- Need R | |
| | aggregationLevel2 | ENUMERATED {n1, n2} |
| OPTIONAL, | -- Need R | |
| | aggregationLevel4 | ENUMERATED {n1, n2} |
| OPTIONAL, | -- Need R | |
| | aggregationLevel8 | ENUMERATED {n1, n2} |
| OPTIONAL, | -- Need R | |
| | aggregationLevel16 | ENUMERATED {n1, n2} |
| OPTIONAL | -- Need R | |
| | }, | |
| | ... | |
| | } | |
| OPTIONAL, | -- Need R | |
| | dci-Format2-1 | SEQUENCE { |
| | ... | |
| | } | |
| OPTIONAL, | -- Need R | |
| | dci-Format2-2 | SEQUENCE { |
| | ... | |
| | } | |
| OPTIONAL, | -- Need R | |
| | dci-Format2-3 | SEQUENCE { |
| | dummy1 | ENUMERATED {sl1, sl2, sl4, sl5, sl8, sl10, |
| sl16, sl20} | OPTIONAL, -- Cond Setup | |
| | dummy2 | ENUMERATED {n1, n2}, |

| | |
|---|---|
| | ... |
| | } |
| OPTIONAL | -- Need R |

},

| ue-Specific | | SEQUENCE { |
|---|---|---|
| | dci-Formats | ENUMERATED {formats0-0-And-1-0, formats0-1- |

And-1-1},

| | ..., | |
|---|---|---|
| | [[ | |
| | dci-Formats-MT-r16 | ENUMERATED {formats2-5} |
| OPTIONAL, | -- Need R | |
| | dci-FormatsSL-r16 | ENUMERATED {formats0-0-And-1-0, formats0-1-And-1-1, |

formats3-0, formats3-1,

| formats3-0-And-3-1} | | |
|---|---|---|
| OPTIONAL, | -- Need R | |
| | dci-FormatsExt-r16 | ENUMERATED {formats0-2-And-1-2, formats0-1-And-1- |

1And-0-2-And-1-2}

| | |
|---|---|
| OPTIONAL | -- Need R |
| | ]] |

```
    }
  }
```

| | |
|---|---|
| OPTIONAL | -- Cond Setup2 |

}

| | |
|---|---|
| SearchSpaceExt-r16 ::= | SEQUENCE { |

| controlResourceSetId-r16 | | ControlResourceSetId-r16 |
|---|---|---|
| OPTIONAL, | -- Cond SetupOnly2 | |
| searchSpaceType-r16 | | SEQUENCE { |
| common-r16 | | SEQUENCE { |
| | dci-Format2-4-r16 | SEQUENCE { |
| | nrofCandidates-CI-r16 | SEQUENCE { |
| | aggregationLevel1-r16 | ENUMERATED {n1, n2} |
| OPTIONAL, | -- Need R | |
| | aggregationLevel2-r16 | ENUMERATED {n1, n2} |
| OPTIONAL, | -- Need R | |
| | aggregationLevel4-r16 | ENUMERATED {n1, n2} |
| OPTIONAL, | -- Need R | |
| | aggregationLevel8-r16 | ENUMERATED {n1, n2} |
| OPTIONAL, | -- Need R | |
| | aggregationLevel16-r16 | ENUMERATED {n1, n2} |
| OPTIONAL | -- Need R | |
| | }, | |
| | ... | |
| | } | |
| OPTIONAL, | -- Need R | |
| | dci-Format2-5-r16 | SEQUENCE { |
| | nrofCandidates-IAB-r16 | SEQUENCE { |
| | aggregationLevel1-r16 | ENUMERATED {n1, n2} |
| OPTIONAL, | -- Need R | |
| | aggregationLevel2-r16 | ENUMERATED {n1, n2} |
| OPTIONAL, | -- Need R | |
| | aggregationLevel4-r16 | ENUMERATED {n1, n2} |
| OPTIONAL, | -- Need R | |
| | aggregationLevel8-r16 | ENUMERATED {n1, n2} |
| OPTIONAL, | -- Need R | |
| | aggregationLevel16-r16 | ENUMERATED {n1, n2} |
| OPTIONAL | -- Need R | |
| | }, | |
| | ... | |
| | } | |
| OPTIONAL, | -- Need R | |
| | dci-Format2-6-r16 | SEQUENCE { |

| | |
|---|---|
| | ... |
| | } |
| OPTIONAL, | -- Need R |
| | ... |

```
    }
  }
```

| | |
|---|---|
| OPTIONAL, | -- Cond Setup3 |

| | |
|---|---|
| searchSpaceGroupIdList-r16 | SEQUENCE (SIZE (1..2)) OF INTEGER (0..1) |

| | |
|---|---|
| OPTIONAL, | -- Need R |

| | |
|---|---|
| freQMonitorLocations-r16 | BIT STRING (SIZE (5)) |

| | |
|---|---|
| OPTIONAL | -- Need R |

}

| | |
|---|---|
| SearchSpaceExt-v1700 ::= | SEQUENCE { |

| | |
|---|---|
| monitoringSlotPeriodicityAndOffset-v1710 | CHOICE { |
| sl32 | INTEGER (0..31), |
| sl64 | INTEGER (0..63), |
| sl128 | INTEGER (0..127), |
| sl5120 | INTEGER (0..5119), |
| sl10240 | INTEGER (0..10239), |
| sl20480 | INTEGER (0..20479) |

}

| | |
|---|---|
| OPTIONAL, | -- Cond Setup5 |

| | |
|---|---|
| monitoringSlotsWithinSlotGroup-r17 | CHOICE { |
| slotGroupLenght4-r17 | BIT STRING (SIZE(4)), |
| slotGroupLength8-r17 | BIT STRING (SIZE(8)) |

}

| | |
|---|---|
| OPTIONAL, | -- Need R |

| | |
|---|---|
| duration-r17 | INTEGER (4..20476) |

| | |
|---|---|
| OPTIONAL, | -- Need R |

| | |
|---|---|
| searchSpaceType-r17 | SEQUENCE{ |
| common-r17 | SEQUENCE { |

| | dci-Format4-0-r17 | SEQUENCE { |
|---|---|---|
| | ... | |
| | } | |
| OPTIONAL, | -- Need R | |
| | dci-Format4-1-r17 | SEQUENCE { |
| | ... | |
| | } | |
| OPTIONAL, | -- Need R | |
| | dci-Format4-2-r17 | SEQUENCE { |
| | ... | |
| | } | |
| OPTIONAL, | -- Need R | |
| | dci-Format4-1-AndFormat4-2-r17 | SEQUENCE { |
| | ... | |
| | } | |
| OPTIONAL, | -- Need R | |
| | dciFormat2-7r17 | SEQUENCE { |
| | nrofCandidates-PEI-r17 | SEQUENCE { |
| | aggregationLevel4-r17 | ENUMERATED {n0, n1, n2, n3, n4} |
| OPTIONAL, | -- Need R | |
| | aggregationLevel8-r17 | ENUMERATED {n0, n1, n2} |
| OPTIONAL, | -- Need R | |
| | aggregationLevel16-r17 | ENUMERATED {n0, n1} |

| | |
|---|---|
| OPTIONAL | -- Need R |
| | }, |
| | ... |
| | } |
| OPTIONAL | -- Need R |

```
    }
  }
```

| | |
|---|---|
| OPTIONAL, | -- Need R |

| searchSpaceGroupIdList-r17 | SEQUENCE (SIZE (1..3)) OF INTEGER (0.. | |
|---|---|---|
| maxNrof Search SpaceGroups-1-r17) | OPTIONAL, | -- Cond DedicatedOnly |

| | |
|---|---|
| searchSpaceLinkingId-r17 | INTEGER (0..maxNrofSearchSpacesLinks-1-r17) |

| | |
|---|---|
| OPTIONAL | -- Cond DedicatedOnly |

}
-- TAG-SEARCHSPACE-STOP
-- ASN1STOP

SearchSpace field descriptions

common
Configures this search space as common search space (CSS) and DCI formats to monitor.
controlResourceSetId
The CORESET applicable for this SearchSpace. Value 0 identifies the common CORESET#0 configured in MIB and in
ServingCellConfigCommon. Values 1 . . . maxNrofControlResourceSets-1 identify CORESETs configured in System
Information or by dedicated signalling. The CORESETs with non-zero controlResourceSetId are configured in the same
BWP as this SearchSpace except commonControlResourceSetExt which is configured by SIB20. If the field
controlResourceSetId-r16 is present, UE shall ignore the controlResourceSetId (without suffix).

In [2] 3GPP TS 38.321, V17.5.0 (2023 June), related paragraph and MAC CE are quoted below:

### 6.1.3.47 Unified TCI States Activation/Deactivation MAC CE

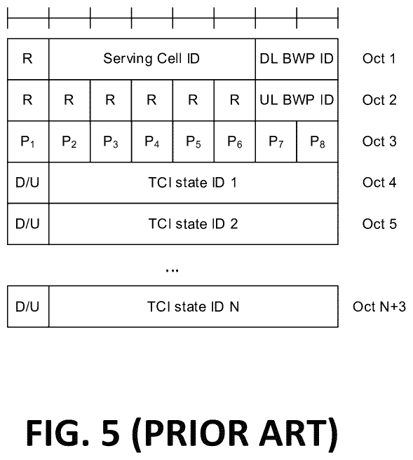

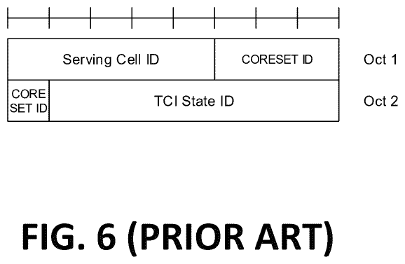

The Unified TCI States Activation/Deactivation MAC CE is identified by a MAC subheader with eLCID as specified in Table 6.2.1-1b. It has a variable size consisting of following fields:
Serving Cell ID: This field indicates the identity of the Serving Cell for which the MAC CE applies. The length of the field is 5 bits. If the indicated Serving Cell is configured as part of a simultaneousU-TCI-UpdateList1, simultaneousU-TCI-UpdateList2, simultaneousU-TCI-UpdateList3 or simultaneousU-TCI-UpdateList4 as specified in TS 38.331 [5], this MAC CE applies to all the Serving Cells in the set simultaneousU-TCI-UpdateList1, simultaneousU-TCI-UpdateList2, simultaneousU-TCI-UpdateList3 or simultaneousU-TCI-UpdateList4, respectively;
DL BWP ID: This field indicates a DL BWP for which the MAC CE applies as the codepoint of the DCI bandwidth part indicator field as specified in TS 38.212 [9]. The length of the BWP ID field is 2 bits;
UL BWP ID: This field indicates a UL BWP for which the MAC CE applies as the codepoint of the DCI bandwidth part indicator field as specified in TS 38.212 [9]. If value of unifiedTCI-StateType in the Serving Cell indicated by Serving Cell ID is joint, this field is considered as the reserved bits. The length of the BWP ID field is 2 bits;
Pᵢ: This field indicates whether each TCI codepoint has multiple TCI states or single TCI state. If Pᵢ field is set to 1, it indicates that i^{th} TCI codepoint includes the DL TCI state and the UL TCI state. If Pᵢ field is set to 0, it indicates that i^{th} TCI codepoint includes only the DL/joint TCI state or the UL TCI state. The codepoint to which a TCI state is mapped is determined by its ordinal position among all the TCI state ID fields;
D/U: This field indicate whether the TCI state ID in the same octet is for joint/downlink or uplink TCI state. If this field is set to 1, the TCI state ID in the same octet is for joint/downlink. If this field is set to 0, the TCI state ID in the same octet is for uplink;
TCI state ID: This field indicates the TCI state identified by TCI-StateId as specified in TS 38.331 [5]. If D/U is set to 1, 7-bits length TCI state ID i.e. TCI-StateId as specified in TS 38.331 [5] is used. If D/U is set to 0, the most significant bit of TCI state ID is considered as the reserved bit and remainder 6 bits indicate the TCI-UL-State-Id as specified in TS 38.331 [5]. The maximum number of activated TCI states is 16;
R: Reserved bit, set to 0.
   FIG. 5 is a reproduction of FIG. 6.1.3.47-1: Unified TCI state activation/deactivation MAC CE, from 3GPP TS 38.321, V17.5.0 (2023 June).

### 6.1.3.15 TCI State Indication for UE-Specific PDCCH MAC CE

The TCI State Indication for UE-specific PDCCH MAC CE is identified by a MAC subheader with LCID as specified in Table 6.2.1-1. It has a fixed size of 16 bits with following fields:
Serving Cell ID: This field indicates the identity of the Serving Cell for which the MAC CE applies. The length of the field is 5 bits. If the indicated Serving Cell is configured as part of a simultaneousTCI-UpdateList1 or simultaneousTCI-UpdateList2 as specified in TS 38.331 [5], this MAC CE applies to all the Serving Cells in the set simultaneousTCI-UpdateList1 or simultaneousTCI-UpdateList2, respectively;
CORESET ID: This field indicates a Control Resource Set identified with ControlResourceSetId as specified in TS 38.331 [5], for which the TCI State is being indicated. In case the value of the field is 0, the field refers to the Control Resource Set configured by controlResourceSetZero as specified in TS 38.331 [5]. The length of the field is 4 bits;
TCI State ID: This field indicates the TCI state identified by TCI-StateId as specified in TS 38.331 [5] applicable to the Control Resource Set identified by CORESET ID field. If the field of CORESET ID is set to 0, this field indicates a TCI-StateId for a TCI state of the first 64 TCI-states configured by tci-StatesToAddModList and tci-StatesToReleaseList in the PDSCH-Config in the active BWP or by dl-OrJoint-TCI-State-ToAddModList and dl-OrJoint-TCI-State-ToReleaseList in the PDSCH-Config in the active BWP or the reference BWP. If the field of CORESET ID is set to the other value than 0, this field indicates a TCI-StateId configured by tci-StatesPDCCH-ToAddList and tci-StatesPDCCH-ToReleaseList in the controlResourceSet identified by the indicated CORESET ID. The length of the field is 7 bits.
   FIG. 6 is a reproduction of FIG. 6.1.3.15-1: TCI State Indication for UE-specific PDCCH MAC CE, from 3GPP TS 38.321, V17.5.0 (2023 June).

In [3] 3GPP TS 38.214, V17.6.0 (2023 June), the following is provided:

### 5.1.5 Antenna Ports Quasi Co-Location

The UE can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi co-location relationship between one or two downlink reference signals and the DM-RS ports of the PDSCH, the DM-RS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘typeA’: {Doppler shift, Doppler spread, average delay, delay spread}
‘typeB’: {Doppler shift, Doppler spread}
‘typeC’: {Doppler shift, average delay}
‘typeD’: {Spatial Rx parameter}

The UE can be configured with a list of up to 128 TCI-State configurations, within the higher layer parameter dl-OrJointTCI-StateList in PDSCH-Config for providing a reference signal for the quasi co-location for DM-RS of PDSCH and DM-RS of PDCCH in a BWP/CC, for CSI-RS, and to provide a reference, if applicable, for determining UL TX spatial filter for dynamic-grant and configured-grant based PUSCH and PUCCH resource in a BWP/CC, and SRS.

If the TCI-State or TCI-UL-State configurations are absent in a BWP of the CC, the UE can apply the TCI-State or TCI-UL-State configurations from a reference BWP of a reference CC. The UE is not expected to be configured with tci-StatesToAddModList, SpatialRelationInfo or PUCCH-SpatialRelationInfo, except SpatialRelationInfoPos in a CC in a band, if the UE is configured with dl-OrJointTCI-StateList or ul-TCI-StateList in any CC in the same band. The UE can assume that when the UE is configured with tci-StatesToAddModList in any CC in the CC list configured by simultaneousTCI-UpdateList1-r16, simultaneousTCI-UpdateList2-r16, simultaneousSpatial-UpdatedList1-r16, or simultaneousSpatial-UpdatedList2-r16, the UE is not configured with dl-OrJointTCI-StateList or ul-TCI-StateList in any CC within the same band in the CC list.

The UE receives an activation command, as described in clause 6.1.3.14 of [10, TS 38.321] or 6.1.3.47 of [10, TS 38.321], used to map up to 8 TCI states and/or pairs of TCI states, with one TCI state for DL channels/signals and/or one TCI state for UL channels/signals to the codepoints of the DCI field ‘Transmission Configuration Indication’ for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of T state IDs are applied for all DL and/or UL BWPs in the indicated CCs. If the activation command maps TCI-State and/or TCI-UL-State to only one TCI codepoint, the UE shall apply the indicated TCI-State and/or TCI-UL-State to one or to a set of CCs/DL BWPs, and if applicable, to one or to a set of CCs/UL BWPs once the indicated mapping for the one single TCI codepoint is applied as described in [11, TS 38.133].

When the bwp-id or cell for QCL-TypeA/D source RS in a QCL-Info of the TCI state is not configured, the UE assumes that QCL-TypeA/D source RS is configured in the CC/DL BWP where TCI state applies.

When tci-PresentInDCI is set as ‘enabled’ or tci-PresentDCI-1-2 is configured for the CORESET, a UE configured with dl-OrJointTCI-StateList with activated TCI-State or ul-TCI-StateList with activated TCI-UL-State receives DCI format 1_1/1_2 providing indicated TCI-State and/or TCI-UL-State for a CC or all CCs in the same CC list configured by simultaneousU-TCI-UpdateList1-r17, simultaneousU-TCI-UpdateList2-r17, simultaneousU-TCI-UpdateList3-r17, simultaneousU-TCI-UpdateList4-r17. The DCI format 1_1/1_2 can be with or without, if applicable, DL assignment. If the DCI format 1_1/1_2/is without DL assignment, the UE can assume the following:
CS-RNTI is used to scramble the CRC for the DCI
The values of the following DCI fields are set as follows:
   RV=all ‘1’s
   MCS=all ‘1’s
   NDI=0
   Set to all ‘0’s for FDRA Type 0, or all ‘1’s for FDRA Type 1, or all ‘0’s for dynamicSwitch (same as in Table 10.2-4 of [6, TS 38.213]).

After a UE receives an initial higher layer configuration of dl-OrJointTCI-StateList with more than one TCI-State and before application of an indicated TCI state from the configured TCI states:
The UE assumes that DM-RS of PDSCH and DM-RS of PDCCH and the CSI-RS applying the indicated TCI state are quasi co-located with the SS/PBCH block the UE identified during the initial access procedure

After a UE receives an initial higher layer configuration of dl-OrJointTCI-StateList with more than one TCI-State or ul-TCI-StateList with more than one TCI-UL-State and before application of an indicated TCI state from the configured TCI states:
The UE assumes that the UL TX spatial filter, if applicable, for dynamic-grant and configured-grant based PUSCH and PUCCH, and for SRS applying the indicated TCI state, is the same as that for a PUSCH transmission scheduled by a RAR UL grant during the initial access procedure

After a UE receives a higher layer configuration of dl-OrJointTCI-StateList with more than one TCI-State as part of a Reconfiguration with sync procedure as described in [12, TS 38.331] and before applying an indicated TCI state from the configured TCI states:
The UE assumes that DM-RS of PDSCH and DM-RS of PDCCH, and the CSI-RS applying the indicated TCI state are quasi co-located with the SS/PBCH block or the CSI-RS resource the UE identified during the random access procedure initiated by the Reconfiguration with sync procedure as described in [12, TS 38.331].

After a UE receives a higher layer configuration of dl-OrJointTCI-StateList with more than one TCI-State or more than one TCI-UL-State as part of a Reconfiguration with sync procedure as described in [12, TS 38.331] and before applying an indicated TCI state from the configured TCI states:
The UE assumes that the UL TX spatial filter, if applicable, for dynamic-grant and configured-grant based PUSCH and PUCCH, and for SRS applying the indicated TCI state, is the same as that for a PUSCH transmission scheduled by a RAR UL grant during random access procedure initiated by the Reconfiguration with sync procedure as described in [12, TS 38.331].

If a UE receives a higher layer configuration of dl-OrJointTCI-StateList with a single TCI-State, that can be used as an indicated TCI state, the UE obtains the QCL assumptions from the configured TCI state for DM-RS of PDSCH and DM-RS of PDCCH, and the CSI-RS applying the indicated TCI state.

If a UE receives a higher layer configuration of dl-OrJointTCI-StateList with a single TCI-State or ul-TCI-StateList with a single TCI-UL-State, that can be used as an indicated TCI state, the UE determines an UL TX spatial filter, if applicable, from the configured TCI state for dynamic-grant and configured-grant based PUSCH and PUCCH, and SRS applying the indicated TCI state.

When a UE configured with dl-OrJointTCI-StateList would transmit a PUCCH with positive HARQ-ACK or a PUSCH with positive HARQ-ACK corresponding to the DCI carrying the TCI State indication and without DL assignment, or corresponding to the PDSCH scheduled by the DCI carrying the TCI State indication, and if the indicated TCI State is different from the previously indicated one, the indicated TCI-State and/or TCI-UL-State should be applied starting from the first slot that is at least beamAppTime symbols after the last symbol of the PUCCH or the PUSCH. The first slot and the beamAppTime symbols are both determined on the active BWP with the smallest SCS among the BWP(s) from the CCs applying the indicated TCI-State or TCI-UL-State that are active at the end of the PUCCH or the PUSCH carrying the positive HARQ-ACK.

If a UE is configured with pdsch-TimeDomainAllocationListForMultiPDSCH in which one or more rows contain multiple SLIVs for PDSCH on a DL BWP of a serving cell, and the UE is receiving a DCI carrying the TCI-State indication and without DL assignment, the UE does not expect that the number of indicated SLIVs in the row of the pdsch-TimeDomainAllocationListForMultiPDSCH by the DCI is more than one.

If the UE is configured with SSB-MTC-AddtionalPCI and with PDCCH-Config that contains two different values of coresetPoolIndex in ControlResourceSet, the UE receives an activation command for CORESET associated with each coresetPoolIndex, as described in clause 6.1.3.14 of [10, TS 38.321], used to map up to 8 TCI states to the codepoints of the DCI field ‘Transmission Configuration Indication’ in one CC/DL BWP. When a set of TCI state IDs are activated for a coresetPoolIndex, the activated TCI states corresponding to one coresetPoolIndex is associated with the serving cell physical cell ID and activated TCI states corresponding to another coresetPoolIndex can be associated with another physical cell ID.

When a UE supports two TCI states in a codepoint of the DCI field ‘Transmission Configuration Indication’ the UE may receive an activation command, as described in clause 6.1.3.24 of [10, TS 38.321], the activation command is used to map up to 8 combinations of one or two TCI states to the codepoints of the DCI field ‘Transmission Configuration Indication’. The UE is not expected to receive more than 8 TCI states in the activation command.

When the DCI field ‘Transmission Configuration Indication’ is present in DCI format 1_2 and when the number of codepoints S in the DCI field ‘Transmission Configuration Indication’ of DCI format 1_2 is smaller than the number of TCI codepoints that are activated by the activation command, as described in clause 6.1.3.14 and 6.1.3.24 of [10, TS38.321], only the first S activated codepoints are applied for DCI format 1_2.

When the UE would transmit a PUCCH with HARQ-ACK information in slot n corresponding to the PDSCH carrying the activation command, the indicated mapping between TCI states and codepoints of the DCI field ‘Transmission Configuration Indication’ should be applied starting from the first slot that is after

$$slot n + 3 {N}_{slot}^{subframe , μ} + \frac{2 μ}{{2}^{{μ}_{{K}_{mac}}}} \cdot {k}_{mac}$$

where μ is the SCS configuration for the PUCCH and μ_{K}_{_{mac}} is the subcarrier spacing configuration for k_{mac} with a value of 0 for frequency range 1, and k_{mac} is provided by K-Mac or k_{mac}=0 if K-Mac is not provided. If tci-PresentInDCI is set to ‘enabled’ or tci-PresentDCI-1-2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the SS/PBCH block determined in the initial access procedure with respect to qcl-Type set to ‘typeA’, and when applicable, also with respect to qcl-Type set to ‘typeD’.

If a UE is configured with the higher layer parameter tci-PresentInDCI that is set as ‘enabled’ for the CORESET scheduling a PDSCH, the UE assumes that the TCI field is present in the DCI format 1_1 of the PDCCH transmitted on the CORESET. If a UE is configured with the higher layer parameter tci-PresentDCI-1-2 for the CORESET scheduling the PDSCH, the UE assumes that the TCI field with a DCI field size indicated by tci-PresentDCI-1-2 is present in the DCI format 1_2 of the PDCCH transmitted on the CORESET. If a UE is configured with the higher layer parameter tci-PresentInDCI that is set as ‘enabled’ for the CORESET scheduling the multicast PDSCH, the UE assumes that the TCI field is present in the DCI format 4_2 of the PDCCH transmitted on the CORESET. If the PDSCH is scheduled by a DCI format not having the TCI field present, and the time offset between the reception of the DL DCI and the corresponding PDSCH of a serving cell is equal to or greater than a threshold timeDurationForQCL if applicable, where the threshold is based on reported UE capability [13, TS 38.306], for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.

When a UE is configured with both sfnSchemePdcch and sfnSchemePdsch scheduled by DCI format 1_0 or by DCI format 1_1/1_2, if the time offset between the reception of the DL DCI and the corresponding PDSCH of a serving cell is equal to or greater than a threshold timeDurationForQCL if applicable:
if the UE supports sfn-DefaultDL-BeamSetup-r17 for DCI scheduling without TCI field, the UE assumes that the TCI state(s) or the QCL assumption(s) for the PDSCH is identical to the TCI state(s) or QCL assumption(s) whichever is applied for the CORESET used for the reception of the DL DCI within the active BWP of the serving cell regardless of the number of active TCI states of the CORESET. If the UE does not support sfn-SchemeA-DynamicSwitching-r17 or sfn-SchemeB-DynamicSwitching-r17, the UE should be activated with the CORESET with two TCI states.
else if the UE does not support sfn-DefaultDL-BeamSetup-r17 for DCI scheduling without TCI field, the UE shall expect TCI field present when scheduled by DCI format 1_1/1_2.

When a UE is configured with sfnSchemePdsch and sfnSchemePdcch is not configured, when scheduled by DCI format 1_1/1_2, if the time offset between the reception of the DL DCI and the corresponding PDSCH of a serving cell is equal to or greater than a threshold timeDurationForQCL if applicable, the UE shall expect TCI field present.

For PDSCH scheduled by DCI format 1_0, 1_1, 1_2, when a UE is configured with sfnSchemePdcch set to ‘sfnSchemeA’ and sfnSchemePdsch is not configured, and there is no TCI codepoint with two TCI states in the activation command, and if the time offset between the reception of the DL DCI and the corresponding PDSCH is equal or larger than the threshold timeDurationForQCL if applicable and the CORESET which schedules the PDSCH is indicated with two TCI states, the UE assumes that the TCI state or the QCL assumption for the PDSCH is identical to the first TCI state or QCL assumption which is applied for the CORESET used for the PDCCH transmission within the active BWP of the serving cell.

If a PDSCH is scheduled by a DCI format having the TCI field present, the TCI field in DCI in the scheduling component carrier points to the activated TCI states in the scheduled component carrier or DL BWP, the UE shall use the TCI-State according to the value of the ‘Transmission Configuration Indication’ field in the detected PDCCH with DCI for determining PDSCH antenna port quasi co-location. The UE may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timeDurationForQCL, where the threshold is based on reported UE capability [13, TS 38.306]. For a single slot PDSCH, the indicated TCI state(s) should be based on the activated TCI states in the slot with the scheduled PDSCH. For a multi-slot PDSCH or the UE is configured with higher layer parameter pdsch-TimeDomainAllocationListForMultiPDSCH, the indicated TCI state(s) should be based on the activated TCI states in the first slot with the scheduled PDSCH(s), and UE shall expect the activated TCI states are the same across the slots with the scheduled PDSCH(s). When the UE is configured with CORESET associated with a search space set for cross-carrier scheduling and the UE is not configured with enableDefaultBeamForCCS, the UE expects tci-PresentInDCI is set as ‘enabled’ or tci-PresentDCI-1-2 is configured for the CORESET, and if one or more of the TCI states configured for the serving cell scheduled by the search space set contains qcl-Type set to ‘typeD’, the UE expects the time offset between the reception of the detected PDCCH in the search space set and a corresponding PDSCH is larger than or equal to the threshold timeDurationForQCL.

Independent of the configuration of tci-PresentInDCI and tci-PresentDCI-1-2 in RRC connected mode, if the UE is not provided dl-OrJointTCI-StateList-r17, and if the offset between the reception of the DL DCI and the corresponding PDSCH is less than the threshold timeDurationForQCL and at least one configured TCI state for the serving cell of scheduled PDSCH contains qcl-Type set to ‘typeD’,
the UE may assume that the DM-RS ports of PDSCH(s) of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In this case, if the qcl-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).
If a UE is configured with enableDefaultTCI-StatePerCoresetPoolIndex and the UE is configured by higher layer parameter PDCCH-Config that contains two different values of coresetPoolIndex in different ControlResourceSets,
   the UE may assume that the DM-RS ports of PDSCH associated with a value of coresetPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of coresetPoolIndex as the PDCCH scheduling that PDSCH, in the latest slot in which one or more CORESETs associated with the same value of coresetPoolIndex as the PDCCH scheduling that PDSCH within the active BWP of the serving cell are monitored by the UE. In this case, if the ‘QCL-TypeD’ of the PDSCH DM-RS is different from that of the PDCCH DM-RS with which they overlap in at least one symbol and they are associated with same value of coresetPoolIndex, the UE is expected to prioritize the reception of PDCCH associated with that CORESET.

This also applies to the intra-band CA case (when PDSCH and the CORESET are in different component carriers).
If a UE is configured with enableTwoDefaultTCI-States, and at least one TCI codepoint indicates two TCI states, the UE may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE is configured by higher layer parameter repetitionScheme set to ‘tdmSchemeA’ or is configured with higher layer parameter repetitionNumber, and the offset between the reception of the DL DCI and the first PDSCH transmission occasion is less than the threshold timeDurationForQCL, the mapping of the TCI states to PDSCH transmission occasions is determined according to clause 5.1.2.1 by replacing the indicated TCI states with the TCI states corresponding to the lowest codepoint among the TCI codepoints containing two different TCI states based on the activated TCI states in the slot with the first PDSCH transmission occasion. In this case, if the ‘QCL-TypeD’ in both of the TCI states corresponding to the lowest codepoint among the TCI codepoints containing two different TCI states is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers)
If a UE is not configured with sfnSchemePdsch, and the UE is configured with sfnSchemePdcch set to ‘sfnSchemeA’ and there is no TCI codepoint witih two TCI states in the activation command and the CORESET with the lowest ID in the latest slot is indicated with two TCI states, the UE may assume that the DM-RS ports of PDSCH of a serving cell are quasi co-located with the RS(s) with respect to the QCL parameter(s) associated with the first TCI state of two TCI states indicated for the CORESET. In this case, if the qcl-Type is set to ‘typeD’ of the PDSCH DM-RS is different from that of the PDCCH DM-RS with which they overlap in at least one symbol, the UE is expected to prioritize the reception of PDCCH associated with that CORESET with single active TCI state. This also applies to the intra-band CA case (when PDSCH and the CORESET are in different component carriers).
In all cases above, if none of configured TCI states for the serving cell of scheduled PDSCH is configured with qcl-Type set to ‘typeD’, the UE shall obtain the other QCL assumptions from the indicated TCI state(s) for its scheduled PDSCH irrespective of the time offset between the reception of the DL DCI and the corresponding PDSCH.

Independent of the configuration of tci-PresentInDCI and tci-PresentDCI-1-2 in RRC connected mode, if the UE is provided dl-OrJointTCI-StateList-r17, and if the offset between the reception of the DL DCI and the corresponding PDSCH is less than the threshold timeDurationForQCL and at least one configured TCI state for the serving cell of scheduled PDSCH contains qcl-Type set to ‘typeD’, regardless of configuration of followUnifiedTCI-State,
if the indicated TCI state is associated with the PCI of the serving cell, the indicated TCI state is applied to PDSCH reception.
if the indicated TCI state is associated with a PCI different from the serving cell, the UE may assume that the DM-RS ports of PDSCH(s) of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In the CA case, if the ‘QCL-TypeD’ of the PDSCH DM-RSs from respective CCs in a band are different in a slot, the QCL-TypeD assumption of the PDSCH DM-RS in the CC with lowest CC ID in the band is applied to all the PDSCH DM-RSs in the CCs in the band. In this case, if the qcl-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).

If the PDCCH carrying the scheduling DCI is received on one component carrier, and a PDSCH scheduled by that DCI is on another component carrier:
The timeDurationForQCL is determined based on the subcarrier spacing of the scheduled PDSCH. If μ_{PDCCH}<μ_{PDSCH} an additional timing delay

$$d \frac{{2}^{{μ}_{PDSCH}}}{{2}^{{μ}_{PDCCH}}}$$

is added to the timeDurationForQCL, where d is defined in 5.2.1.5.1a-1, otherwise d is zero;
When the UE is configured with enableDefaultBeamForCCS, if the offset between the reception of the DL DCI and the corresponding PDSCH is less than the threshold timeDurationForQCL, or if the DL DCI does not have the TCI field present, the UE obtains its QCL assumption for the scheduled PDSCH from the activated TCI state with the lowest ID applicable to PDSCH in the active BWP of the scheduled cell.

A UE that has indicated a capability beamCorrespondenceWithoutUL-BeamSweeping set to ‘supported’, as described in [13, TS 38.306], can determine a spatial domain filter to be used while performing the applicable channel access procedures described in [16, TS 37.213] prior to a UL transmission on the channel as follows:
if UE is indicated with an SRI corresponding to the UL transmission, the UE may use a spatial domain filter that is same as the spatial domain transmission filter associated with the indicated SRI,
if UE is configured with SRS-spatialRelationInfo for the UL transmission, the UE may use a spatial domain filter that is same as the spatial domain filter associated with referenceSignal in the corresponding SRS-spatialRelationInfo,
if UE is configured with TCI-State in dl-OrJointTCI-StateList or TCI-UL-State in ul-TCI-StateList, the UE may use a spatial domain filter that is same as the spatial domain receive filter the UE may use to receive the DL reference signal associated with the indicated TCI state.

When the PDCCH reception includes two PDCCH from two respective search space sets, as described in clause 10.1 of [6, TS 38.213], for the purpose of determining the time offset between the reception of the DL DCI and the corresponding PDSCH, the PDCCH candidate that ends later in time is used. When the PDCCH reception includes two PDCCH candidates from two respective search space sets, as described in clause 10.1 of [6, TS 38.213], for the configuration of tci-PresentInDCI or tci-PresentDCI-1-2, the UE expects the same configuration in the first and second CORESETs associated with the two PDCCH candidates; and if the PDSCH is scheduled by a DCI format not having the TCI field present and if the scheduling offset is equal to or larger than timeDurationForQCL, if applicable, PDSCH QCL assumption is based on the CORESET with lower ID among the first and second CORESETs associated with the two PDCCH candidates.

For a periodic CSI-RS resource in an NZP-CSI-RS-ResourceSet configured with higher layer parameter trs-Info, the UE shall expect that a TCI-State indicates one of the following quasi co-location type(s):
‘typeC’ with an SS/PBCH block and, when applicable, ‘typeD’ with the same SS/PBCH block where SS/PBCH block may have a PCI different from the PCI of the serving cell. The UE can assume center frequency, SCS, SFN offset are the same for SS/PBCH block from the serving cell and SS/PBCH block having a PCI different from the serving cell, or
‘typeC’ with an SS/PBCH block and, when applicable, ‘typeD’ with a CSI-RS resource in an NZP-CSI-RS-ResourceSet configured with higher layer parameter repetition, where SS/PBCH block may have a PCI different from the PCI of the serving cell. The UE can assume center frequency, SCS, SFN offset are the same for SS/PBCH block from the serving cell and SS/PBCH block having a PCI different from the serving cell.

For periodic/semi-persistent CSI-RS, if the UE is configured with dl-OrJointTCI-StateList, the UE can assume that the indicated TCI-State is not applied.

For an aperiodic CSI-RS resource in an NZP-CSI-RS-ResourceSet configured with higher layer parameter trs-Info, the UE shall expect that a TCI-State indicates qcl-Type set to ‘typeA’ with a periodic CSI-RS resource in a NZP-CSI-RS-ResourceSet configured with higher layer parameter trs-Info and, when applicable, qcl-Type set to ‘typeD’ with the same periodic CSI-RS resource.

For a CSI-RS resource in an NZP-CSI-RS-ResourceSet configured without higher layer parameter trs-Info and without the higher layer parameter repetition, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with an SS/PBCH block, where SS/PBCH block may have a PCI different from the PCI of the serving cell. The UE can assume center frequency, SCS, SFN offset are the same for SS/PBCH block from the serving cell and SS/PBCH block having a PCI different from the serving cell, or
‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition, or
‘typeB’ with a CSI-RS resource in a NZP-CSI-RS-ResourceSet configured with higher layer parameter trs-Info when ‘typeD’ is not applicable.

For a CSI-RS resource in an NZP-CSI-RS-ResourceSet configured with higher layer parameter repetition, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition, or
‘typeC’ with an SS/PBCH block and, when applicable, ‘typeD’ with the same SS/PBCH block, the reference RS may additionally be an SS/PBCH block having a PCI different from the PCI of the serving cell. The UE can assume center frequency, SCS, SFN offset are the same for SS/PBCH block from the serving cell and SS/PBCH block having a PCI different from the serving cell.

For the DM-RS of PDCCH, if the UE is not configured with dl-OrJointTCI-StateList, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
‘typeA’ with a CSI-RS resource in a NZP-CSI-RS-ResourceSet configured without higher layer parameter trs-Info and without higher layer parameter repetition and, when applicable, ‘typeD’ with the same CSI-RS resource.

When a UE is configured with sfnSchemePdcch set to ‘sfnSchemeA’, and CORESET is activated with two TCI states, the UE shall assume that the DM-RS port(s) of the PDCCH in the CORESET is quasi co-located with the DL-RSs of the two TCI states. When a UE is configured with sfnSchemePdcch set to ‘sfnSchemeB’, and a CORESET is activated with two TCI states, the UE shall assume that the DM-RS port(s) of the PDCCH is quasi co-located with the DL-RSs of the two TCI states except for quasi co-location parameters {Doppler shift, Doppler spread} of the second indicated TCI state.

For the DM-RS of PDSCH, if the UE is not configured with dl-OrJointTCI-StateList, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
typeA′ with a CSI-RS resource in a NZP-CSI-RS-ResourceSet configured without higher layer parameter trs-Info and without higher layer parameter repetition and, when applicable, ‘typeD’ with the same CSI-RS resource.

For the DM-RS of PDCCH, if the UE is configured with dl-OrJointTCI-StateList, the UE shall expect that an indicated TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition.

For the DM-RS of PDSCH, if the UE is configured with dl-OrJointTCI-StateList, the UE shall expect that an indicated TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition.

When a UE is configured with sfnSchemePdsch set to ‘sfnSchemeA’, and the UE is indicated with two TCI states in a codepoint of the DCI field ‘Transmission Configuration Indication’ in a DCI scheduling a PDSCH, the UE shall assume that the DM-RS port(s) of the PDSCH is quasi co-located with the DL-RSs of the two TCI states. When a UE is configured with sfnSchemePdsch set to ‘sfnSchemeB’, and the UE is indicated with two TCI states in a codepoint of the DCI field ‘Transmission Configuration Indication’ in a DCI scheduling a PDSCH, the UE shall assume that the DM-RS port(s) of the PDSCH is quasi co-located with the DL-RSs of the two TCI states except for quasi co-location parameters {Doppler shift, Doppler spread} of the second indicated TCI state.

In [4] 3GPP TS 38.213, V17.6.0 (2023 June), the following is provided:

### 6 Link Recovery Procedures

A UE can be provided, for each BWP of a serving cell, a set q̅₀ of periodic CSI-RS resource configuration indexes by failureDetectionResourcesToAddModList and a set q̅₁ of periodic CSI-RS resource configuration indexes and/or SS/PBCH block indexes by candidateBeamRSList or candidateBeamRSListExt or candidateBeamRSSCellList for radio link quality measurements on the BWP of the serving cell. Instead of the sets q̅₀ and q̅₁, for each BWP of a serving cell, the UE can be provided respective two sets q̅_{0,0} and q̅_{0,1} of periodic CSI-RS resource configuration indexes by failureDetectionSet1 and failureDetectionSet2 that can be activated by a MAC CE [11 TS 38.321] and corresponding two sets q̅_{1,0} and q̅_{1,1} of periodic CSI-RS resource configuration indexes and/or SS/PBCH block indexes by candidateBeamRS-List and candidateBeamRS-List2, respectively, for radio link quality measurements on the BWP of the serving cell. The set q̅_{0,0} is associated with the set q̅_{1,0} and the set q̅_{0,1} is associated with the set q̅_{1,1}.

If the UE is not provided q̅₀ by failureDetectionResourcesToAddModList for a BWP of the serving cell, the UE determines the set q̅₀ to include periodic CSI-RS resource configuration indexes with same values as the RS indexes in the RS sets indicated by TCI-State for respective CORESETs that the UE uses for monitoring PDCCH. If the UE is not provided q̅_{0,0} and q̅_{0,1} for a BWP of the serving cell, the UE determines the set q̅_{0,0} and q̅_{0,1} to include periodic CSI-RS resource configuration indexes with same values as the RS indexes in the RS sets indicated by TCI-State for first and second CORESETs that the UE uses for monitoring PDCCH, respectively, where the UE is provided two coresetPoolIndex values 0 and 1 for the first and second CORESETs, or is not provided coresetPoolIndex value for the first CORESETs and is provided coresetPoolIndex value of 1 for the second CORESETs, respectively. If there are two RS indexes in a TCI state, the set q̅₀ or q̅_{0,0}, or q̅_{0,1} includes RS indexes configured with qcl-Type set to ‘typeD’ for the corresponding TCI states. If a CORESET that the UE uses for monitoring PDCCH includes two TCI states and the UE is provided sfnSchemePdcch set to ‘sfnSchemeA’ or ‘sfnSchemeB’, the set q̅₀ includes RS indexes in the RS sets associated with the two TCI states.

The UE expects the set q̅₀ to include up to two RS indexes. If the UE is provided q̅_{0,0} or q̅_{0,1}, the UE expects the set q̅_{0,0} or the set q̅_{0,1} to include up to a number of N_{BFD} RS indexes indicated by maxBFD-RS-resourcesPerSetPerBWP. If the UE is not provided q̅_{0,0} or q̅_{0,1}, and if a number of active TCI states for PDCCH receptions in the first or second CORESETs is larger than N_{BFD}, the UE determines the set q̅_{0,0} or q̅_{0,1} to include periodic CSI-RS resource configuration indexes with same values as the RS indexes in the RS sets associated with the active TCI states for PDCCH receptions in the first or second CORESETs corresponding to search space sets according to an ascending order for PDCCH monitoring periodicity. If more than one first or second CORESETs correspond to search space sets with same monitoring periodicity, the UE determines the order of the first or second CORESETs according to a descending order of a CORESET index.

If a UE
is not provided coresetPoolIndex or is provided coresetPoolIndex with a value of 0 for first CORESETs on an active DL BWP of a serving cell,
is provided coresetPoolIndex with a value of 1 for second CORESETs on the active DL BWP of the serving cells, and
is provided SSB-MTCAdditionalPCI

SS/PBCH block indexes associated with a physical cell identity other than the one provided by physCellId in ServingCellConfigCommon can be provided in either q̅_{1,0} or q̅_{1,1} set and the corresponding q̅_{0,0} or q̅_{0,1} set is associated with the physical cell identity.

The UE expects single port RS in the set q̅₀, or q̅_{0,0}, or q̅_{0,1}. The UE expects single-port or two-port CSI-RS with frequency density equal to 1 or 3 REs per RB in the set q̅₁, or q̅_{1,0}, or q̅_{1,1}. The thresholds Q_{out,LR} and Q_{in,LR} correspond to the default value of rlmInSyncOutOfSyncThreshold, as described in [10, TS 38.133] for Qₒᵤₜ, and to the value provided by rsrp-ThresholdSSB or rsrp-ThresholdBFR, respectively.

The physical layer in the UE assesses the radio link quality according to the set q̅₀, q̅_{0,0}, or q̅_{0,1}, of resource configurations against the threshold Q_{out,LR}. For the set go, the UE assesses the radio link quality only according to SS/PBCH blocks on the PCell or the PSCell or periodic CSI-RS resource configurations that are quasi co-located, as described in [6, TS 38.214], with the DM-RS of PDCCH receptions by the UE. The UE applies the Q_{in,LR} threshold to the L1-RSRP measurement obtained from a SS/PBCH block. The UE applies the Q_{in,LR} threshold to the L1-RSRP measurement obtained for a CSI-RS resource after scaling a respective CSI-RS reception power with a value provided by powerControlOffsetSS.

In non-DRX mode operation, the physical layer in the UE provides an indication to higher layers when the radio link quality for all corresponding resource configurations in the set q̅₀, or in the set q̅_{0,0}, or q̅_{0,1}, that the UE uses to assess the radio link quality is worse than the threshold Q_{out,LR}. The physical layer informs the higher layers when the radio link quality is worse than the threshold Q_{out,LR} with a periodicity determined by the maximum between the shortest periodicity among the SS/PBCH blocks on the PCell or the PSCell and/or the periodic CSI-RS configurations in the set q̅₀, q̅_{0,0}, or q_{0,1} that the UE uses to assess the radio link quality and 2 msec. In DRX mode operation, the physical layer provides an indication to higher layers when the radio link quality is worse than the threshold Q_{out,LR} with a periodicity determined as described in [10, TS 38.133].

For the PCell or the PSCell, upon request from higher layers, the UE provides to higher layers the periodic CSI-RS configuration indexes and/or SS/PBCH block indexes from the set q̅₁, or q̅_{1,0}, or q̅_{1,1} and the corresponding L1-RSRP measurements that are larger than or equal to the Q_{in,LR} threshold.

For the SCell, upon request from higher layers, the UE indicates to higher layers whether there is at least one periodic CSI-RS configuration index or SS/PBCH block index from the set q̅₁, or q̅_{1,0}, or q̅_{1,1} with corresponding L1-RSRP measurements that is larger than or equal to the Q_{in,LR} threshold, and provides the periodic CSI-RS configuration indexes and/or SS/PBCH block indexes from the set q̅₁, or q̅_{1,0}, or q̅_{1,1} and the corresponding L1-RSRP measurements that are larger than or equal to the Q_{in,LR} threshold, if any.

For the PCell or the PSCell, a UE can be provided a CORESET through a link to a search space set provided by recoverySearchSpaceId, as described in clause 10.1, for monitoring PDCCH in the CORESET. If the UE is provided recoverySearchSpaceId, the UE does not expect to be provided another search space set for monitoring PDCCH in the CORESET associated with the search space set provided by recoverySearchSpaceId.

For the PCell or the PSCell, the UE can be provided, by PRACH-ResourceDedicatedBFR, a configuration for PRACH transmission as described in clause 8.1. For PRACH transmission in slot n and according to antenna port quasi co-location parameters associated with periodic CSI-RS resource configuration or with SS/PBCH block associated with index q_{new} provided by higher layers [11, TS 38.321], the UE monitors PDCCH in a search space set provided by recoverySearchSpaceId for detection of a DCI format with CRC scrambled by C-RNTI or MCS-C-RNTI starting from slot n+4+2^{μ}·k_{mac}, where μ is the SCS configuration for the PRACH transmission and k_{mac} is a number of slots provided by k_{mac} [12, TS 38.331] or k_{mac}=0 if k_{mac} is not provided, within a window configured by BeamFailureRecoveryConfig. For PDCCH monitoring in a search space set provided by recoverySearchSpaceId and for corresponding PDSCH receptions, the UE assumes the same antenna port quasi-collocation parameters as the ones associated with index q_{new} until the UE receives by higher layers an activation for a TCI state or any of the parameters tci-StatesPDCCH-ToAddList and/or tci-StatesPDCCH-ToReleaseList. After the UE detects a DCI format with CRC scrambled by C-RNTI or MCS-C-RNTI in the search space set provided by recoverySearchSpaceId, the UE continues to monitor PDCCH candidates in the search space set provided by recoverySearchSpaceId until the UE receives a MAC CE activation command for a TCI state or tci-StatesPDCCH-ToAddList and/or tci-StatesPDCCH-ToReleaseList.

For the PCell or the PSCell, after 28 symbols from a last symbol of a first PDCCH reception in a search space set provided by recoverySearchSpaceId for which the UE detects a DCI format with CRC scrambled by C-RNTI or MCS-C-RNTI and until the UE receives an activation command for PUCCH-SpatialRelationInfo [11, TS 38.321] or is provided PUCCH-SpatialRelationInfo for PUCCH resource(s), the UE transmits a PUCCH on a same cell as the PRACH transmission using
a same spatial filter as for the last PRACH transmission
a power determined as described in clause 7.2.1 with qᵤ=0, q_{d}=q_{new}, and l=0

For the PCell or the PSCell and for sets q̅₀ and q̅₁, after 28 symbols from a last symbol of a first PDCCH reception in a search space set provided by recoverySearchSpaceId where a UE detects a DCI format with CRC scrambled by C-RNTI or MCS-C-RNTI, the UE assumes same antenna port quasi-collocation parameters as the ones associated with index q_{new} for PDCCH monitoring in a CORESET with index 0.

If a UE is provided dl-OrJointTCI-StateList or ul-TCI-StateList indicating a unified TCI state for the PCell or the PSCell [6, TS 38.214], after 28 symbols from a last symbol of a first PDCCH reception in a search space set provided by recoverySearchSpaceId where the UE detects a DCI format with CRC scrambled by C-RNTI or MCS-C-RNTI, the UE
if SSB-MTC-AdditionalPCI is not provided, monitors PDCCH in all CORESETs, and receives PDSCH and aperiodic CSI-RS resource in a CSI-RS resource set with same indicated TCI state as for the PDCCH and PDSCH, using the same antenna port quasi co-location parameters as the ones associated with the corresponding index q_{new}, if any
transmits PUSCH, PUCCH and SRS that uses a same spatial domain filter with same indicated TCI state as for the PUSCH and the PUCCH, using a same spatial domain filter as for the last PRACH transmission using the following parameters for determination of a corresponding power as described in clauses 7.1.1, 7.2.1, and 7.3.1
   the RS index q_{d}=q_{new} for obtaining the downlink pathloss estimate
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the PCell or the PSCell
the value of P_{O_PUCCH,b,f,c}(qᵤ) and the PUCCH power control adjustment state l provided by p0AlphaSetforPUCCH associated with the smallest value of ul-powercontrolId for the PCell or the PSCell
the values of P_{O_SRS,b,f,c}(qₛ), α_{SRS,b,f,c}(qₛ), and the SRS power control adjustment state l provided by p0AlphaSetforSRS associated with the smallest value of ul-powercontrolId for the PCell or the PSCell

For the remaining of this clause, if a PDCCH reception includes two PDCCH candidates from two linked search space sets based on searchSpaceLinkingId, as described in clause 10.1, the last symbol of the PDCCH reception is the last symbol of the PDCCH candidate that ends later. The PDCCH reception includes the two PDCCH candidates also when the UE is not required to monitor one of the two PDCCH candidates as described in clauses 10 (except clause 10.4), 11.1, 11.1.1 and 17.2.

For the PCell or the PSCell, if BFR MAC CE [11, TS 38.321] is provided in Msg3 or MsgA of contention based random access procedure, and if a PUCCH resource is provided with PUCCH-SpatialRelationInfo, after 28 symbols from the last symbol of the PDCCH reception that determines the completion of the contention based random access procedure as described in clause 5.1.4a or in clause 5.1.5 of [11, TS 38.321], the UE transmits the PUCCH on a same cell as the PRACH transmission using
a same spatial filter as for the last PRACH transmission
a power determined as described in clause 7.2.1 with qᵤ=0, q_{d}=q_{new}, and l=0, where q_{new} is the SS/PBCH block index selected for the last PRACH transmission.

If a UE is provided dl-OrJointTCI-StateList or ul-TCI-StateList indicating a unified TCI state for the PCell or the PSCell and the UE provides BFR MAC CE in Msg3 or MsgA of contention based random access procedure, after 28 symbols from the last symbol of the PDCCH reception that determines the completion of the contention based random access procedure as described in [11, TS 38.321], the UE
if SSB-MTC-AdditionalPCI is not provided, monitors PDCCH in all CORESETs, and receives PDSCH and aperiodic CSI-RS resource in a CSI-RS resource set with same indicated TCI state as for the PDCCH and PDSCH using the same antenna port quasi co-location parameters as the ones associated with the corresponding index q_{new}, if any
transmits PUSCH, PUCCH and SRS that uses a same spatial domain filter with same indicated TCI state as for the PUSCH and PUCCH, using a same spatial domain filter as for the last PRACH transmission using the following parameters for determination of a corresponding power as described in clauses 7.1.1, 7.2.1, and 7.3.1
   the RS index q_{d}=q_{new} for obtaining the downlink pathloss estimate
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the PCell or the PSCell
the value of P_{O_PUCCH,b,f,c}(qᵤ) and the PUCCH power control adjustment state l provided by p0AlphaSetforPUCCH associated with the smallest value of ul-powercontrolId for the PCell or the PSCell
the values of P_{O_SRS,b,f,c}(qₛ), α_{SRS,b,f,c}(qₛ), and the SRS power control adjustment state l provided by p0AlphaSetforSRS associated with the smallest value of ul-powercontrolId for the PCell or the PSCell

A UE can be provided, by schedulingRequestID-BFR-SCell, a configuration for PUCCH transmission with a link recovery request (LRR) as described in clause 9.2.4 for the UE to transmit PUCCH [11, TS 38.321]. If the PCell or the PSCell is associated with sets q̅_{0,0} and q̅_{1,0}, and with sets q̅_{0,1} and q̅_{1,1}, the UE can be provided by schedulingRequestID-BFR a first configuration for PUCCH transmission with a LRR and, if the UE provides twoLRRcapability, the UE can be provided by schedulingRequestID-BFR2 a second configuration for PUCCH transmission with a LRR. If the UE is provided only the first configuration, the UE transmits a PUCCH with LRR for either set q̅_{0,0} or q̅_{0,1}. If the UE is provided both the first and second configurations, the UE uses the first configuration to transmit a PUCCH with LRR associated with set q̅_{0,0} and the second configuration to transmit a PUCCH with LRR associated with set q̅_{0,1} [11, TS 38.321].

The UE can provide in a first PUSCH MAC CE index(es) for at least corresponding SCell(s) with radio link quality worse than Q_{out,LR}, indication(s) of presence of q_{new} for corresponding SCell(s), and index(es) q_{new} for a periodic CSI-RS configuration or for a SS/PBCH block provided by higher layers, as described in [11, TS 38.321], if any, for corresponding SCell(s). After 28 symbols from a last symbol of a PDCCH reception with a DCI format scheduling a PUSCH transmission with a same HARQ process number as for the transmission of the first PUSCH and having a toggled NDI field value, the UE
monitors PDCCH in all CORESETs on the SCell(s) indicated by the MAC CE using the same antenna port quasi co-location parameters as the ones associated with the corresponding index(es) q_{new}, if any
transmits PUCCH on a PUCCH-SCell using a same spatial domain filter as the one corresponding to q_{new}, if any, for periodic CSI-RS or SS/PBCH block reception, as described in clause 9.2.2, and using a power determined as described in clause 7.2.1 with qᵤ=0, q_{d}=q_{new}, and l=0, if
   the UE is provided PUCCH-SpatialRelationInfo for the PUCCH,
   a PUCCH with the LRR was either not transmitted or was transmitted on the PCell or the PSCell, and
   the PUCCH-SCell is included in the SCell(s) indicated by the MAC-CE
      where the SCS configuration for the 28 symbols is the smallest of the SCS configurations of the active DL BWP for the PDCCH reception and of the active DL BWP(s) of the at least one SCell.

If a UE is provided dl-OrJointTCI-StateList or ul-TCI-StateList indicating a unified TCI state, after 28 symbols from a last symbol of a PDCCH reception with a DCI format scheduling a PUSCH transmission with a same HARQ process number as for the transmission of the first PUSCH and having a toggled NDI field value, the UE
if SSB-MTC-AdditionalPCI is not provided, monitors PDCCH in all CORESETs, on the SCell (s) indicated by the MAC CE, and receives PDSCH and aperiodic CSI-RS resource in a CSI-RS resource set using the same antenna port quasi co-location parameters as the ones associated with the corresponding index q_{new}, if any
transmits PUSCH, PUCCH and SRS that uses a same spatial domain filter with same indicated TCI state as for the PUSCH and PUCCH, using a same spatial domain filter as the one corresponding to q_{new}, if any, and using the following parameters for determination of a corresponding power as described in clauses 7.1.1, 7.2.1, and 7.3.1
   the RS index q_{d}=q_{new} for obtaining the downlink pathloss estimate
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the corresponding SCell
the value of P_{O_PUCCH,b,f,c}(qᵤ) and the PUCCH power control adjustment state l provided by p0AlphaSetforPUCCH associated with the smallest value of ul-powercontrolId for the corresponding SCell
the values of P_{O_SRS,b,f,c}(qₛ), α_{SRS,b,f,c}(qₛ), and the SRS power control adjustment state l provided by p0AlphaSetforSRS associated with the smallest value of ul-powercontrolId for the corresponding SCell

If there is at least one serving cell associated with sets q̅_{0,0} and q̅_{1,0}, and with sets q̅_{0,1} and q̅_{1,1}, the UE can provide in a second PUSCH MAC CE index(es) for cell(s) with q̅₀ and/or with at least one of q̅_{0,0} and q̅_{0,1} having radio link quality worse than Q_{out,LR}, the index(es) of those q̅_{0,0} and/or q̅_{0,1}, and indication(s) of presence of q_{new} and of index(es) q_{new}, if any, from q̅₁ and/or corresponding sets q̅_{1,0} and/or q̅_{1,1} for the serving cells.

For serving cells associated with sets q̅_{0,0} and q̅_{1,0}, and with sets q̅_{0,1} and q̅_{1,1}, and having radio link quality worse than Q_{out,LR}, after 28 symbols from a last symbol of a first PDCCH reception with a DCI format scheduling a PUSCH transmission with a same HARQ process number as for transmission of the second PUSCH and having a toggled NDI field value, the UE assumes antenna port quasi-collocation parameters
corresponding to q_{new} from q̅_{1,0}, if any, for the first CORESETs,
corresponding to q_{new} from q̅_{1,1}, if any, for the second CORESETs
   where the SCS configuration for the 28 symbols is the smallest of the SCS configurations of the active DL BWP for the PDCCH reception and of the active DL BWP(s) of the serving cells.
   . . .

### 7.4 Physical Random Access Channel

A UE determines a transmission power for a physical random access channel (PRACH), P_{PRACH, b,f,c}(i), on active UL BWP b of carrier f of serving cell C based on DL RS for serving cell C in transmission occasion i as

$${P}_{PRACH , b , f , c} ( i ) = min \{ {P}_{CMAX f , c} ( i ) , {P}_{PRACH , target , f , c} + {PL}_{b , f , c} \} [ dB m ] ,$$

where P_{CMAX, f,c}(i) is the UE configured maximum output power defined in [8-1, TS 38.101-1], [8-2, TS 38.101-2] and [8-3, TS 38.101-3] for carrier f of serving cell C within transmission occasion i, P_{PRACH, target,f,c} is the PRACH target reception power PREAMBLE_RECEIVED_TARGET_POWER provided by higher layers [11, TS 38.321] for the active UL BWP b of carrier f of serving cell C, and PL_{b,f,c} is a pathloss for the active UL BWP b of carrier f based on the DL RS associated with the PRACH transmission on the active DL BWP of serving cell C and calculated by the UE in dB as referenceSignalPower—higher layer filtered RSRP in dBm, where RSRP is defined in [7, TS 38.215] and the higher layer filter configuration is defined in [12, TS 38.331]. If the active DL BWP is the initial DL BWP and for SS/PBCH block and CORESET multiplexing pattern 2 or 3, as described in clause 13, the UE determines PL_{b,f,c} based on the SS/PBCH block associated with the PRACH transmission.

If a PRACH transmission from a UE is not in response to a detection of a PDCCH order by the UE, or is in response to a detection of a PDCCH order by the UE that triggers a contention based random access procedure, or is associated with a link recovery procedure where a corresponding index q_{new} is associated with a SS/PBCH block, as described in clause 6, referenceSignalPower is provided by ss-PBCH-BlockPower.

If a PRACH transmission from a UE is in response to a detection of a PDCCH order by the UE that triggers a contention-free random access procedure and depending on the DL RS that the DM-RS of the PDCCH order is quasi-collocated with as described in clause 10.1, referenceSignalPower is provided by ss-PBCH-BlockPower or, if the UE is configured resources for a periodic CSI-RS reception or the PRACH transmission is associated with a link recovery procedure where a corresponding index q_{new} is associated with a periodic CSI-RS configuration as described in clause 6, referenceSignalPower is obtained by ss-PBCH-BlockPower and powerControlOffsetSS where powerControlOffsetSS provides an offset of CSI-RS transmission power relative to SS/PBCH block transmission power [6, TS 38.214]. If powerControlOffsetSS is not provided to the UE, the UE assumes an offset of 0 dB. If the active T state for the PDCCH that provides the PDCCH order includes two RS, the UE expects that one RS is configured with qcl-Type set to ‘typeD’ and the UE uses the one RS when applying a value provided by powerControlOffsetSS.

If within a random access response window, as described in clause 8.2, the UE does not receive a random access response that contains a preamble identifier corresponding to the preamble sequence transmitted by the UE, the UE determines a transmission power for a subsequent PRACH transmission, if any, as described in [11, TS 38.321].

If prior to a PRACH retransmission, a UE changes the spatial domain transmission filter, Layer 1 notifies higher layers to suspend the power ramping counter as described in [11, TS 38.321].

If due to power allocation to PUSCH/PUCCH/PRACH/SRS transmissions as described in clause 7.5, or due to power allocation in EN-DC or NE-DC or NR-DC operation, or due to slot format determination as described in clause 11.1, or due to the PUSCH/PUCCH/PRACH/SRS transmission occasions are in the same slot or the gap between a PRACH transmission and PUSCH/PUCCH/SRS transmission is small as described in clause 8.1, or due to DAPS operation as described in clause 15, or due to HD-UE operation in paired spectrum as described in clause 17.2, the UE does not transmit a PRACH in a transmission occasion, Layer 1 notifies higher layers to suspend the corresponding power ramping counter. If due to power allocation to PUSCH/PUCCH/PRACH/SRS transmissions as described in clause 7.5, or due to power allocation in EN-DC or NE-DC or NR-DC operation, the UE transmits a PRACH with reduced power in a transmission occasion, Layer 1 may notify higher layers to suspend the corresponding power ramping counter.

. . .

### 8 Random Access Procedure

Prior to initiation of the physical random access procedure, Layer 1 receives from higher layers a set of SS/PBCH block indexes and provides to higher layers a corresponding set of RSRP measurements.

Prior to initiation of the physical random access procedure, Layer 1 may receive from higher layers an indication to perform a Type-1 random access procedure, as described in clauses 8.1 through 8.4, or a Type-2 random access procedure as described in clauses 8.1 through 8.2A.

Prior to initiation of the physical random access procedure, Layer 1 receives the following information from the higher layers:
Configuration of physical random access channel (PRACH) transmission parameters (PRACH preamble format, time resources, and frequency resources for PRACH transmission).
Parameters for determining the root sequences and their cyclic shifts in the PRACH preamble sequence set (index to logical root sequence table, cyclic shift (N_{CS}), and set type (unrestricted, restricted set A, or restricted set B)).

From the physical layer perspective, the Type-1 L1 random access procedure includes the transmission of random access preamble (Msg1) in a PRACH, random access response (RAR) message with a PDCCH/PDSCH (Msg2), and when applicable, the transmission of a PUSCH scheduled by a RAR UL grant, and PDSCH for contention resolution.

From the physical layer perspective, the Type-2 L1 random access procedure includes the transmission of random access preamble in a PRACH and of a PUSCH (MsgA) and the reception of a RAR message with a PDCCH/PDSCH (MsgB), and when applicable, the transmission of a PUSCH scheduled by a fallback RAR UL grant, and PDSCH for contention resolution.

If a random access procedure is initiated by a PDCCH order to the UE, a PRACH transmission is with a same SCS as a PRACH transmission initiated by higher layers.

If a UE is configured with two UL carriers for a serving cell and the UE detects a PDCCH order, the UE uses the UL/SUL indicator field value from the detected PDCCH order to determine the UL carrier for the corresponding PRACH transmission.

### 8.1 Random Access Preamble

Physical random access procedure is triggered upon request of a PRACH transmission by higher layers or by a PDCCH order. A configuration by higher layers for a PRACH transmission includes the following:
A configuration for PRACH transmission [4, TS 38.211].
A preamble index, a preamble SCS, PP_{RACH,target}, a corresponding RA-RNTI, and a PRACH resource.

A PRACH is transmitted using the selected PRACH format with transmission power P_{PRACH,b,f,c}(i), as described in clause 7.4, on the indicated PRACH resource.

For Type-1 random access procedure, a UE is provided a number N of SS/PBCH block indexes associated with one PRACH occasion and a number R of contention based preambles per SS/PBCH block index per valid PRACH occasion by ssb-perRACH-OccasionAndCB-PreamblesPerSSB.

For Type-2 random access procedure with common configuration of PRACH occasions with Type-1 random access procedure, a UE is provided a number N of SS/PBCH block indexes associated with one PRACH occasion by ssb-perRACH-OccasionAndCB-PreamblesPerSSB and a number Q of contention based preambles per SS/PBCH block index per valid PRACH occasion by msgA-CB-PreamblesPerSSB-PerSharedRO. The PRACH transmission can be on a subset of PRACH occasions associated with a same SS/PBCH block index within an SSB-RO mapping cycle for a UE provided with a PRACH mask index by msgA-SSB-SharedRO-MaskIndex according to [11, TS 38.321].

For Type-2 random access procedure with separate configuration of PRACH occasions with Type-1 random access procedure, a UE is provided a number N of SS/PBCH block indexes associated with one PRACH occasion and a number R of contention based preambles per SS/PBCH block index per valid PRACH occasion by msgA-SSB-PerRACH-OccasionAndCB-PreamblesPerSSB when provided; otherwise, by ssb-perRACH-OccasionAndCB-PreamblesPerSSB.

For a random access procedure associated with a feature combination indicated by FeatureCombinationPreambles, a UE is provided a number N of SS/PBCH block indexes associated with one PRACH occasion by ssb-perRACH-OccasionAndCB-PreamblesPerSSB or msgA-SSB-PerRACH-OccasionAndCB-PreamblesPerSSB when provided and a number S of contention based preambles per SS/PBCH block index per valid PRACH occasion by startPreambleForThisPartition and numberOfPreamblesPerSSB-ForThisPartition. The PRACH transmission can be on a subset of PRACH occasions associated with a same SS/PBCH block index within an SSB-RO mapping cycle for a UE provided with a PRACH mask index by ssb-SharedRO-MaskIndex according to [11, TS 38.321].

For Type-1 random access procedure, or for Type-2 random access procedure with separate configuration of PRACH occasions from Type 1 random access procedure, if N<1, one SS/PBCH block index is mapped to 1/N consecutive valid PRACH occasions and R contention based preambles with consecutive indexes associated with the SS/PBCH block index per valid PRACH occasion start from preamble index 0. If N≥1, R contention based preambles with consecutive indexes associated with SS/PBCH block index n, 0≤n≤N−1, per valid PRACH occasion start from preamble index n·N_{preamble}^{total}/N where N_{preamble}^{total} is provided by totalNumberOfRA-Preambles for Type-1 random access procedure, or by msgA-TotalNumberOfRA-Preambles for Type-2 random access procedure with separate configuration of PRACH occasions from a Type 1 random access procedure, and is an integer multiple of N.

For Type-2 random access procedure with common configuration of PRACH occasions with Type-1 random access procedure, if N<1, one SS/PBCH block index is mapped to 1/N consecutive valid PRACH occasions and Q contention based preambles with consecutive indexes associated with the SS/PBCH block index per valid PRACH occasion start from preamble index R. If N≥1, Q contention based preambles with consecutive indexes associated with SS/PBCH block index n, 0≤n≤N−1, per valid PRACH occasion start from preamble index n·N_{preamble}^{total}/N+R, where N_{preamble}^{total} is provided by totalNumberOfRA-Preambles for Type-1 random access procedure.

For link recovery, a UE is provided N SS/PBCH block indexes associated with one PRACH occasion by ssb-perRACH-Occasion in BeamFailureRecoveryConfig. For a dedicated RACH configuration provided by RACH-ConfigDedicated, if cfra is provided, a UE is provided N SS/PBCH block indexes associated with one PRACH occasion by ssb-perRACH-Occasion in occasions. If N<1, one SS/PBCH block index is mapped to 1/N consecutive valid PRACH occasions. If N≥1, all consecutive N SS/PBCH block indexes are associated with one PRACH occasion.

SS/PBCH block indexes provided by ssb-PositionsInBurst in SIB1 or in ServingCellConfigCommon are mapped to valid PRACH occasions in the following order where the parameters are described in [4, TS 38.211].
First, in increasing order of preamble indexes within a single PRACH occasion
Second, in increasing order of frequency resource indexes for frequency multiplexed PRACH occasions
Third, in increasing order of time resource indexes for time multiplexed PRACH occasions within a PRACH slot
Fourth, in increasing order of indexes for PRACH slots

An association period, starting from frame 0, for mapping SS/PBCH block indexes to PRACH occasions is the smallest value in the set determined by the PRACH configuration period according Table 8.1-1 such that N_{Tx}^{SSB} SS/PBCH block indexes are mapped at least once to the PRACH occasions within the association period, where a UE obtains N_{Tx}^{SSB} from the value of ssb-PositionsInBurst in SIB1 or in Serving CellConfigCommon. If after an integer number of SS/PBCH block indexes to PRACH occasions mapping cycles within the association period there is a set of PRACH occasions or PRACH preambles that are not mapped to N_{Tx}^{SSB} SS/PBCH block indexes, no SS/PBCH block indexes are mapped to the set of PRACH occasions or PRACH preambles. An association pattern period includes one or more association periods and is determined so that a pattern between PRACH occasions and SS/PBCH block indexes repeats at most every 160 msec. PRACH occasions not associated with SS/PBCH block indexes after an integer number of association periods, if any, are not used for PRACH transmissions.

For a PRACH transmission by a UE triggered by a PDCCH order, the PRACH mask index field [5, TS 38.212], if the value of the random access preamble index field is not zero, indicates the PRACH occasion for the PRACH transmission where the PRACH occasions are associated with the SS/PBCH block index indicated by the SS/PBCH block index field of the PDCCH order. If the UE is provided K_{cell,offset} by cellSpecificKoffset, the PRACH occasion is after slot n+2^{μ}·K_{cell,offset} where n is the slot of the UL BWP for the PRACH transmission that overlaps with the end of the PDCCH order reception assuming T_{TA}=0, and μ is the SCS configuration for the PRACH transmission. If the PDCCH reception for the PDCCH order includes two PDCCH candidates from two linked search space sets based on searchSpaceLinkingId, as described in clause 10.1, the last symbol of the PDCCH reception is the last symbol of the PDCCH candidate that ends later. The PDCCH reception includes the two PDCCH candidates also when the UE is not required to monitor one of the two PDCCH candidates as described in clauses 10 (except clause 10.4), 11.1, 11.1.1 and 17.2.

For a PRACH transmission triggered by higher layers, if ssb-ResourceList is provided, the PRACH mask index is indicated by ra-ssb-OccasionMaskIndex which indicates the PRACH occasions for the PRACH transmission where the PRACH occasions are associated with the selected SS/PBCH block index.

The PRACH occasions are mapped consecutively per corresponding SS/PBCH block index. The indexing of the PRACH occasion indicated by the mask index value is reset per mapping cycle of consecutive PRACH occasions per SS/PBCH block index. The UE selects for a PRACH transmission the PRACH occasion indicated by PRACH mask index value for the indicated SS/PBCH block index in the first available mapping cycle.

For the indicated preamble index, the ordering of the PRACH occasions is
First, in increasing order of frequency resource indexes for frequency multiplexed PRACH occasions
Second, in increasing order of time resource indexes for time multiplexed PRACH occasions within a PRACH slot
Third, in increasing order of indexes for PRACH slots

For a PRACH transmission triggered upon request by higher layers, a value of ra-OccasionList [12, TS 38.331], if csirs-ResourceList is provided, indicates a list of PRACH occasions for the PRACH transmission where the PRACH occasions are associated with the selected CSI-RS index indicated by csi-RS. The indexing of the PRACH occasions indicated by ra-OccasionList is reset per association pattern period.

TABLE 8.1-1
Mapping between PRACH configuration period and SS/PBCH
block to PRACH occasion association period

| PRACH configuration | Association period (number |
|---|---|
| period (msec) | of PRACH configuration periods) |
| 10 | {1, 2, 4, 8, 16} |
| 20 | {1, 2, 4, 8} |
| 40 | {1, 2, 4} |
| 80 | {1, 2} |
| 160 | {1} |

For paired spectrum or supplementary uplink band all PRACH occasions are valid.

For unpaired spectrum,
if a UE is not provided tdd-UL-DL-ConfigurationCommon, a PRACH occasion in a PRACH slot is valid if it does not precede a SS/PBCH block in the PRACH slot and starts at least N_{gap} symbols after a last SS/PBCH block reception symbol, where N_{gap} is provided in Table 8.1-2 and, if channelAccessMode=“semiStatic” is provided, does not overlap with a set of consecutive symbols before the start of a next channel occupancy time where the UE does not transmit [15, TS 37.213].
   the candidate SS/PBCH block index of the SS/PBCH block corresponds to the SS/PBCH block index provided by ssb-PositionsInBurst in SIB1 or in ServingCellConfigCommon, as described in clause 4.1
If a UE is provided tdd-UL-DL-ConfigurationCommon, a PRACH occasion in a PRACH slot is valid if
   it is within UL symbols, or
   it does not precede a SS/PBCH block in the PRACH slot and starts at least N_{gap} symbols after a last downlink symbol and at least N_{gap} symbols after a last SS/PBCH block symbol, where N_{gap} is provided in Table 8.1-2, and if channelAccessMode=“semiStatic” is provided, does not overlap with a set of consecutive symbols before the start of a next channel occupancy time where there shall not be any transmissions, as described in [15, TS 37.213]
   the candidate SS/PBCH block index of the SS/PBCH block corresponds to the SS/PBCH block index provided by ssb-PositionsInBurst in SIB1 or in ServingCellConfigCommon, as described in clause 4.1.

For preamble format B4 [4, TS 38.211], N_{gap}=0.

TABLE 8.1-2
N_{gap} values for different preamble SCS μ

| Preamble SCS | N_{gap} |
|---|---|
| 1.25 kHz or 5 kHz | 0 |
| 15 kHz or 30 kHz or | 2 |
| 60 kHz or 120 kHz | |
| 480 kHz | 8 |
| 960 kHz | 16 |

If a random access procedure is initiated by a PDCCH order, the UE, if requested by higher layers, transmits a PRACH in the selected PRACH occasion, as described in [11, TS 38.321], for which a time between the last symbol of the PDCCH order reception and the first symbol of the PRACH transmission is larger than or equal to N_{T,2}+Δ_{BWPSwitching}+Δ_{Delay}+T_{switch} msec, where
N_{T,2} is a time duration of N₂ symbols corresponding to a PUSCH preparation time for UE processing capability 1 [6, TS 38.214] assuming μ corresponds to the smallest SCS configuration between the SCS configuration of the PDCCH order and the SCS configuration of the corresponding PRACH transmission
Δ_{BWPSwitching}=0 if the active UL BWP does not change and Δ_{BWPSwitching} is defined in [10, TS 38.133] otherwise
Δ_{Delay}=0.5 msec for FR1 and Δ_{Delay}=0.25 msec for FR2
T_{switch} is a switching gap duration as defined in [6, TS 38.214]

For a PRACH transmission using 1.25 kHz or 5 kHz SCS, the UE determines N₂ assuming SCS configuration μ=0.

For single cell operation or for operation with contiguous carrier aggregation in a same frequency band or for operation with non-contiguous carrier aggregation in a same frequency band if the UE is not provided with intraBandNC-PRACH-simulTx-r17, a UE does not transmit PRACH and PUSCH/PUCCH/SRS in a same slot with respect to the smallest SCS configuration between the SCS configuration for the UL BWP with the PRACH and the SCS configuration for the UL BWP with the PUSCH/PUCCH/SRS transmissions or when a gap between the first or last symbol of a PRACH transmission in a first slot is separated by less than N symbols from the last or first symbol, respectively, of a PUSCH/PUCCH/SRS transmission in a second slot where N=2 for μ=0 or μ=1, N=4 for μ=2 or μ=3, N=16 for μ=5, N=32 for μ=6, and μ is the smallest SCS configuration between the SCS configuration for the UL BWP with the PRACH and the SCS configuration for the UL BWP with the PUSCH/PUCCH/SRS transmissions. For a PUSCH transmission with repetition Type B, this applies to each actual repetition for PUSCH transmission [6, TS 38.214].

. . .

### 8.2 Random Access Response—Type-1 Random Access Procedure

. . .

If the UE attempts to detect the DCI format 1_0 with CRC scrambled by the corresponding RA-RNTI in response to a PRACH transmission initiated by a PDCCH order that triggers a contention-free random access procedure for the SpCell [11, TS 38.321], the UE may assume that the PDCCH that includes the DCI format 1_0 and the PDCCH order have same DM-RS antenna port quasi co-location properties. If the UE attempts to detect the DCI format 1_0 with CRC scrambled by the corresponding RA-RNTI in response to a PRACH transmission initiated by a PDCCH order that triggers a contention-free random access procedure for a secondary cell, the UE may assume the DM-RS antenna port quasi co-location properties of the CORESET associated with the Type1-PDCCH CSS set for receiving the PDCCH that includes the DCI format 1_0.

. . .

### 10.1 UE Procedure for Determining Physical Downlink Control Channel Assignment

A set of PDCCH candidates for a UE to monitor is defined in terms of PDCCH search space sets. A search space set can be a CSS set or a USS set. A UE monitors PDCCH candidates in one or more of the following search spaces sets
a Type0-PDCCH CSS set on the primary cell of the MCG configured by
   pdcch-ConfigSIB1 in MIB or by searchSpaceSIB1 in PDCCH-ConfigCommon or by searchSpaceZero in PDCCH-Config Common for a DCI format 1_0 with CRC scrambled by a SI-RNTI, or
   searchSpaceZero by providing searchSpaceID=0 for searchSpaceMCCH or searchSpaceMTCH for a DCI format 4_0 with CRC scrambled by a MCCH-RNTI or a G-RNTI for broadcast
a Type0A-PDCCH CSS set configured by searchSpaceOtherSystemInformation in PDCCH-ConfigCommon for a DCI format 1_0 with CRC scrambled by a SI-RNTI on the primary cell of the MCG
a Type0B-PDCCH CSS set configured by searchSpaceMCCH and searchSpaceMTCH for a DCI format 4_0 with CRC scrambled by a MCCH-RNTI or a G-RNTI for broadcast, on the primary cell of the MCG
a Type1-PDCCH CSS set configured by ra-SearchSpace in PDCCH-Config Common for a DCI format with CRC scrambled by a RA-RNTI, a MsgB-RNTI, or a TC-RNTI on the primary cell
a Type1A-PDCCH CSS set configured by sdt-SearchSpace in PDCCH-Config Common for a DCI format with CRC scrambled by a C-RNTI or a CS-RNTI on the primary cell as described in clause 19.1
a Type2-PDCCH CSS set configured by pagingSearchSpace in PDCCH-ConfigCommon for a DCI format 1_0 with CRC scrambled by a P-RNTI on the primary cell of the MCG
a Type2A-PDCCH CSS set configured by pei-SearchSpace in pei-ConfigBWP for a DCI format 2_7 with CRC scrambled by a PEI-RNTI on the primary cell of the MCG
a Type3-PDCCH CSS set configured by
   SearchSpace in PDCCH-Config with searchSpaceType=common for DCI formats with CRC scrambled by INT-RNTI, SFI-RNTI, TPC-PUSCH-RNTI, TPC-PUCCH-RNTI, TPC-SRS-RNTI, or CI-RNTI and, only for the primary cell, C-RNTI, MCS-C-RNTI, CS-RNTI(s), or PS-RNTI, or
   SearchSpace in pdcch-ConfigMulticast for DCI formats with CRC scrambled by G-RNTI, or G-CS-RNTI, or
   searchSpaceMCCH and searchSpaceMTCH on a secondary cell for a DCI format 4_0 with CRC scrambled by a MCCH-RNTI or a G-RNTI for broadcast, and
a USS set configured by
   SearchSpace in PDCCH-Config with searchSpaceType=ue-Specific for DCI formats with CRC scrambled by C-RNTI, MCS-C-RNTI, SP-CSI-RNTI, CS-RNTI(s), SL-RNTI, SL-CS-RNTI, or SL Semi-Persistent Scheduling V-RNTI

In the following, DCI formats with CRC scrambled by C-RNTI or CS-RNTI or MCS-C-RNTI are also referred to as unicast DCI formats, DCI formats with CRC scrambled by G-RNTI for multicast or G-CS-RNTI are also referred to as multicast DCI formats, and DCI formats with CRC scrambled by MCCH-RNTI or G-RNTI for broadcast scheduling PDSCH receptions are also referred to as broadcast DCI formats.

For a DL BWP, if a UE is not provided searchSpaceSIB1 for Type0-PDCCH CSS set by PDCCH-Config Common, the UE does not monitor PDCCH candidates for a Type0-PDCCH CSS set on the DL BWP. The Type0-PDCCH CSS set is defined by the CCE aggregation levels and the number of PDCCH candidates per CCE aggregation level given in Table 10.1-1.

If the active DL BWP and the initial DL BWP for a UE have same SCS and same CP length and the active DL BWP includes all RBs of the CORESET with index 0, or the active DL BWP is the initial DL BWP, or the active DL BWP includes all RBs of an MBS frequency resource provided by cfr-ConfigMCCH-MTCH as described in clause 18, the CORESET configured for Type0-PDCCH CSS set has CORESET index 0 and the Type0-PDCCH CSS set has search space set index 0.

If the active DL BWP and an MBS frequency resource provided by cfr-ConfigMCCH-MTCH or determined by CORESET with index 0 when cfr-ConfigMCCH-MTCH is not provided for a UE have same SCS and same CP length and the active DL BWP includes all RBs of the MBS frequency resource, and if the UE is provided searchSpaceMCCH or searchSpaceMTCH for Type0B-PDCCH CSS set on the primary cell or for Type3-PDCCH CSS set on a secondary cell, the UE monitors PDCCH for detection of broadcast DCI formats, as described in clause 18, on the active DL BWP.

For a DL BWP, if a UE is not provided searchSpaceOtherSystemInformation for Type0A-PDCCH CSS set, the UE does not monitor PDCCH for Type0A-PDCCH CSS set on the DL BWP. The CCE aggregation levels and the number of PDCCH candidates per CCE aggregation level for Type0A-PDCCH CSS set are given in Table 10.1-1.

For a DL BWP, if a UE is not provided ra-SearchSpace for Type1-PDCCH CSS set, the UE does not monitor PDCCH for Type1-PDCCH CSS set on the DL BWP. If the UE has not been provided a Type3-PDCCH CSS set, or a Type1A-PDCCH CSS set, or a USS set and the UE has received a C-RNTI and has been provided a Type1-PDCCH CSS set, the UE monitors PDCCH candidates for DCI format 0_0 and DCI format 1_0 with CRC scrambled by the C-RNTI in the Type1-PDCCH CSS set.

If a UE is not provided pagingSearchSpace for Type2-PDCCH CSS set, the UE does not monitor PDCCH for Type2-PDCCH CSS set on the DL BWP. The CCE aggregation levels and the number of PDCCH candidates per CCE aggregation level for Type2-PDCCH CSS set are given in Table 10.1-1.

If a UE is not provided pei-SearchSpace for Type2A-PDCCH CSS set, the UE does not monitor PDCCH for Type2A-PDCCH CSS set on the DL BWP. The CCE aggregation levels and the maximum number of PDCCH candidates per CCE aggregation level for Type2A-PDCCH CSS set are given in Table 10.1-1. If the UE is provided pei-SearchSpace with zero value for the Type2A-PDCCH CSS set index, and for the SS/PBCH block and CORESET multiplexing patterns 2 and 3, the UE determines PDCCH monitoring occasions as described in clause 13 and the CCE aggregation levels and the number of PDCCH candidates per CCE aggregation level for Type2A-PDCCH CSS set are given in Table 10.1-1.

If a UE is provided a zero value for searchSpaceID in PDCCH-ConfigCommon for a Type0/0A/2-PDCCH CSS set, or is provided a zero value for searchSpaceMCCH or searchSpaceMTCH, the UE determines monitoring occasions for PDCCH candidates of the Type0/0A/2-PDCCH CSS set as described in clause 13, and the UE is provided a C-RNTI, the UE monitors PDCCH candidates only at monitoring occasions associated with a SS/PBCH block, where the SS/PBCH block is determined by the most recent of
a MAC CE activation command indicating a TCI state of the active BWP that includes a CORESET with index 0, as described in [6, TS 38.214], where the TCI-state includes a CSI-RS which is quasi-co-located with the SS/PBCH block, or
a random access procedure that is not initiated by a PDCCH order that triggers a contention-free random access procedure

If a UE monitors PDCCH candidates for DCI formats with CRC scrambled by a C-RNTI and the UE is provided a non-zero value for searchSpaceID in PDCCH-ConfigCommon for a Type0/0A/2-PDCCH CSS set, or monitors PDCCH candidates for DCI formats with CRC scrambled by a MCCH-RNTI or a G-RNTI for broadcast and the UE is provided a non-zero value for searchSpaceMCCH and searchSpaceMTCH in PDCCH-ConfigCommon for a Type0/0B-PDCCH CSS set, the UE determines monitoring occasions for PDCCH candidates of the Type0/0A/2-PDCCH CSS set, or of the Type0/0B-PDCCH set, respectively, based on the search space set associated with the value of searchSpaceID.

The UE may assume that the DM-RS antenna port associated with PDCCH receptions in the CORESET configured by pdcch-ConfigSIB1 in MIB, the DM-RS antenna port associated with corresponding PDSCH receptions, and the corresponding SS/PBCH block are quasi co-located with respect to average gain, quasi co-location ‘typeA’ and ‘typeD’ properties, when applicable [6, TS 38.214], if the UE is not provided a T state indicating quasi co-location information of the DM-RS antenna port for PDCCH reception in the CORESET. The value for the DM-RS scrambling sequence initialization is the cell ID. For operation without shared spectrum channel access in FR1 and FR2-1, a SCS is provided by subCarrierSpacing Common in MIB. For operation with shared spectrum channel access in FR1 and for operation in FR2-2, a SCS is same as the SCS of a corresponding SS/PBCH block.

For single cell operation or for operation with carrier aggregation in a same frequency band, a UE does not expect to monitor a PDCCH in a Type0/0A/0B/2/3-PDCCH CSS set or in a USS set if a DM-RS for monitoring a PDCCH in a Type1-PDCCH CSS set is not configured with same qcl-Type set to ‘typeD’ properties [6, TS 38.214] with a DM-RS for monitoring the PDCCH in the Type0/0A/0B/2/3-PDCCH CSS set or in the USS set, and if the PDCCH or an associated PDSCH overlaps in at least one symbol with a PDCCH the UE monitors in a Type1-PDCCH CSS set or with an associated PDSCH.

If a UE is provided
one or more search space sets by corresponding one or more of searchSpaceZero, searchSpaceSIB1, searchSpaceOtherSystemInformation, pagingSearchSpace, ra-SearchSpace, and
a C-RNTI, an MCS-C-RNTI, or a CS-RNTI
   the UE monitors PDCCH candidates for DCI format 0_0 and DCI format 1_0 with CRC scrambled by the C-RNTI, the MCS-C-RNTI, or the CS-RNTI in the one or more search space sets in a slot where the UE monitors PDCCH candidates for at least a DCI format 0_0 or a DCI format 1_0 with CRC scrambled by SI-RNTI, RA-RNTI, MsgB-RNTI, or P-RNTI.

If a UE is provided
one or more search space sets by corresponding one or more of searchSpaceZero, searchSpaceSIB1, searchSpaceOtherSystemInformation, pagingSearchSpace, pei-SearchSpace, ra-SearchSpace, or a CSS set by PDCCH-Config, and
a SI-RNTI, a P-RNTI, a PEI-RNTI, a RA-RNTI, a MsgB-RNTI, a SFI-RNTI, an INT-RNTI, a TPC-PUSCH-RNTI, a TPC-PUCCH-RNTI, or a TPC-SRS-RNTI
   then, for a RNTI from any of these RNTIs, the UE does not expect to process information from more than one DCI format with CRC scrambled with the RNTI per slot.

TABLE 10.1-1: CCE aggregation levels and maximum
number of PDCCH candidates per CCE aggregation
level for CSS sets configured by searchSpaceSIB1

| CCE Aggregation | Number of |
|---|---|
| Level | Candidates |
| 4 | 4 |
| 8 | 2 |
| 16 | 1 |

For each DL BWP configured to a UE in a serving cell, the UE can be provided by higher layer signalling with
P≤3 CORESETs if coresetPoolIndex is not provided, or if a value of coresetPoolIndex is same for all CORESETs if coresetPoolIndex is provided
P≤5 CORESETs if coresetPoolIndex is not provided for a first CORESET, or is provided and has a value 0 for a first CORESET, and is provided and has a value 1 for a second CORESET

For each CORESET, the UE is provided the following by ControlResourceSet:
a CORESET index p, by controlResourceSetId or by controlResourceSetId-v1610, where
   0<p<12 if coresetPoolIndex is not provided, or if a value of coresetPoolIndex is same for all CORESETs if coresetPoolIndex is provided;
   0<p<16 if coresetPoolIndex is not provided for a first CORESET, or is provided and has a value 0 for a first CORESET, and is provided and has a value 1 for a second CORESET;
a DM-RS scrambling sequence initialization value by pdcch-DMRS-ScramblingID;
a precoder granularity for a number of REGs in the frequency domain where the UE can assume use of a same DM-RS precoder by precoderGranularity;
a number of consecutive symbols provided by duration;
a set of resource blocks provided by frequencyDomainResources;
CCE-to-REG mapping parameters provided by cce-REG-MappingType;
an antenna port quasi co-location, from a set of antenna port quasi co-locations provided by TCI-State, indicating quasi co-location information of the DM-RS antenna port for PDCCH reception;
an indication for a presence or absence of a transmission configuration indication (TCI) field for a DCI format, other than DCI format 1_0, that schedules PDSCH receptions or has associated HARQ-ACK information without scheduling PDSCH and is provided by a PDCCH in CORESET p, by tci-PresentInDCI or tci-PresentDCI-1-2.

When precoderGranularity=allContiguousRBs, a UE does not expect
to be configured a set of resource blocks of a CORESET that includes more than four sub-sets of resource blocks that are not contiguous in frequency
any RE of a CORESET to overlap with any RE determined from lte-CRS-ToMatchAround, or from LTE-CRS-PatternList, or with any RE of a SS/PBCH block.

If a UE is provided two TCI states indicating quasi co-location information of the DM-RS antenna port for PDCCH reception in a CORESET associated with a Type3-PDCCH CSS set, the UE may assume the quasi co-location information indicated in both of the two T states for the PDCCH reception in the CORESET.

For each CORESET in a DL BWP of a serving cell, a respectivefrequencyDomainResources provides a bitmap
if a CORESET is not associated with any search space set configured with freqMonitorLocations, the bits of the bitmap have a one-to-one mapping with non-overlapping groups of 6 consecutive PRBs, in ascending order of the PRB index in the DL BWP bandwidth of N_{RB}^{BWP} PRBs with starting common RB position N_{BWP}^{start}, where the first common RB of the first group of 6 PRBs has common RB index 6·┌N_{BWP}^{start}/6┐ if rb-Offset is not provided, or the first common RB of the first group of 6 PRBs has common RB index N_{BWP}^{start}+N_{RB}^{start} where N_{RB}^{offset} is provided by rb-Offset.
if a CORESET is associated with at least one search space set configured with freqMonitorLocations, the first N_{RBG,set0}^{size} bits of the bitmap have a one-to-one mapping with non-overlapping groups of 6 consecutive PRBs, in ascending order of the PRB index in each RB set k in the DL BWP bandwidth of NR_{RB}^{BWP} PRBs with starting common RB position RB_{s0+k,DL}^{start,μ} [6, TS 38.214], where the first common RB of the first group of 6 PRBs has common RB index RB_{s0+k,DL}^{start,μ}+N_{RB}^{offset} and k is indicated by freqMonitorLocations if provided for a search space set; otherwise, k=0. N_{RBG,set0}^{size}=└(N_{RB,set0}^{size}−N_{RB}^{offset})/6┘, N_{RB,set0}^{size} is a number of available PRBs in the RB set 0 for the DL BWP, and N_{RB}^{offset} is provided by rb-Offset or N_{RB}^{ofset}=0 if rb-Offset is not provided. If a UE is provided RB sets in the DL BWP, the UE expects that the RBs of the CORESET are within the union of the PRBs in the RB sets of the DL BWP.

For a CORESET other than a CORESET with index 0,
if a UE has not been provided a configuration of TCI state(s) by tci-StatesPDCCH-ToAddList and tci-StatesPDCCH-ToReleaseList for the CORESET, or has been provided initial configuration of more than one TCI states for the CORESET by tci-StatesPDCCH-ToAddList and tci-StatesPDCCH-ToReleaseList but has not received a MAC CE activation command for one of the TCI states as described in [11, TS 38.321], the UE assumes that the DM-RS antenna port associated with PDCCH receptions is quasi co-located with the SS/PBCH block the UE identified during the initial access procedure, or for a most recent configured grant PUSCH transmission as described in clause 19 for a same HARQ process;
if a UE has been provided a configuration of more than one TCI states by tci-StatesPDCCH-ToAddList and tci-StatesPDCCH-ToReleaseList for the CORESET as part of Reconfiguration with sync procedure as described in [12, TS 38.331] but has not received a MAC CE activation command for one of the TCI states as described in [11, TS 38.321], the UE assumes that the DM-RS antenna port associated with PDCCH receptions is quasi co-located with the SS/PBCH block or the CSI-RS resource the UE identified during the random access procedure initiated by the Reconfiguration with sync procedure as described in [12, TS 38.331].

For a CORESET with index 0,
if the UE is provided TCI-State and if followUnifiedTCI-State=‘enabled’ for the CORESET, the UE assumes that a DM-RS antenna port for PDCCH receptions in the CORESET and a DM-RS antenna port for PDSCH receptions scheduled by DCI formats provided by PDCCH receptions in the CORESET are quasi co-located with the reference signals provided by the indicated TCI-State [6, TS 38.214]
else, the UE assumes that a DM-RS antenna port for PDCCH receptions in the CORESET is quasi co-located with
   the one or more DL RS configured by a TCI state, where the TCI state is indicated by a MAC CE activation command for the CORESET, if any, or
   a SS/PBCH block the UE identified during a most recent random access procedure not initiated by a PDCCH order that triggers a contention-free random access procedure, if no MAC CE activation command indicating a TCI state for the CORESET is received after the most recent random access procedure, or a SS/PBCH block the UE identified during a most recent configured grant PUSCH transmission as described in clause 19.

For a CORESET other than a CORESET with index 0, if a UE is provided a single TCI state for a CORESET, or if the UE receives a MAC CE activation command for one or two of the provided TCI states for a CORESET, the UE assumes that the DM-RS antenna port associated with PDCCH receptions in the CORESET is quasi co-located with the one or more DL RS configured by the TCI states. For a CORESET with index 0, the UE expects that a CSI-RS configured with qcl-Type set to ‘typeD’ in a TCI state indicated by a MAC CE activation command for the CORESET is provided by a SS/PBCH block
if the UE receives a MAC CE activation command for one of the TCI states, the UE applies the activation command in the first slot that is after slot k+3Nₛₗₒₜ^{subframe,μ}+2^{μ}·k_{mac} where k is the slot where the UE would transmit a PUCCH with HARQ-ACK information for the PDSCH providing the activation command, μ is the SCS configuration for the PUCCH in the slot when the activation command is applied, and k_{mac} is a number of slots for SCS configuration μ=0 provided by k_{mac} or k_{mac}=0 if k_{mac} is not provided.

If a UE is provided TCI-State in dl-OrJointTCI-StateList, a DM-RS antenna port for PDCCH receptions in a CORESET, other than a CORESET with index 0, associated only with USS sets and/or Type3-PDCCH CSS sets, and a DM-RS antenna port for PDSCH receptions scheduled by DCI formats provided by PDCCH receptions in the CORESET are quasi co-located with reference signals provided by the indicated TCI-State [6, TS 38.214].

If a UE is provided followUnifiedTCI-State for a CORESET, other than a CORESET with index 0, associated at least with CSS sets other than Type3-PDCCH CSS sets, and if followUnifiedTCI-State is set as enabled, a DM-RS antenna port for PDCCH receptions in the CORESET and a DM-RS antenna port for PDSCH receptions scheduled by DCI formats provided by PDCCH receptions in the CORESET are quasi co-located with reference signals provided by the indicated TCI-State.

If the UE is provided by simultaneousTCI-UpdateList1 or simultaneousTCI-UpdateList2 up to two lists of cells for simultaneous TCI state activation, the UE applies the antenna port quasi co-location provided by one or two TCI-State each with same activated tci-StateID value, to CORESETs with a same index in all configured DL BWPs of all configured cells in a list determined from a serving cell index, where one or two tci-StateID, the CORESET index, and the serving cell index are provided by a MAC CE command.

For each DL BWP configured to a UE in a serving cell, the UE is provided by higher layers with S≤10 search space sets where, for each search space set from the S search space sets, the UE is provided the following by SearchSpace:
a search space set index s, 0<s<40, by searchSpaceId
an association between the search space set s and a CORESET p by controlResourceSetId or by controlResourceSetId-v1610
a PDCCH monitoring periodicity of kₛ slots and a PDCCH monitoring offset of oₛ slots, by monitoringSlotPeriodicityAndOffset or by monitoringSlotPeriodicityAndOffset-r17
a PDCCH monitoring pattern within a slot, indicating first symbol(s) of the CORESET for PDCCH monitoring within each slot where the UE monitors PDCCH, by monitoringSymbolsWithinSlot
a duration of Tₛ<kₛ indicating a number of slots that the search space set s exists by duration, or a number of slots in consecutive groups of slots where the search space set s can exist by duration-r17
a bitmap, by monitoringSlotsWithinSlotGroup, that applies per group of slots and provides a PDCCH monitoring pattern indicating slots in a group of slots for PDCCH monitoring
   a size of the group of slots is same as a size of monitoringSlotsWithinSlotGroup
   for a Type1-PDCCH CSS set provided by ra-SearchSpace in dedicated RRC signaling, or for a Type3-PDCCH CSS set, or for a USS set, the PDCCH monitoring pattern indicates only consecutive slots in the group of slots for PDCCH monitoring and, at least for one combination (Xₛ, Yₛ) indicated by the UE as a capability, a number of the consecutive slots is not larger than Yₛ
   for a Type1-PDCCH CSS set provided by ra-SearchSpace in SIB1, the PDCCH monitoring pattern indicates only up to 1 slot in the group of slots for PDCCH monitoring
   for a Type0-PDCCH CSS set or for a Type0A-PDCCH CSS set, or for a Type2-PDCCH CSS set, the PDCCH monitoring pattern indicates slots in the group of slots for PDCCH monitoring, and the slots are not restricted to be consecutive, and the number of those slots is not larger than the size of monitoringSlotsWithinSlotGroup
a number of PDCCH candidates Mₛ^{(L)} per CCE aggregation level L by aggregationLevel1, aggregationLevel2, aggregationLevel4, aggregationLevel8, and aggregationLevel16, for CCE aggregation level 1, CCE aggregation level 2, CCE aggregation level 4, CCE aggregation level 8, and CCE aggregation level 16, respectively
an indication that search space set s is either a CSS set or a USS set by searchSpaceType
if search space set s is a CSS set
   an indication by dci-Format0-0-AndFormat1-0 to monitor PDCCH candidates for DCI format 0_0 and DCI format 1_0
   an indication by dci-Format2-0 to monitor one or two PDCCH candidates, or to monitor one PDCCH candidate per RB set if the UE is providedfreqMonitorLocations for the search space set, for DCI format 2_0 and a corresponding CCE aggregation level
   an indication by dci-Format2-1 to monitor PDCCH candidates for DCI format 2_1
   an indication by dci-Format2-2 to monitor PDCCH candidates for DCI format 2_2
   an indication by dci-Format2-3 to monitor PDCCH candidates for DCI format 2_3
   an indication by dci-Format2-4 to monitor PDCCH candidates for DCI format 2_4
   an indication by dci-Format2-6 to monitor PDCCH candidates for DCI format 2_6
   an indication by dci-Format4-0 to monitor PDCCH candidates for DCI format 4_0
   an indication by dci-Format4-1, or dci-Format4-2, or dci-Format4-1-AndFormat4-2 to monitor PDCCH candidates for DCI format 4_1, or DCI format 4_2, or for both DCI format 4_1 and DCI format 4_2, respectively
an indication by searchSpaceLinkingId that search space set s is linked to another search space set for which is provided a same value for searchSpaceLinkingId
if search space set s is a USS set, an indication by dci-Formats to monitor PDCCH candidates either for DCI format 0_0 and DCI format 1_0, or for DCI format 0_1 and DCI format 1_1, or an indication by dci-FormatsExt to monitor PDCCH candidates for DCI format 0_2 and DCI format 1_2, or for DCI format 0_1, DCI format 1_1, DCI format 0_2, and DCI format 1_2, or an indication by dci-FormatsSL to monitor PDCCH candidates for DCI format 0_0 and DCI format 1_0, or for DCI format 0_1 and DCI format 1_1, or for DCI format 3_0, or for DCI format 3_1, or for DCI format 3_0 and DCI format 3_1
a bitmap by freqMonitorLocations, if provided, to indicate an index of one or more RB sets for the search space set s, where the MSB k in the bitmap corresponds to RB set k−1 in the DL BWP. For RB set k indicated in the bitmap, the first PRB of the frequency domain monitoring location confined within the RB set is given by RB_{s0+k,DL}^{start,μ}+N_{RB}^{offset}, where RB_{s0+k,DL}^{start,μ} is the index of first common RB of the RB set k [6, TS 38.214], and N_{RB}^{offset} is provided by rb-Offset or N_{RB}^{offset}=0 if rb-Offset is not provided. For each RB set with a corresponding value of 1 in the bitmap, the frequency domain resource allocation pattern for the monitoring location is determined based on the first N_{RBG,set 0}^{size} bits in frequencyDomainResources provided by the associated CORESET configuration.

If the monitoringSymbolsWithinSlot indicates to a UE to monitor PDCCH in a subset of up to three consecutive symbols that are same in every slot where the UE monitors PDCCH for all search space sets, the UE does not expect to be configured with a PDCCH SCS other than 15 kHz if the subset includes at least one symbol after the third symbol.

A UE does not expect to be provided a first symbol and a number of consecutive symbols for a CORESET that results to a PDCCH candidate mapping to symbols of different slots.

A UE does not expect any two PDCCH monitoring occasions on an active DL BWP, for a same search space set or for different search space sets, in a same CORESET to be separated by a non-zero number of symbols that is smaller than the CORESET duration.

A UE determines a PDCCH monitoring occasion on an active DL BWP from the PDCCH monitoring periodicity, the PDCCH monitoring offset, and the PDCCH monitoring pattern within a slot. If monitoringSlotsWithinSlotGroup is not provided, the UE determines that PDCCH monitoring occasions exist in a slot with number n_{s,f}^{μ} [4, TS 38.211] in a frame with number n_{f} if (n_{f} Nₛₗₒₜ^{frame,μ}+n_{s,f}^{μ}−oₛ)mod kₛ=0. The UE monitors PDCCH candidates for search space set s for Tₛ consecutive slots, starting from slot n_{s,f}^{μ}, and does not monitor PDCCH candidates for search space set s for the next kₛ−Tₛ consecutive slots. If monitoringSlotsWithinSlotGroup is provided, for search space set s, the UE determines that the slot with number n_{s,f}^{μ} [4, TS 38.211] in a frame with number n_{f} satisfying (n_{f} Nₛₗₒₜ^{frame,μ}+n_{s,f}^{μ}−oₛ)mod kₛ=0 is the first slot in a first group of Lₛ slots and that PDCCH monitoring occasions exist in Tₛ/Lₛ consecutive groups of slots starting from the first group, where Lₛ is the size of monitoringSlotsWithinSlotGroup. The UE monitors PDCCH candidates for search space set s within each of the Tₛ/Lₛ consecutive groups of slots according to monitoringSlotsWithinSlotGroup, starting from slot n_{s,f}^{μ}, and does not monitor PDCCH candidates for search space set s for the next kₛ-Tₛ consecutive slots.

A USS at CCE aggregation level L∈{1, 2, 4, 8, 16} is defined by a set of PDCCH candidates for CCE aggregation level L.

In [5] 3GPP TS 38.212, V17.5.0 (2023 March), the following is provided:

### 7.3.1.1.1 Format 0_0

DCI format 0_0 is used for the scheduling of PUSCH in one cell.

The following information is transmitted by means of the DCI format 0_0 with CRC scrambled by C-RNTI or CS-RNTI or MCS-C-RNTI:
Identifier for DCI formats—1 bit
   The value of this bit field is always set to 0, indicating an UL DCI format
Frequency domain resource assignment—number of bits determined by the following:
   ┌log₂(N_{RB}^{UL,BWP}(N_{RB}^{BWP}+1)/2)┐ bits if neither of the higher layer parameters useInterlacePUCCH-PUSCH in BWP-UplinkCommon and useInterlacePUCCH-PUSCH in BWP-UplinkDedicated is configured, where N_{RB}^{UL,BWP} is defined in clause 7.3.1.0
      For PUSCH hopping with resource allocation type 1:
         N_{UL_hop} MSB bits are used to indicate the frequency offset according to Clause 6.3 of [6, TS 38.214], where N_{UL_hop}=1 if the higher layer parameter frequencyHoppingOffsetLists contains two offset values and N_{UL_hop}=2 if the higher layer parameter frequencyHoppingOffsetLists contains four offset values
         ┌log₂(N_{RB}^{UL,BWP}(N_{RB}^{UL,BWP}+1)/2)┐−N_{UL_hop} bits provide the frequency domain resource allocation according to Clause 6.1.2.2.2 of [6, TS 38.214]
      For non-PUSCH hopping with resource allocation type 1:
         ┌log₂(N_{RB}^{UL,BWP}(N_{RB}^{UL,BWP}+1)/2)┐ bits provide the frequency domain resource allocation according to Clause 6.1.2.2.2 of [6, TS 38.214]
   If any of the higher layer parameters useInterlacePUCCH-PUSCH in BWP-UplinkCommon and useInterlacePUCCH-PUSCH in BWP-UplinkDedicated is configured
      5+Y bits provide the frequency domain resource allocation according to Clause 6.1.2.2.3 of [6, TS 38.214] if the subcarrier spacing for the active UL bandwidth part is 30 kHz.
      6+Y bits provide the frequency domain resource allocation according to Clause 6.1.2.2.3 of [6, TS 38.214] if the subcarrier spacing for the active UL bandwidth part is 15 kHz.

If the DCI format 0_0 is monitored in a UE-specific search space, the value of Y is determined by

$$⌈ {log}_{2} ( \frac{{N}_{RB - set , UL}^{BWP} ( {N}_{RB - set , UL}^{BWP} + 1 )}{2} ) ⌉$$

where N_{RB-set,UL}^{BWP} is the number of RB sets contained in the active UL BWP as defined in clause 7 of [6, TS38.214]. If the DCI 0_0 is monitored in a common search space Y=0.
Time domain resource assignment—4 bits as defined in Clause 6.1.2.1 of [6, TS 38.214]
Frequency hopping flag—1 bit according to Table 7.3.1.1.1-3, as defined in Clause 6.3 of [6, TS 38.214]
Modulation and coding scheme—5 bits as defined in Clause 6.1.4.1 of [6, TS 38.214]
New data indicator—1 bit
Redundancy version—2 bits as defined in Table 7.3.1.1.1-2
HARQ process number—4 bits
TPC command for scheduled PUSCH—2 bits as defined in Clause 7.1.1 of [5, TS 38.213]
ChannelAccess-CPext—2 bits indicating combinations of channel access type and CP extension as defined in Table 7.3.1.1.1-4, or Table 7.3.1.1.1-4A if channelAccessMode-r16=“semiStatic” is provided, for operation in a cell with shared spectrum channel access in frequency range 1; 2 bits indicating channel access type as defined in Table 7.3.1.1.1-4B if ChannelAccessMode2-r17 is provided for operation in a cell in frequency range 2-2; 0 bit otherwise.
Padding bits, if required.
UL/SUL indicator—1 bit for UEs configured with supplementary Uplink in ServingCellConfig in the cell as defined in Table 7.3.1.1.1-1 and the number of bits for DCI format 1_0 before padding is larger than the number of bits for DCI format 00 before padding; 0 bit otherwise. The UL/SUL indicator, if present, locates in the last bit position of DCI format 0_0, after the padding bit(s).
   If the UL/SUL indicator is present in DCI format 0_0 and the higher layer parameter pusch-Config is not configured on both UL and SUL the UE ignores the UL/SUL indicator field in DCI format 0_0, and the corresponding PUSCH scheduled by the DCI format 0_0 is for the UL or SUL for which high layer parameter pucch-Config is configured;
   If the UL/SUL indicator is not present in DCI format 0_0 and pucch-Config is configured, the corresponding PUSCH scheduled by the DCI format 0_0 is for the UL or SUL for which high layer parameter pucch-Config is configured.
   If the UL/SUL indicator is not present in DCI format 0_0 and pucch-Config is not configured, the corresponding PUSCH scheduled by the DCI format 0_0 is for the uplink on which the latest PRACH is transmitted.

### 7.3.1.2.1 Format 1_0

DCI format 1_0 is used for the scheduling of PDSCH in one DL cell.

The following information is transmitted by means of the DCI format 1_0 with CRC scrambled by C-RNTI or CS-RNTI or MCS-C-RNTI:
Identifier for DCI formats—1 bits
   The value of this bit field is always set to 1, indicating a DL DCI format
Frequency domain resource assignment—┌log₂(N_{RB}^{DL,BWP}(N_{RB}^{DL,BWP}+1)/2)┐ bits where N_{RB}^{DL,BWP} is given by clause 7.3.1.0

If the CRC of the DCI format 1_0 is scrambled by C-RNTI and the “Frequency domain resource assignment” field are of all ones, the DCI format 1_0 is for random access procedure initiated by a PDCCH order, with all remaining fields set as follows:
Random Access Preamble index—6 bits according to ra-PreambleIndex in Clause 5.1.2 of [8, TS38.321]
UL/SUL indicator—1 bit. If the value of the “Random Access Preamble index” is not all zeros and if the UE is configured with supplementary Uplink in ServingCellConfig in the cell, this field indicates which UL carrier in the cell to transmit the PRACH according to Table 7.3.1.1.1-1; otherwise, this field is reserved
SS/PBCH index—6 bits. If the value of the “Random Access Preamble index” is not all zeros, this field indicates the SS/PBCH that shall be used to determine the RACH occasion for the PRACH transmission; otherwise, this field is reserved.
PRACH Mask index—4 bits. If the value of the “Random Access Preamble index” is not all zeros, this field indicates the RACH occasion associated with the SS/PBCH indicated by “SS/PBCH index” for the PRACH transmission, according to Clause 5.1.1 of [8, TS38.321]; otherwise, this field is reserved
Reserved bits—12 bits for operation in a cell with shared spectrum channel access in frequency range 1 or when the DCI format is monitored in common search space for operation in a cell in frequency range 2-2; otherwise 10 bits

Otherwise, all remaining fields are set as follows:
Time domain resource assignment—4 bits as defined in Clause 5.1.2.1 of [6, TS 38.214]
VRB-to-PRB mapping—1 bit according to Table 7.3.1.2.2-5
Modulation and coding scheme—5 bits as defined in Clause 5.1.3 of [6, TS 38.214]
New data indicator—1 bit
Redundancy version—2 bits as defined in Table 7.3.1.1.1-2
HARQ process number—4 bits
Downlink assignment index—2 bits as defined in Clause 9.1.3 of [5, TS 38.213], as counter DAI
TPC command for scheduled PUCCH—2 bits as defined in Clause 7.2.1 of [5, TS 38.213]
PUCCH resource indicator—3 bits as defined in Clause 9.2.3 of [5, TS 38.213]
PDSCH-to-HARQ_feedback timing indicator—3 bits as defined in Clause 9.2.3 of [5, TS38.213]
ChannelAccess-CPext—2 bits indicating combinations of channel access type and CP extension as defined in Table 7.3.1.1.1-4, or Table 7.3.1.1.1-4A if channelAccessMode-r16=“semiStatic” is provided, for operation in a cell with shared spectrum channel access in frequency range 1; 2 bits indicating channel access type as defined in Table 7.3.1.1.1-4B if ChannelAccessMode2-r17 is provided for operation in a cell in frequency range 2-2; 0 bits otherwise
Reserved bits—2 bits when the DCI format is monitored in common search space for operation in a cell in frequency range 2-2 and the number of bits for the field of ‘ChannelAccess-CPext’ is 0; 0 bits otherwise

In legacy New Radio (NR), Physical Random Access Channel (PRACH) could be triggered by Physical Downlink Control Channel (PDCCH) order. Based on a Random Access (RA) procedure field being all zeros or not, Contention Free Random Access (CFRA) (e.g., not all zeros) or Contention Based Random Access (CBRA) (all zeros). Due to a User Equipment (UE) selecting Synchronization Signal (SS)/Physical Broadcast Channel (PBCH) for CBRA triggered by the PDCCH order, a SS/PBCH field and PRACH mask index field are both reserved. However, for CFRA triggered by the PDCCH order, the SS/PBCH field would indicate one SS/PBCH, and a PRACH occasion associated with the one SS/PBCH could be determined. From a dedicated Random Access Channel (RACH) configuration aspect, a plurality of Reference Signals (RSs) could be configured (either SS/PBCH or Channel State Information Reference Signal (CSI-RS)), and each RS could be configured with at least one PRACH occasion (and one preamble index).

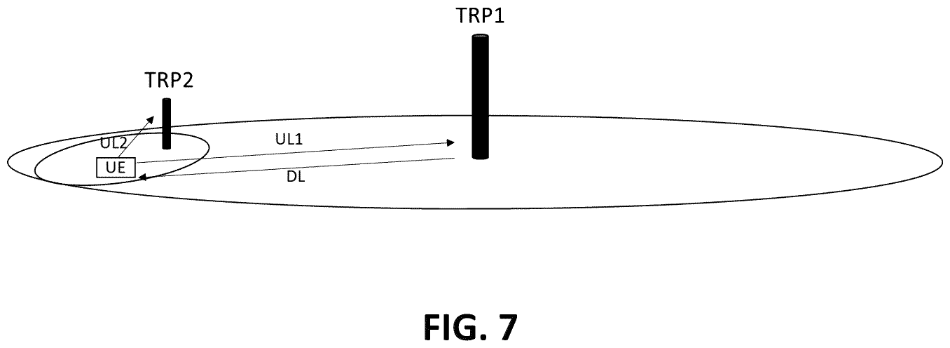

In NR Rel-19, network vendors are proposing deploying Uplink (UL) only Transmission/Reception Point (TRP) for enhancing coverage. Based on this enhanced deployment, downlink (DL) and UL may be associated with different TRPs, and with this deployment, a UE does not need to perform UL transmission using too much transmit power. For example for a UL only TRP, as shown in FIG. 7, both TRP1 and TRP2 are intra-cell TRPs (i.e., TRP1 and TRP2 are in a same serving cell), and the UE may receive DL from TRP1 (e.g., DL) while transmitting UL to TRP2 (e.g., UL2). TRP2 could serve as a UL only TRP. The UL only TRP could be served as a cost reduced device. TRP1 and TRP2 may have a backhaul link for communication. In some cases, the UE may perform an initial access procedure to TRP1 comprising DL and ULL. The initial access procedure may comprise a cell search, a synchronization signal, and a broadcast channel reception, and/or a random access procedure. The UE may perform UL transmission associated with the random access procedure via TRP1. Alternatively, another way is to use TRP2 for performing UL transmission associated with the random access procedure.

Considering DL and UL being associated with different TRPs (in a same serving cell), issues related to UL transmission may need to be addressed. More specifically, Timing Alignment (including downlink reference timing, and/or initial Timing Advance (TA) value acquirement), UL transmit power (including open loop power control, closed loop power control, and/or pathloss RS determination), beam for PRACH to/for a UL only TRP.

In a first example, according to current signaling for a PDCCH order (e.g., Downlink Control Information (DCI) format 1_0), bit fields in the signaling comprises a Random Access Preamble index, a UL/Supplementary Uplink (SUL) indicator, an SS/PBCH index, and a PRACH Mask index. A beam for PRACH according to the PDCCH order is determined based on a SS/PBCH index, however, there is no DL functionality for an UL only TRP (i.e., the UL only TRP does not support DL functionality, including transmitting SS/PBCH).

Besides, two TA scenarios are proposed not only in using multi-DCI (mDCI) multi-TRP (mTRP) but also in using single-DCI (sDCI) mTRP.

### Concept

This concept is to change the beam or associated RS for the PDCCH order (received in a cell) triggered PRACH transmission (in the cell) from “SS/PBCH” to “UL RS”. The UL RS could be a Demodulation Reference Signal (DMRS), a Phase Tracking Reference Signal (PTRS), or a Sounding Reference Signal (SRS). Alternatively, the UL RS should be SRS. Differentiation between this new kind of beam (e.g., SRS) and a legacy kind of beam (e.g., SS/PBCH) for the PDCCH order triggered PRACH transmission may be needed. Whether an RS field in the PDCCH order is determined/interpreted as “SS/PBCH” or “SRS” is based on the PDCCH order is associated with which TRP (e.g., PRACH to be transmitted to which TRP) (of the cell). Detailed differentiation between different TRP's PDCCH order is based on the following.

Explicit signaling differentiation may be based on a specific (new) field in a PDCCH order. When this new specific (new) field is set as a first value, e.g., 0, the PDCCH order corresponds to a TRP providing a DL signal (or beam or associated RS for the PDCCH order is “SS/PBCH”). When this new specific (new) field is set as a second value, e.g., 1, the PDCCH order corresponds to the UL only TRP (or beam or associated RS for the PDCCH order is “UL RS”). A random access preamble index field in the PDCCH order is NOT (allowed to) set to all zeros (e.g., the PDCCH order indicates a CFRA) (e.g., if the new specific (new) field is set as 1). When this new specific (new) field is set as the first value, the UE determines a PRACH resource and/or a beam or associated RS for PRACH via a first dedicated RACH configuration. When this specific (new) field is set as the second value, the UE determines the PRACH resource and/or the beam or associated RS for PRACH via a second dedicated RACH configuration.

The first dedicated RACH configuration corresponds to the PRACH resource associated with SS/PBCH or CSI-RS. The first dedicated RACH configuration is associated with the TRP providing the DL signal. The following text using legacy RRC parameters could be the first dedicated RACH configuration.

| | |
|---|---|
| RACH-ConfigDedicated ::= | SEQUENCE { |

| | |
|---|---|
| cfra | CFRA |

OPTIONAL, -- Need S
...

| | |
|---|---|
| CFRA ::= | SEQUENCE { |

| | |
|---|---|
| occasions | SEQUENCE { |
| rach-ConfigGeneric | RACH-ConfigGeneric, |
| ssb-perRACH-Occasion | ENUMERATED {oneEighth, oneFourth, oneHalf, one, two, four, |

eight, sixteen}
OPTIONAL -- Cond Mandatory
}
OPTIONAL, -- Need S

| | |
|---|---|
| resources | CHOICE { |
| ssb | SEQUENCE { |
| ssb-ResourceList | SEQUENCE (SIZE(1..maxRA-SSB-Resources)) OF CFRA-SSB- |

Resource,

| | |
|---|---|
| ra-ssb-OccasionMaskIndex | INTEGER (0..15) |

},

| | |
|---|---|
| csirs | SEQUENCE { |
| csirs-ResourceList | SEQUENCE (SIZE(1..maxRA-CSIRS-Resources)) OF CFRA-CSIRS- |

Resource,

| | |
|---|---|
| rsrp-ThresholdCSI-RS | RSRP-Range |

}
}
...

| | |
|---|---|
| CFRA-SSB-Resource ::= | SEQUENCE { |

| | |
|---|---|
| ssb | SSB-Index, |
| ra-PreambleIndex | INTEGER (0..63), |

```
  ...,
  [[
```

| | |
|---|---|
| msgA-PUSCH-Resource-Index-r16 | INTEGER (0..3071) OPTIONAL -- Cond 2StepCFRA |

]]
}

| | |
|---|---|
| CFRA-CSIRS-Resource ::= | SEQUENCE { |

| | |
|---|---|
| csi-RS | CSI-RS-Index, |
| ra-OccasionList | SEQUENCE (SIZE(1..maxRA-OccasionsPerCSIRS)) OF INTEGER (0..maxRA- |

Occasions-1),

| | |
|---|---|
| ra-PreambleIndex | INTEGER (0..63), |

...
}

The second dedicated RACH configuration corresponds to a PRACH resource associated with SRS or UL RS. The second dedicated RACH configuration is associated with a UL only TRP. The second dedicated RACH configuration could contain associated one or more SRSs or UL RSs. The second dedicated RACH configuration could contain PRACH occasion(s) associated with an SRS or UL RS indicated in the second dedicated RACH configuration. The second dedicated RACH configuration could contain PRACH preamble index(s) associated with an SRS or UL RS indicated in the second dedicated RACH configuration. The following text using legacy Radio Resource Control (RRC) parameters could be the second dedicated RACH configuration (added text bolded and underlined).

| | |
|---|---|
| RACH-ConfigDedicated :: = | SEQUENCE { |
| cfra | CFRA |

OPTIONAL, -- Need S
...

| | |
|---|---|
| CFRA ::= | SEQUENCE { |
| occasions | SEQUENCE { |
| rach-ConfigGeneric | RACH-ConfigGeneric, |
| ssb-perRACH-Occasion | ENUMERATED {oneEighth, oneFourth, oneHalf, one, two, four, |

eight, sixteen}
OPTIONAL -- Cond Mandatory
}
OPTIONAL, -- Need S

| | |
|---|---|
| resources | { |

```
    SRS SEQUENCE {
      SRS-ResourceList SEQUENCE (SIZE(1..maxRA-SRS-Resources)) OF CFRA-SRS-
Resource
    }
}
CFRA-SRS-Resource ::= SEQUENCE {
  SRS-Resource SRS-ResourceId,
  ra-OccasionList SEQUENCE (SIZE(1..maxRA-OccasionsPerSRS)) OF INTEGER (0..maxRA-
Occasions-1),
  ra-PreambleIndex INTEGER (0..63),
  ...
}
```

Based on the specific (new) field, the UE determines to transmit PRACH based on either the first dedicated RACH configuration or the second RACH configuration.

The specific (new) field may be set/put being earlier than an “RS field” in the PDCCH order. The “RS field corresponds to either an “SS/PBCH field” or an “SRS field”. The new specific (new) field may be set/put being earlier than a “Random Access Preamble index” field. Alternatively, the specific (new) field may be set/put being later than a “Random Access Preamble index” field (but being earlier than an “RS field”). When this specific (new) field is set as the first value, the “RS field” is interpreted/determined as an “SS/PBCH” index, and/or the RS field is interpreted/determined as an SS/PBCH field. When this specific (new) field is set as the second value, the “RS field” is interpreted/determined as an “SRS resource” index, and/or the RS field is interpreted/determined as an SRS field. The SRS field indicates an SRS resource index among an SRS resource set. The SRS resource set could be configured or dynamically indicated. Preferably in certain embodiments, the SRS field indicates one SRS resource among a plurality of SRS resources. Alternatively, when this specific (new) field is set as the first value, the “RS field” is interpreted/determined as an “SS/PBCH” index, and/or the RS field is interpreted/determined as an SS/PBCH field. When this specific (new) field is set as the second value, the “RS field” is interpreted/determined as an “SRS resource set” index and “SRS resource” index, and/or the RS field is interpreted/determined as an SRS field. This alternative provides additional flexibility for a network node to indicate both the SRS resource set and the SRS resource (within the indicated SRS resource set).

Preferably in certain embodiments, size of the specific (new) field is one bit and/or a bit field.

Preferably in certain embodiments, whether (DCI format for) the PDCCH order includes the specific (new) field could be based on an RRC configuration and/or be configured by a network node.

Alternatively, explicit signaling differentiation may be based on (whether there is) a second specific (new) field (in the PDCCH order) directly indicating SRS resource. The size of the second specific (new) field may be based on a number of SRS resources in a plurality of SRS resources (e.g., especially in a RACH dedicated configuration). Preferably in certain embodiments, size of the second specific (new) field may be further based on one reserved code-point for differentiation. In this way, a dedicated RACH configuration using SRS may not comprise parameter(s) for configuring a PRACH occasion (e.g., without ra-OccasionList). The SS/PBCH field in a PDCCH order would indicate a PRACH occasion associated with such SS/PBCH. A UE transmits PRACH on the PRACH occasion using a spatial filter based on the SRS according to the second specific (new) field. Preferably in certain embodiments, size of the second specific (new) field is more than one bit. As the second specific (new) field is using reserved bits set to zeros, the code-point of the second specific (new) field as all zeros corresponds to the PDCCH order for TRP providing DL signaling (e.g., or corresponds to TRP with RS for the PDCCH order is “SS/PBCH”). On the other hand, code-point of the second specific (new) field as NOT all zeros corresponds to PDCCH for the UL only TRP (e.g., or corresponds to TRP with RS for the PDCCH order is “UL RS”). Preferably in certain embodiments, code-point 1 of the second specific (new) field corresponds to SRS resource Identity (ID)=0 or the lowest SRS resource or lowest entry in an SRS resource set.

Implicit signaling differentiation may be based on a specific Control Resource Set (CORESET)/search space carrying/delivering the PDCCH order. More specifically, the PDCCH order carried/delivered by the specific CORESET/search space corresponds to the PDCCH order for the UL only TRP. The PDCCH order carried/delivered NOT by the specific CORESET/search space corresponds to the PDCCH order for the TRP providing the DL signal. Preferably in certain embodiments, the specific CORESET/search space is configured by a network node. Based on which CORESET/search space carrying/delivering the PDCCH order, the UE could determine the SS/PBCH field (or RS field) in the PDCCH order is determined/interpreted as an SS/PBCH field, or an SRS resource field. Based on which CORESET/search space carrying/delivering the PDCCH order, the UE could determine the SS/PBCH field (or RS field) is determined/interpreted as the SS/PBCH field, or the SRS resource set and the SRS resource field. Based on which CORESET/search space carrying/delivering the PDCCH order, the UE could determine the PDCCH order is associated with which TRP. More specifically, based on which CORESET/search space carrying/delivering the PDCCH order, the UE could determine the PRACH transmission is based on which beam or being associated with SS/PBCH or SRS. Preferably in certain embodiments, the specific CORESET/search space is associated with a specific SRS resource set. Preferably in certain embodiments, the SRS resource indicated by the SRS field in the PDCCH order is among the specific SRS resource set. Preferably in certain embodiments, the specific CORESET/search space is not a Beam Failure Recovery (BFR) CORESET or a BFR Search Space (SS). Preferably in certain embodiments, the UE could monitor the specific CORESET/search space (even) when beam failure does not happen. Preferably in certain embodiments, the specific CORESET/search space could comprise the PDCCH scheduling the UL transmission in addition to the PDCCH scheduling the PDCCH order. Preferably in certain embodiments, the UE does not expect that the specific CORESET/search space is NOT following a unified Transmission Configuration Indicator (TCI) state. The UE monitors the specific CORESET/search space based on a TCI state activated in a TCI state (de)activation Medium Access Control (MAC) Control Element (CE) for the specific CORESET/search space (which does not follow the beam indication DCI or the beam indication MAC CE). Preferably in certain embodiments, the beam indication or beam indication MAC CE is used for UE-specific DL channel/signal reception and/or UE-specific channel/signal transmission. Preferably in certain embodiments, the beam indication MAC CE and the MAC CE for the specific CORESET/search space corresponds to a different MAC CE. Alternatively, the specific CORESET is configured with following a 2-nd TCI state. Alternatively, the specific CORESET is configured with following both a 1-st and a 2-nd TCI state (e.g., PDCCH in Single Frequency Network (SFN)). Preferably in certain embodiments, PDCCH in SFN in the scenario of FIG. 7 may correspond to a CORESET with such configuration but the UE actually receives PDCCH in TRP1.

Alternatively, implicit signaling differentiation may be based on a specific CORESET/search space carrying/delivering the PDCCH order, and the specific CORESET/search space is used for delivering the PDCCH order for the TRP providing the DL signal. The PDCCH order carried/delivered by the specific CORESET/search space corresponds to the TRP providing the DL signal. The PDCCH order carried/delivered by the CORESET/search space other than the specific CORESET/search space corresponds to the UL only TRP.

Implicit signaling differentiation may be based on that a CORESET delivering/comprising/providing the PDCCH order is configured with following a 1-st TCI state or not. Preferably in certain embodiments, a PDCCH order received in CORESET following a 1-st TCI state corresponds to the PDCCH order associated with the TRP providing the DL signal (e.g., trigger PRACH to TRP1 in FIG. 7). Preferably in certain embodiments, a PDCCH order received in CORESET NOT following a 1-st TCI state (e.g., following both, not following, following 2-nd) corresponds to the PDCCH order associated with the UL only TRP (e.g., trigger PRACH to TRP2 in FIG. 7). Preferably in certain embodiments, when a first CORESET is configured with following a 1-st TCI state, the UE will apply the 1-st TCI state in a code-point of a beam indication MAC CE (e.g., (e-)unified TCI state (de)activation MAC CE) to monitor the first CORESET. Preferably in certain embodiments, when there is more than one code-point in the beam indication MAC CE, the code-point of the beam indication MAC CE is indicated by a beam indication DCI (which indicates a different code-point than the previous beam indication DCI). Preferably in certain embodiments, when there is only one code-point in the beam indication MAC CE, the code-point of the beam indication MAC CE is the only one code-point. Preferably in certain embodiments, a second CORESET is configured with following a 2-nd TCI state. The UE monitors the second CORESET via the 2-nd TCI state. In this UL only TRP scenario, the UE expects the 1-st TCI state and the 2-nd TCI state (as a code-point of beam indication MAC CE) to correspond to a same TCI state (e.g., TCI state ID). When the UE receives a beam indication MAC CE comprising at least one code-point with a 1-st TCI state and a 2-nd TCI state corresponding to a same TCI state ID, the UE determines as a multiple TRP operation considering a UL only TRP scenario. Preferably in certain embodiments, DL functionality of the UL only TRP is muted and/or the UE does not expect to receive a DL signal from the UL only TRP.

Implicit signaling differentiation may be based on a time pattern or an even/odd slot. More specifically, the PDCCH order received in the odd slot corresponds to the PDCCH order for the UL only TRP. The PDCCH order received in the even slot corresponds to the PDCCH order for the TRP providing DL signal. Alternatively, the PDCCH order received in the odd slot corresponds to the TRP providing the DL signal while the PDCCH order received in the even slot corresponds to the PDCCH order for the UL only TRP. Preferably in certain embodiments, the slot could be replaced by Transmit Time Interval (TTI).

Implicit signaling differentiation may be based on whether the UL only TRP is being added or not or operation in mode with communication with the UL only TRP. When the UE determines or is being signaled as using the UL only TRP or performs the UL transmission to the UL only TRP (and receiving the DL in another TRP), the PDCCH order is determined as being associated with the UL only TRP. When the UE determines NOT using the UL only TRP or NOT being signaled as using the UL only TRP or performs the UL transmission to the TRP which is the same as the receiving DL, the PDCCH order is determined as being associated with the TRP providing the DL signal. Before the UE is added or operating in mode with communication with the UL only TRP, the UE determines the PDCCH order is associated with the TRP for providing the DL signal.

Implicit signaling differentiation may be based on a DCI format for the PDCCH order associated with the UL only TRP or the PDCCH order associated with the TRP providing the DL signal. For a first search space being configured with monitoring DCI format associated with the UL only TRP, the PDCCH order monitored in the first search space is associated with the UL only TRP and/or the PRACH transmission in response to the PDCCH order is associated with the UL only TRP. For a second search space being configured with monitoring the DCI format associated with the TRP providing the DL signal, the PDCCH order monitored in the second search space is associated with the TRP providing the DL signal and/or the PRACH transmission in response to the PDCCH order is associated with the TRP providing the DL signal. The DCI format for scheduling the PRACH transmission associated with the TRP providing the DL signal may be DCI format 1_0. DCI format for scheduling the PRACH transmission associated with the UL only TRP may not be DCI format 1_0. DCI format for scheduling the PRACH transmission associated with the UL only TRP may be DCI format 1_x, or DCI format 0_x, or DCI format 0_0. For example, there is one condition check for DCI format 0_0 indicating that the PDCCH order frequency domain resource assignment field in DCI format 0_0 are all ones.

The following is example text (bolded and underlined):

If the CRC of the DCI format 0_0 is scrambled by C-RNTI and the “Frequency domain resource assignment” field are of all ones, the DCI format 0_0 is for random access procedure initiated by a PDCCH order, with all remaining fields set as follows:
Random Access Preamble index—6 bits according to ra-PreambleIndex in Clause 5.1.2 of [8, TS38.3211].
UL/SUL indicator—1 bit. If the value of the “Random Access Preamble index” is not all zeros and if the UE is configured with supplementaryUplink in ServinkCellConfig in the cell, this field indicates which UL carrier in the cell to transmit the PRACH according to Table 7.3.1.1.1-1; otherwise, this field is reserved.
SRS index—6 bits. If the value of the “Random Access Preamble index” is not all zeros, this field indicates the SRS or SS/PBCH associated with the SRS that shall be used to determine the RACH occasion for the PRACH transmission; otherwise, this field is reserved.
PRACH Mask index—4 bits. If the value of the “Random Access Preamble index” is not all zeros, this field indicates the RACH occasion associated with the SRS indicated by “SRS index” for the PRACH transmission, according to Clause 5.1.1 of [8, TS38.321]; otherwise, this field is reserved.
Reserved bits—12 bits for operation in a cell with shared spectrum channel access in frequency range 1 or when the DCI format is monitored in common search space for operation in a cell in frequency range 2-2; otherwise 10 bits.

Implicit signaling differentiation may be based on applying the “TCI state” (field) to replace the “SS/PBCH index” field (in a PDCCH order). Preferably in certain embodiments, this method may need to build an association between the TCI state and the dedicated RACH configuration (rather than SS/PBCH index and dedicated RACH configuration). Preferably in certain embodiments, based on the source RS of the TCI state indicated by the TCI state field in the PDCCH order, the UE could determine a dedicated PRACH configuration or PRACH occasion. For example, when the source RS of the TCI state indicated by the TCI field in the PDCCH order corresponds to SS/PBCH index x, the UE determines the PRACH occasion associated with the dedicated PRACH configuration which provides the PRACH occasion associated with SS/PBCH index x. For another example, when the source RS of the TCI state indicated by the TCI field in the PDCCH order corresponds to SRS index y, the UE determines the PRACH occasion associated with the dedicated PRACH configuration which provides the PRACH occasion associated with SRS index y. Alternatively, when the source RS of the TCI state indicated by the TCI field in the PDCCH order corresponds to SRS index y, the UE determines the PRACH occasion associated with the dedicated PRACH configuration which provides the PRACH occasion associated with an SS/PBCH being associated with SRS index y. Based on the TCI state indicated by the TCI field in the PDCCH order, the UE could determine the RACH occasion (which may further based on configuration that the TCI state being associated with the dedicated RACH configuration). Based on the source RS associated with the TCI state indicated by the TCI state field in the PDCCH order, the UE could determine whether the beam or spatial filter for the PRACH transmission is associated with SRS or SS/PBCH (or CSI-RS). When the source RS associated with the TCI state indicated by the TCI state field in the PDCCH order corresponds to an SRS and preferably the SRS is associated with the UL only TRP (e.g., using the 2-nd TCI state), the UE determines the PDCCH order is associated with the UL only TRP, and/or the UE determines the PRACH transmission in response to the PDCCH order is associated with the (indicated) TCI state. Based on indication of the PDCCH order, the UE performs the PRACH transmission via a spatial filter being associated with an SS/PBCH, SRS, CSI-RS, and/or TCI state.

The PDCCH order with the “TCI state” (field) could trigger the PRACH transmission(s) to the UL only TRP. The PDCCH order with the “TCI state” (field) could also trigger the PRACH transmission(s) to the TRP providing the DL signal. Alternatively, the PDCCH order with the “TCI state” (field) may not be (allowed to be) used to trigger the PRACH transmission(s) to the TRP providing the DL signal.

The following is one example of an association between a TCI state and a dedicated RACH configuration. Preferably in certain embodiments, the TCI state corresponds to the TCI-state or the TCI-UL-State (bolded and underlined).

ReferenceSignal(-r17) in qcl-info or in TCI-UL-State(-r17) corresponds to an SS/PBCH index, CSI-RS index, or SRS index.

| | |
|---|---|
| RACH-ConfigDedicated ::= | SEQUENCE { |

| | |
|---|---|
| cfra | CFRA |

OPTIONAL, -- Need S
...

| | |
|---|---|
| CFRA ::= | SEQUENCE { |

| | |
|---|---|
| occasions | SEQUENCE { |
| rach-ConfigGeneric | RACH-ConfigGeneric, |
| ssb-perRACH-Occasion | ENUMERATED {oneEighth, oneFourth, oneHalf, one, two, four, |

eight, sixteen}
OPTIONAL -- Cond Mandatory
}
OPTIONAL, -- Need S

| | |
|---|---|
| resources | CHOICE { |
| ssb | SEQUENCE { |
| ssb-ResourceList | SEQUENCE (SIZE(1..maxRA-SSB-Resources)) OF CFRA-SSB- |

Resource,

| | |
|---|---|
| ra-ssb-OccasionMaskIndex | INTEGER (0..15) |

},

| | |
|---|---|
| csirs | SEQUENCE { |
| csirs-ResourceList | SEQUENCE (SIZE(1..maxRA-CSIRS-Resources)) OF CFRA-CSIRS- |

Resource,

| | |
|---|---|
| rsrp-ThresholdCSI-RS | RSRP-Range |

}
}
...

| | |
|---|---|
| CFRA-r18 ::= | SEQUENCE { |

| | |
|---|---|
| occasions | SEQUENCE { |
| rach-ConfigGeneric | RACH-ConfigGeneric, |
| ssb-perRACH-Occasion | ENUMERATED {oneEighth, oneFourth, oneHalf, one, two, four, |

eight, sixteen}
OPTIONAL -- Cond Mandatory
}
OPTIONAL, -- Need S

| | |
|---|---|
| resources | { |

```
    One or more TCI states SEQUENCE (SIZE(1..maxRA-TCI-states)) OF CFRA-TCI-states
}
CFRA-TCI-states ::= SEQUENCE {
  CFRA-TCI-states TCI-StateId,
  ra-OccasionList SEQUENCE (SIZE(1..maxRA-OccasionsPerTCI)) OF INTEGER (0..maxRA-
Occasions-1),
  ra-PreambleIndex INTEGER (0..63),
  ...
}
```

Preferably in certain embodiments, the UE determines using the UL only TRP based on a signaling. Preferably in certain embodiments, the signaling could be DCI, MAC CE, or RRC. Preferably in certain embodiments, the signaling could indicate or imply performing UL transmission in the UL only TRP. Preferably in certain embodiments, in response to the signaling, the UE could determine that the UL transmission is to the UL only TRP. More specifically, the signaling could be a beam indication MAC CE and/or a beam indication DCI. A beam indication MAC CE may comprise at least one code-point with a 1-st TCI state and a 2-nd TCI state corresponding to the same TCI state. Preferably in certain embodiments, the 1-st/2-nd TCI state corresponds to a DL TCI state. Alternatively, a detailed further extended beam indication MAC CE design could indicate a 1-st joint TCI state with disabled UL and/or a 2-nd TCI state with disabled DL. In one example, there are two octets in the MAC CE, wherein each bit in the first octet corresponds to the 1-st TRP while each bit in the second octet corresponds to the 2-nd TRP. Preferably in certain embodiments, each bit in the first octet of the two octets indicates one code-point of the TCI field in DCI corresponds to multiple or a single TCI state for the 1-st TRP. Preferably in certain embodiments, each bit in the second octet of the two octets indicates one code-point of the TCI field in DCI corresponds to multiple or a single TCI state for the 2-nd TRP. For one bit in the first octet of the two octets indicating the single TCI state for one code-point of the TCI field in DCI, the code-point indicates a single TCI state for the 1-st TRP. Even for joint TCI states, when one bit in the first octet of the two octets indicates a single TCI state, whether DL/UL of the joint TCI state is used based on the DL/UL field in the same octet of the joint TCI state. When the DL/UL field in the same octet of the joint TCI state corresponds to DL, there is no UL functionality or UL of the joint TCI state is disabled or not activated. When the DL/UL field in the same octet of the joint TCI state corresponds to UL, there is no DL functionality or DL of the joint TCI state is disabled or not activated. Similar functionality is reused from each bit in the first octet of the two octets to each bit in the second octet of the two octets.

Preferably in certain embodiments, a dedicated RACH configuration could be extended. One example could be illustrated below (bolded and underlined wording corresponds to the extended part). Preferably in certain embodiments, the UE may be configured with one or more dedicated RACH configurations. Preferably in certain embodiments, the PDCCH order trigger PRACH could correspond to either CFRA associated with SS/PBCH or SRS. Preferably in certain embodiments, differentiation between the PDCCH order is associated with which dedicated PRACH configuration may be determined based on the above differentiation method.

| | |
|---|---|
| RACH-ConfigDedicated ::= | SEQUENCE { |

| | |
|---|---|
| cfra | CFRA |

OPTIONAL, -- Need S
...

| | |
|---|---|
| CFRA ::= | SEQUENCE { |

| | |
|---|---|
| occasions | SEQUENCE { |
| rach-ConfigGeneric | RACH-ConfigGeneric, |
| ssb-perRACH-Occasion | ENUMERATED {oneEighth, oneFourth, oneHalf, one, two, four, |

eight, sixteen}
OPTIONAL -- Cond Mandatory
}
OPTIONAL, -- Need S

| | |
|---|---|
| resources | CHOICE { |
| ssb | SEQUENCE { |
| ssb-ResourceList | SEQUENCE (SIZE(1..maxRA-SSB-Resources)) OF CFRA-SSB- |

Resource,

| | |
|---|---|
| ra-ssb-OccasionMaskIndex | INTEGER (0..15) |

},

| | |
|---|---|
| csirs | SEQUENCE { |
| csirs-ResourceList | SEQUENCE (SIZE(1..maxRA-CSIRS-Resources)) OF CFRA-CSIRS- |

Resource,

| | |
|---|---|
| rsrp-ThresholdCSI-RS | RSRP-Range |

}
}
...

| | |
|---|---|
| CFRA-r18 ::= | SEQUENCE { |

| | |
|---|---|
| occasions | SEQUENCE { |
| rach-ConfigGeneric | RACH-ConfigGeneric, |
| ssb-perRACH-Occasion | ENUMERATED {oneEighth, oneFourth, oneHalf, one, two, four, |

eight, sixteen}
OPTIONAL -- Cond Mandatory
}
OPTIONAL, -- Need S

| | |
|---|---|
| resources | CHOICE { |
| ssb | SEQUENCE { |
| ssb-ResourceList | SEQUENCE (SIZE(1..maxRA-SSB-Resources)) OF CFRA-SSB- |

Resource,

| | |
|---|---|
| ra-ssb-OccasionMaskIndex | INTEGER (0..15) |

},

| | |
|---|---|
| csirs | SEQUENCE { |
| csirs-ResourceList | SEQUENCE (SIZE(1..maxRA-CSIRS-Resources)) OF CFRA-CSIRS- |

Resource,

| | |
|---|---|
| rsrp-ThresholdCSI-RS | RSRP-Range |

```
    }
SRS SEQUENCE {
      SRS-ResourceList SEQUENCE (SIZE(1..maxRA-SRS-Resources)) OF CFRA-SRS-
Resource
}
...
```

| | |
|---|---|
| CFRA-SSB-Resource ::= | SEQUENCE { |

| | |
|---|---|
| ssb | SSB-Index, |
| ra-PreambleIndex | INTEGER (0..63), |

```
  ...,
  [[
```

| | |
|---|---|
| msgA-PUSCH-Resource-Index-r16 | INTEGER (0..3071) OPTIONAL -- Cond 2StepCFRA |

]]
}

| | |
|---|---|
| CFRA-CSIRS-Resource ::= | SEQUENCE { |

| | |
|---|---|
| csi-RS | CSI-RS-Index, |
| ra-OccasionList | SEQUENCE (SIZE(1..maxRA-OccasionsPerCSIRS)) OF INTEGER (0..maxRA- |

Occasions-1),

| | |
|---|---|
| ra-PreambleIndex | INTEGER (0..63), |

```
  ...
}
CFRA-SRS-Resource ::= SEQUENCE {
  SRS-Resource SRS-ResourceId,
  ra-OccasionList SEQUENCE (SIZE(1..maxRA-OccasionsPerSRS)) OF INTEGER (0..maxRA-
Occasions-1),
  ra-PreambleIndex INTEGER (0..63),
  ...
}
```

Alternatively, taking FIG. 7 as an example, when a UE is in an RRC connected state with TRP1, the UE may receive reconfiguration or signaling for information associated with TRP2. The reconfiguration or signaling for information may provide that a first one or more RACH occasion(s) is associated with SS/PBCH without being associated with SRS and a second one or more RACH occasion(s) is associated with SS/PBCH with being associated with SRS. The reconfiguration or signaling for information may provide association between SS/PBCH and SRS. With this method, when the UE receives a PDCCH order (with a random access preamble being NOT all zeros), the UE could determine whether the PDCCH order is associated with TRP1 or TRP2 based on whether SS/PBCH indicated by an SS/PBCH index field is associated with SRS or not (or based on whether a PRACH occasion is associated with (SS/PBCH that is associated with) SRS or not). When the SS/PBCH index field indicates a first SS/PBCH without being associated with SRS, the UE determines the PDCCH order is associated with TRP1 (e.g., TRP providing DL signal). When the SS/PBCH index field indicates a second SS/PBCH with being associated with SRS, the UE determines the PDCCH order is associated with TRP2 (e.g., UL only TRP). Preferably in certain embodiments, differentiation for the PDCCH order being associated with which TRP could be based on SS/PBCH separation. Preferably in certain embodiments, SS/PBCH separation could be based on an RRC, MAC CE, and/or DCI signal. Preferably in certain embodiments, above is one separation method, an alternative separation could be based on indicating SS/PBCH is associated with TRP1/TRP2. Alternatively, a separation method could be based on SS/PBCH being associated with the 1-st or 2-nd TCI state in a code-point in a beam indication MAC CE or in a beam indication DCI. Preferably in certain embodiments, the 1-st TCI state could be associated with or imply TRP1 (e.g., TRP providing DL signal). Preferably in certain embodiments, the 2-nd TCI state could be associated with or imply TRP2 (e.g., UL only TRP).

Preferably in certain embodiments, throughout the present invention, the PDCCH order (received in a cell) here indicates CFRA to either the TRP providing the DL signal or the UL only TRP (of the cell).

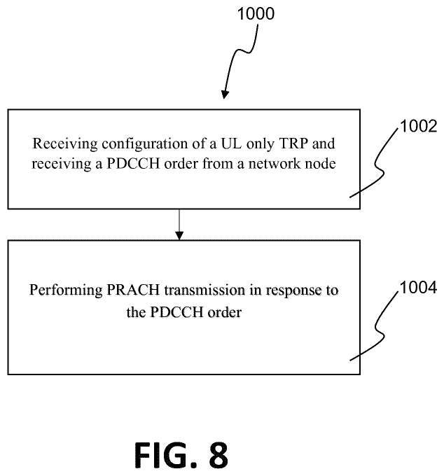

Referring to FIG. 8, with this and other concepts, systems, and methods of the present invention, a method 1000 for a UE in a wireless communication system comprises receiving configuration of a UL only TRP and receiving a PDCCH order from a network node (step 1002), and performing PRACH transmission in response to the PDCCH order (step 1004).

Preferably in certain embodiments, the PDCCH order and the PRACH transmission are on a same serving cell.

Preferably in certain embodiments, based on which serving cell the UE received the PDCCH order, the UE determines the PRACH transmission is in response to which serving cell.

Preferably in certain embodiments, the serving cell corresponds to a Primary Cell (PCell) or a Secondary Cell (SCell).

Preferably in certain embodiments, the UE determines whether the PRACH transmission is associated with an SRS or a SS/PBCH based on a specific field in the PDCCH order.

Preferably in certain embodiments, the UE determines the PRACH transmission via a spatial filter associated with SRS or SS/PBCH based on the specific field.

Preferably in certain embodiments, the UE determines the PRACH occasion associated with SRS or SS/PBCH based on the specific field.

Preferably in certain embodiments, the specific field is enabled or exists or is a valid bit field in the PDCCH order when the UE receives a parameter or signaling or a (re)configuration associated with the specific field.

Preferably in certain embodiments, the specific field is NOT enabled or does not exist or NOT being a valid bit field in the PDCCH order before the UE receives the parameter or signaling or the (re)configuration associated with the specific field or when the UE does not receive the parameter or signaling or the (re)configuration associated with the specific field.

Preferably in certain embodiments, the parameter or signaling or the (re)configuration associated with the specific field corresponds to a UL only TRP.

Preferably in certain embodiments, the parameter or signaling or the (re)configuration associated with the specific field corresponds to an additional SRS power control process, and/or when the UE is configured with two SRS power control processes (for at least one serving cell), the specific field is enabled or exists or is a valid bit field.

Preferably in certain embodiments, the UE is configured with two SRS resource sets associated with a same purpose (e.g., non-codebook or codebook), or when at least the UE is configured with two SRS resource sets associated with the same purpose (e.g., non-codebook or codebook), the specific field is enabled or exists or is a valid bit field.

Preferably in certain embodiments, the specific field indicates information of a (type-D) Quasi Co-Location (QCL) source RS or information of a source RS or information of a spatial filter for PRACH transmission.

Preferably in certain embodiments, based on the specific field, the UE determines the source RS or the spatial filter for the PRACH transmission is QCL to an SRS or an SS/PBCH.

Preferably in certain embodiments, size of the specific field is one.

Preferably in certain embodiments, when the specific field indicates a first value (e.g., 0), the PDCCH order is associated with an SS/PBCH.

Preferably in certain embodiments, when the specific field indicates a second value (e.g., 1), the PDCCH order is associated with an SRS.

Preferably in certain embodiments, the PRACH transmission corresponds to a contention free PRACH transmission, and/or a random access preamble index field in the PDCCH order indicates NOT all zeros.

Preferably in certain embodiments, when the random access preamble index field in the PDCCH order indicates NOT all zeros (e.g., CFRA PRACH), the specific field indicates information of the (type-D) quasi co-location source RS or information of the source RS or information of the spatial filter for PRACH transmission.

Preferably in certain embodiments, when the random access preamble index field in the PDCCH order indicates all zeros (e.g., CBRA PRACH), the specific field is reserved.

Preferably in certain embodiments, the specific field is put or set in an earlier bit field than an RS field (e.g., SS/PBCH index field or SRS index field).

Preferably in certain embodiments, based on indication of the specific field, the UE determines an RS field in the PDCCH order corresponds to an SS/PBCH index field or an SRS index field.

Preferably in certain embodiments, the specific field is put later than the random access preamble index field.

Preferably in certain embodiments, the RS field is used for determining a PRACH occasion for PRACH transmission.

Preferably in certain embodiments, the UE received one or more dedicated PRACH configurations.

Preferably in certain embodiments, based on a dedicated PRACH configuration, the UE determines or identifies association between the PRACH occasion and one RS.

Preferably in certain embodiments, based on an RS indicated by the RS field in the PDCCCH order, the UE determines or identifies the PRACH occasion for PRACH transmission.

Preferably in certain embodiments, an RS corresponds to SS/PBCH, CSI-RS, or SRS.

Preferably in certain embodiments, the UE receives a DL signal from a first TRP and transmits a UL signal to a second TRP.

Preferably in certain embodiments, the UE communicates with a serving cell comprising a first TRP and a second TRP.

Preferably in certain embodiments, an activated TCI state corresponds to the DL TCI state associated with the first TRP and the UL TCI state associated with the second TRP, and/or the activated TCI state corresponds to DL functionality and UL functionality of a 1-st joint TCI state and UL functionality of a 2-nd joint TCI state.

Preferably in certain embodiments, the UE receives a beam indication MAC CE for activating one or more DL/UL/joint TCI states.

Preferably in certain embodiments, the UE receives a beam indication DCI indicating one code-point from the beam indication MAC CE, and the TCI state(s) in the code-point is determined or considered as an indicated/used/applied TCI state.

Preferably in certain embodiments, the UE determines whether the PRACH transmission is associated with an SRS or a SS/PBCH based on at least one or any combination of the following: DCI format associated with the PDCCH order, which CORESET/search space is providing the PDCCH order, 1-st/2-nd TCI state associated with the CORESET providing the PDCCH order, an even/odd TTI associated with the PDCCH order, or a TCI state field in the PDCCH order.

Preferably in certain embodiments, the PRACH occasion (for the PRACH transmission in response to the PDCCH order) is determined based on an RS field (e.g., SS/PBCH index field or SRS index field) in the PDCCH order.

Preferably in certain embodiments, the PRACH occasion (for the PRACH transmission in response to the PDCCH order) is determined based on the TCI field in the PDCCH order.

Preferably in certain embodiments, the PRACH occasion (for the PRACH transmission in response to the PDCCH order) may be further determined based on a dedicated PRACH configuration.

Preferably in certain embodiments, a spatial filter or beam for transmitting PRACH is associated with an RS indicated by the RS field in the PDCCH order.

Preferably in certain embodiments, a source RS associated with a spatial filter or beam for transmitting PRACH is determined based on any one or any combination of the following: specific field in the PDCCH order, DCI format for the PDCCH order, and/or association between PRACH occasion and SS/PBCH or SRS, and/or a dedicated PRACH configuration, and/or a joint/UL TCI state corresponding to CORESET for providing the PDCCH order.

Preferably in certain embodiments, the UE performs the PRACH transmission on a PRACH occasion (determined by a second RS) via a spatial filter or beam associated with a first RS.

Preferably in certain embodiments, the first RS corresponds to SRS, and/or the second RS corresponds to SS/PBCH.

Preferably in certain embodiments, both the first RS and the second RS correspond to SS/PBCH.

Preferably in certain embodiments, both the first RS and the second RS correspond to SRS.

Preferably in certain embodiments, the dedicated PRACH configuration provides association between the PRACH occasion and the first RS.

Preferably in certain embodiments, the dedicated PRACH configuration provides association between the PRACH occasion and the second RS.

Preferably in certain embodiments, when a specific field in the PDCCH order indicates a first value, the first RS corresponds to SRS.

Preferably in certain embodiments, when a specific field in the PDCCH order indicates a second value, the first RS corresponds to SRS.

Preferably in certain embodiments, when DCI format for the PDCCH order corresponds to a first kind of DCI format (e.g., DCI format 1_0), the first RS corresponds to SS/PBCH.

Preferably in certain embodiments, when DCI format for the PDCCH order corresponds to a second kind of DCI format (e.g., DCI format 0_0), the first RS corresponds to SRS.

Preferably in certain embodiments, when a first CORESET for the PDCCH order is configured with following a 1-st joint TCI state (or 1-st UL TCI state) or being associated with the first TRP, the first RS corresponds to SS/PBCH.

Preferably in certain embodiments, when a second CORESET for the PDCCH order is configured with following a 2-nd joint TCI state (or 2-nd UL TCI state) or being associated with the second TRP, the first RS corresponds to SRS.

Preferably in certain embodiments, the UE is configured with a first set of SSs/PBCHs being associated with the first TRP and a second set of SSs/PBCHs being associated with the second TRP.

Preferably in certain embodiments, when the SS/PBCH index field in the PDCCH order indicates SS/PBCH which is in a first set of SSs/PBCHs being associated with the first TRP, the first RS corresponds to SS/PBCH.

Preferably in certain embodiments, when the SS/PBCH index field in the PDCCH order indicates SS/PBCH which is in a second set of SSs/PBCHs being associated with the second TRP, the first RS corresponds to SRS.

Preferably in certain embodiments, when the PDCCH order is received in an even TTI, the first RS corresponds to SS/PBCH.

Preferably in certain embodiments, when the PDCCH order is received in an odd TTI, the first RS corresponds to SRS.

Preferably in certain embodiments, association between the PRACH occasion and SS/PBCH or SRS is configured by a dedicated PRACH configuration.

Preferably in certain embodiments, the dedicated PRACH configuration configures a plurality of resource(s) or RS(s) comprising a first set of RS(s) associated with the first TRP and a second set of RS(s) associated with the second TRP.

Preferably in certain embodiments, the dedicated PRACH configuration configures one or more PRACH occasions associated with one resource or one RS from a plurality of resource(s) or a plurality of RS(s).

Preferably in certain embodiments, the UE is operating in sDCI mTRP.

Preferably in certain embodiments, the UE is not configured with CORESETPoolIndex for any serving cell.

Preferably in certain embodiments, the UE is configured with a specific CORESET/search space for the PDCCH order associated with SRS.

Preferably in certain embodiments, when the UE receives a PDCCH order in the specific CORESET/search space, the first RS corresponds to SRS.

Preferably in certain embodiments, the PDCCH order comprises a TCI field, and/or a source RS of the TCI state indicated by the TCI field or the QCL type-D source RS of the TCI state indicated by the TCI field corresponds to the first RS (e.g., the first RS corresponds to such source RS).

Preferably in certain embodiments, when the UE receives parameters/(re)configuration associated with the UL only TRP or enabled with the UL only TRP, the PDCCH order comprises a TCI field (instead of the SS/PBCH index field).

Preferably in certain embodiments, the TCI field in the PDCCH order indicates or provides an RS associated with a dedicated PRACH configuration.

Preferably in certain embodiments, the TCI field in the PDCCH order indicates or provides the first RS (as a spatial filter for transmitting PRACH).

Preferably in certain embodiments, the TCI field in the PDCCH order indicates or provides the second RS (for determining the PRACH occasion).

Preferably in certain embodiments, the PDCCH order comprises both a TCI field and an SS/PBCH index field.

Preferably in certain embodiments, the SS/PBCH field provides the second RS.

Preferably in certain embodiments, the TCI field provides the first RS.

Preferably in certain embodiments, based on the source RS of the TCI state indicated by the TCI field corresponds to SS/PBCH or SRS, the UE determines a PRACH occasion associated with SS/PBCH or SRS.

Preferably in certain embodiments, when the source RS of the TCI state indicated by the TCI field corresponds to SS/PBCH, the PRACH occasion is associated with SS/PBCH in a dedicated/common PRACH configuration.

Preferably in certain embodiments, when the source RS of the TCI state indicated by the TCI field corresponds to SRS, the PRACH occasion is associated with SRS in a dedicated PRACH configuration.

Preferably in certain embodiments, the UE is configured with an SRS resource set being associated with an SRS resource in the dedicated PRACH configuration, and/or a SRS resource index in the dedicated PRACH configuration is associated with the SRS resource set.

Preferably in certain embodiments, when identifying an SRS resource in the dedicated PRACH configuration, signaling may provide an SRS resource set index and an SRS resource index.

Preferably in certain embodiments, the PRACH occasion associated with SS/PBCH is determined by a common PRACH configuration.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive configuration of a UL only TRP and receiving a PDCCH order from a network node; and (ii) perform PRACH transmission in response to the PDCCH order. Moreover, the CPU 308 can execute the program code 312 to perform all of the described actions, steps, and methods described above, below, or otherwise herein.

It is noted that any of the methods, alternatives, steps, examples, and embodiments proposed above and herein may be applied independently, individually, and/or with multiple methods, alternatives, steps, examples, and embodiments combined together.

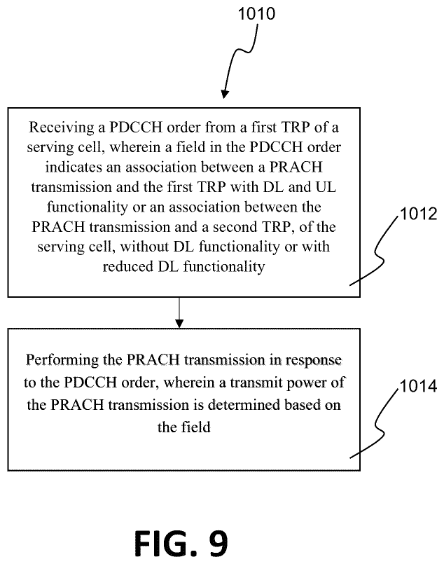

Referring to FIG. 9, with this and other concepts, systems, and methods of the present invention, a method 1010 for a UE in a wireless communication system comprises receiving a PDCCH order from a first TRP of a serving cell, wherein a field in the PDCCH order indicates an association between a PRACH transmission and the first TRP with DL and UL functionality or an association between the PRACH transmission and a second TRP, of the serving cell, without DL functionality or with reduced DL functionality (step 1012), and performing the PRACH transmission in response to the PDCCH order, wherein a transmit power of the PRACH transmission is determined based on the field (step 1014).

In various embodiments, if the field indicates a first value, the transmit power of the PRACH transmission is determined as a first transmit power, wherein the PRACH transmission is to the first TRP, and/or if the field indicates a second value, the transmit power of the PRACH transmission is determined as a second transmit power, wherein the PRACH transmission is to the second TRP, and/or the first transmit power is larger than the second transmit power, and/or the first transmit power is different than the second transmit power.

In various embodiments, no matter whether the field indicates the first value or the second value, the UE determines or uses a PL RS associated with the first TRP for determining a pathloss estimate for determining the transmit power of the PRACH transmission.

In various embodiments, a PL RS for determining a pathloss estimate for determining the transmit power of the PRACH transmission is associated with the first TRP, and/or even if the PRACH transmission is transmitted to the second TRP, the UE determines or uses the PL RS associated with the first TRP for determining the pathloss estimate for determining the transmit power of the PRACH transmission.

In various embodiments, the field is enabled or exists or is a valid bit field in the PDCCH order when the UE receives a parameter or a signaling or a configuration or a reconfiguration associated with the field, and/or the field is enabled or exists or is a valid bit field in the PDCCH order when the UE is configured with at least the second TRP, and/or the parameter or the signaling or the configuration or the reconfiguration associated with the field corresponds to a UL only TRP, and/or when a random access preamble index field in the PDCCH order indicates all zeros, the field is reserved.

In various embodiments, the UE is configured with two SRS power control processes for the serving cell, and/or one of the two SRS power control processes is associated with the first TRP and another of the two SRS power control processes is associated with the second TRP, and/or when the UE is configured with the serving cell comprising a UL only TRP or a TRP with reduced DL functionality, the UE is configured with the two SRS power control processes for the serving cell.

In various embodiments, the UE does not report capability of supporting multi-DCI based multiple TRPs, and/or the UE reports capability of supporting multi-DCI based multiple TRPs.

In various embodiments, the UE receives one or more CORESET configurations associated with the serving cell, and wherein a parameter for configuring CORESETPoolIndex is absent in the one or more CORESET configurations, and/or the UE receives one or more CORESET configurations associated with the serving cell, and wherein a parameter for configuring CORESETPoolIndex is absent in the one or more CORESET configurations.

In various embodiments, the UE performs the PRACH transmission to the first TRP or the second TRP based on the field.

In various embodiments, the UE receives one or more DL signal indicating a first TCI state and a second TCI state, and/or the first TRP means or corresponds to the first TCI state, and/or the second TRP means or corresponds to the second TCI state.

In various embodiments, if the UE is configured with a joint TCI state mode, both the first TCI state and the second TCI state are or correspond to joint TCI state, and/or the UE determines the second TCI state is applied with UL functionality or is applied to one or more UL channels and/or the UE determines the second TCI state is not applied with DL functionality or is not applied to one or more DL channels, and/or the UE determines the first TCI state is applied with DL and UL functionality or is applied to one or more UL channels and one or more DL channels.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive a PDCCH order from a first TRP of a serving cell, wherein a field in the PDCCH order indicates an association between a PRACH transmission and the first TRP with DL and UL functionality or an association between the PRACH transmission and a second TRP, of the serving cell, without DL functionality or with reduced DL functionality; and (ii) perform the PRACH transmission in response to the PDCCH order, wherein a transmit power of the PRACH transmission is determined based on the field. Moreover, the CPU 308 can execute the program code 312 to perform all of the described actions, steps, and methods described above, below, or otherwise herein.

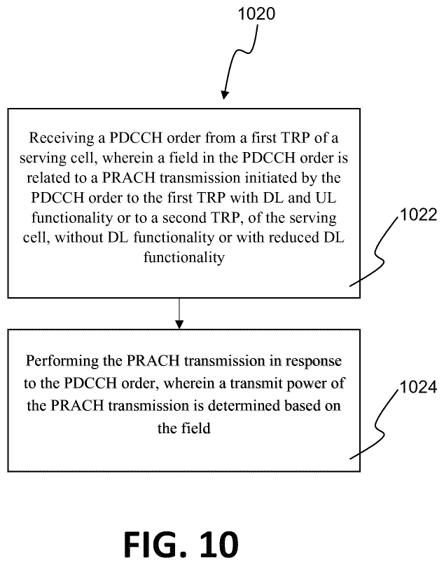

Referring to FIG. 10, with this and other concepts, systems, and methods of the present invention, a method 1020 for a UE in a wireless communication system comprises receiving a PDCCH order from a first TRP of a serving cell, wherein a field in the PDCCH order is related to a PRACH transmission initiated by the PDCCH order to the first TRP with DL and UL functionality or to a second TRP, of the serving cell, without DL functionality or with reduced DL functionality (step 1022), and performing the PRACH transmission in response to the PDCCH order, wherein a transmit power of the PRACH transmission is determined based on the field (step 1024).

In various embodiments, if the field indicates a first value, the transmit power of the PRACH transmission is determined as a first transmit power, wherein the PRACH transmission is to the first TRP, and/or if the field indicates a second value, the transmit power of the PRACH transmission is determined as a second transmit power, wherein the PRACH transmission is to the second TRP, and/or the first transmit power is larger than the second transmit power, and/or the first transmit power is different than the second transmit power.

In various embodiments, no matter whether the field indicates the first value or the second value, the UE determines or uses a PL RS associated with the first TRP for determining a pathloss estimate for determining the transmit power of the PRACH transmission.

In various embodiments, a PL RS for determining a pathloss estimate for determining the transmit power of the PRACH transmission is associated with the first TRP, and/or even if the PRACH transmission is transmitted to the second TRP, the UE determines or uses the PL RS associated with the first TRP for determining the pathloss estimate for determining the transmit power of the PRACH transmission.

In various embodiments, the field is enabled or exists or is a valid bit field in the PDCCH order when the UE receives a parameter or a signaling or a configuration or a reconfiguration associated with the field, and/or the field is enabled or exists or is a valid bit field in the PDCCH order when the UE is configured with at least the second TRP, and/or the parameter or the signaling or the configuration or the reconfiguration associated with the field corresponds to a UL only TRP, and/or when a random access preamble index field in the PDCCH order indicates all zeros, the field is reserved.

In various embodiments, the UE is configured with two SRS power control processes for the serving cell, and/or one of the two SRS power control processes is associated with the first TRP and another of the two SRS power control processes is associated with the second TRP, and/or when the UE is configured with the serving cell comprising the UL only TRP or a TRP with reduced DL functionality, the UE is configured with the two SRS power control processes for the serving cell.

In various embodiments, the UE does not report capability of supporting multi-DCI based multiple TRPs, and/or the UE reports capability of supporting multi-DCI based multiple TRPs.

In various embodiments, the UE receives one or more CORESET configurations associated with the serving cell, wherein a parameter for configuring CORESETPoolIndex is absent in the one or more CORESET configurations.

In various embodiments, the UE performs the PRACH transmission to the first TRP or the second TRP based on the field.

In various embodiments, the UE receives one or more DL signals indicating a first TCI state and a second TCI state, and/or the first TRP means or corresponds to the first TCI state, and/or the second TRP means or corresponds to the second TCI state.

In various embodiments, if the UE is configured with a joint TCI state mode, both the first TCI state and the second TCI state are or correspond to joint TCI state, and/or the UE determines the second TCI state is applied with UL functionality or is applied to one or more UL channels and/or the UE determines the second TCI state is not applied with DL functionality or is not applied to one or more DL channels, and/or the UE determines the first TCI state is applied with DL and UL functionality or is applied to one or more UL channels and one or more DL channels.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive a PDCCH order from a first TRP of a serving cell, wherein a field in the PDCCH order is related to a PRACH transmission initiated by the PDCCH order to the first TRP with DL and UL functionality or to a second TRP, of the serving cell, without DL functionality or with reduced DL functionality; and (ii) perform the PRACH transmission in response to the PDCCH order, wherein a transmit power of the PRACH transmission is determined based on the field. Moreover, the CPU 308 can execute the program code 312 to perform all of the described actions, steps, and methods described above, below, or otherwise herein.

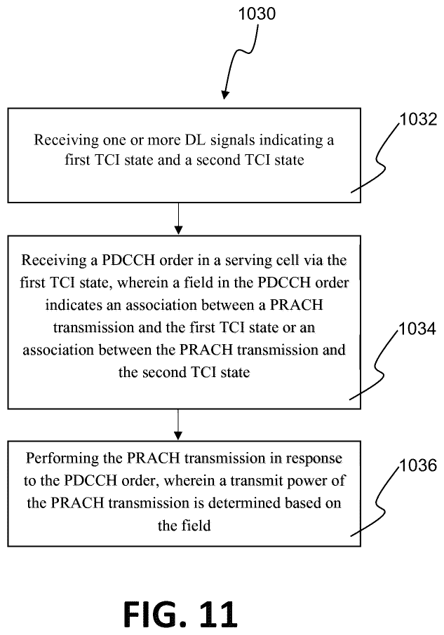

Referring to FIG. 11, with this and other concepts, systems, and methods of the present invention, a method 1030 for a UE in a wireless communication system comprises receiving one or more DL signals indicating a first TCI state and a second TCI state (step 1032), receiving a PDCCH order in a serving cell via the first TCI state, wherein a field in the PDCCH order indicates an association between a PRACH transmission and the first TCI state or an association between the PRACH transmission and the second TCI state (step 1034), and performing the PRACH transmission in response to the PDCCH order, wherein a transmit power of the PRACH transmission is determined based on the field (step 1036).

In various embodiments, if the field indicates a first value, the transmit power of the PRACH transmission is determined as a first transmit power, wherein the PRACH transmission is associated with the first TCI state, and/or if the field indicates a second value, the transmit power of the PRACH transmission is determined as a second transmit power, wherein the PRACH transmission is associated with the second TCI state, and/or the first transmit power is larger than the second transmit power, and/or the first transmit power is different than the second transmit power.

In various embodiments, no matter whether the field indicates the first value or the second value, the UE determines or uses a PL RS associated with the first TCI state for determining a pathloss estimate for determining the transmit power of the PRACH transmission.

In various embodiments, a PL RS for determining a pathloss estimate for determining the transmit power of the PRACH transmission is associated with the first TCI state, and/or even if the PRACH transmission is associated with the second TCI state, the UE determines or uses the PL RS associated with the first TCI state for determining the pathloss estimate for determining the transmit power of the PRACH transmission.

In various embodiments, the field is enabled or exists or is a valid bit field in the PDCCH order when the UE receives a parameter or a signaling or a configuration or a reconfiguration associated with the field, and/or the field is enabled or exists or is a valid bit field in the PDCCH order when the UE is configured with at least the second TCI state which is applied for one or more UL channels only, and/or the parameter or the signaling or the configuration or the reconfiguration associated with the field corresponds to a UL only TRP, and/or when a random access preamble index field in the PDCCH order indicates all zeros, the field is reserved.

In various embodiments, the UE is configured with two SRS power control processes for the serving cell, and/or one of the two SRS power control processes is associated with the first TCI state and another of the two SRS power control processes is associated with the second TCI state, and/or when the UE is configured with the serving cell comprising a UL only TRP or a TRP with reduced DL functionality, the UE is configured with the two SRS power control processes for the serving cell.

In various embodiments, the UE does not report capability of supporting multi-DCI based multiple TRPs, and/or the UE reports capability of supporting multi-DCI based multiple TRPs.

In various embodiments, the UE receives one or more CORESET configurations associated with the serving cell, wherein a parameter for configuring CORESETPoolIndex is absent in the one or more CORESET configurations.

In various embodiments, the UE performs the PRACH transmission via the first TCI state or the second TCI state based on the field, and/or the UE determines the transmit power of the PRACH transmission via using the first TCI state or via the second TCI state based on the field.

In various embodiments, if the UE is configured with a joint TCI state mode, both the first TCI state and the second TCI state are or correspond to joint TCI state, and/or the UE determines the second TCI state is applied with UL functionality or is applied to one or more UL channels and/or the UE determines the second TCI state is not applied with DL functionality or is not applied to one or more DL channels, and/or the UE determines the first TCI state is applied with DL and UL functionality or is applied to one or more UL channels and one or more DL channels.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive one or more DL signals indicating a first TCI state and a second TCI state; (ii) receive a PDCCH order in a serving cell via the first TCI state, wherein a field in the PDCCH order indicates an association between a PRACH transmission and the first TCI state or an association between the PRACH transmission and the second TCI state; and (iii) perform the PRACH transmission in response to the PDCCH order, wherein a transmit power of the PRACH transmission is determined based on the field. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a User Equipment (UE), comprising:
receiving a Physical Downlink Control Channel (PDCCH) order from a first Transmission/Reception Point (TRP) of a serving cell, wherein a field in the PDCCH order indicates an association between a Physical Random Access Channel (PRACH) transmission and the first TRP with Downlink (DL) and Uplink (UL) functionality or an association between the PRACH transmission and a second TRP, of the serving cell, without DL functionality or with reduced DL functionality; and
performing the PRACH transmission in response to the PDCCH order, wherein a transmit power of the PRACH transmission is determined based on the field.

2. The method of claim 1, wherein:
if the field indicates a first value, the transmit power of the PRACH transmission is determined as a first transmit power, wherein the PRACH transmission is to the first TRP, and/or
if the field indicates a second value, the transmit power of the PRACH transmission is determined as a second transmit power, wherein the PRACH transmission is to the second TRP, and/or
the first transmit power is larger than the second transmit power, and/or
the first transmit power is different than the second transmit power.

3. The method of claim 2, wherein no matter whether the field indicates the first value or the second value, the UE determines or uses a Pathloss Reference Signal (PL RS) associated with the first TRP for determining a pathloss estimate for determining the transmit power of the PRACH transmission.

4. The method of claim 1, wherein:
a PL RS for determining a pathloss estimate for determining the transmit power of the PRACH transmission is associated with the first TRP, and/or
even if the PRACH transmission is transmitted to the second TRP, the UE determines or uses the PL RS associated with the first TRP for determining the pathloss estimate for determining the transmit power of the PRACH transmission.

5. The method of claim 1, wherein:
the field is enabled or exists or is a valid bit field in the PDCCH order when the UE receives a parameter or a signaling or a configuration or a reconfiguration associated with the field, and/or
the field is enabled or exists or is a valid bit field in the PDCCH order when the UE is configured with at least the second TRP, and/or
the parameter or the signaling or the configuration or the reconfiguration associated with the field corresponds to a UL only TRP, and/or
when a random access preamble index field in the PDCCH order indicates all zeros, the field is reserved.

6. The method of claim 1, wherein:
the UE is configured with two Sounding Reference Signal (SRS) power control processes for the serving cell, and/or
one of the two SRS power control processes is associated with the first TRP and another of the two SRS power control processes is associated with the second TRP, and/or
when the UE is configured with the serving cell comprising a UL only TRP or a TRP with reduced DL functionality, the UE is configured with the two SRS power control processes for the serving cell.

7. The method of claim 1, wherein:
the UE does not report capability of supporting multi-Downlink Control Information (DCI) based multiple TRPs, and/or
the UE reports capability of supporting multi-DCI based multiple TRPs, and/or
the UE receives one or more Control Resource Set (CORESET) configurations associated with the serving cell, and wherein a parameter for configuring CORESETPoolIndex is absent in the one or more CORESET configurations.

8. The method of claim 1, wherein the UE performs the PRACH transmission to the first TRP or the second TRP based on the field.

9. The method of claim 1, the UE receives one or more DL signals indicating a first Transmission Configuration Indicator (TCI) state and a second TCI state, and/or
the first TRP means or corresponds to the first TCI state, and/or
the second TRP means or corresponds to the second TCI state.

10. The method of claim 9, wherein:
if the UE is configured with a joint TCI state mode, both the first TCI state and the second TCI state are or correspond to joint TCI state, and/or
the UE determines the second TCI state is applied with UL functionality or is applied to one or more UL channels and/or the UE determines the second TCI state is not applied with DL functionality or is not applied to one or more DL channels, and/or
the UE determines the first TCI state is applied with DL and UL functionality or is applied to one or more UL channels and one or more DL channels.

11. A method of a User Equipment (UE), comprising:
receiving one or more downlink (DL) signals indicating a first Transmission Configuration Indicator (TCI) state and a second TCI state;
receiving a Physical Downlink Control Channel (PDCCH) order in a serving cell via the first TCI state, wherein a field in the PDCCH order indicates an association between a Physical Random Access Channel (PRACH) transmission and the first TCI state or an association between the PRACH transmission and the second TCI state; and
performing the PRACH transmission in response to the PDCCH order, wherein a transmit power of the PRACH transmission is determined based on the field.

12. The method of claim 11, wherein:
if the field indicates a first value, the transmit power of the PRACH transmission is determined as a first transmit power, wherein the PRACH transmission is associated with the first TCI state, and/or
if the field indicates a second value, the transmit power of the PRACH transmission is determined as a second transmit power, wherein the PRACH transmission is associated with the second TCI state, and/or
the first transmit power is larger than the second transmit power, and/or
the first transmit power is different than the second transmit power.

13. The method of claim 12, wherein no matter whether the field indicates the first value or the second value, the UE determines or uses a Pathloss Reference Signal (PL RS) associated with the first TCI state for determining a pathloss estimate for determining the transmit power of the PRACH transmission.

14. The method of claim 11, wherein:
a PL RS for determining a pathloss estimate for determining the transmit power of the PRACH transmission is associated with the first TCI state, and/or
even if the PRACH transmission is associated with the second TCI state, the UE determines or uses the PL RS associated with the first TCI state for determining the pathloss estimate for determining the transmit power of the PRACH transmission.

15. The method of claim 11, wherein:
the field is enabled or exists or is a valid bit field in the PDCCH order when the UE receives a parameter or a signaling or a configuration or a reconfiguration associated with the field, and/or
the field is enabled or exists or is a valid bit field in the PDCCH order when the UE is configured with at least the second TCI state which is applied for one or more UL channels only, and/or
the parameter or the signaling or the configuration or the reconfiguration associated with the field corresponds to a UL only Transmission/Reception Point (TRP), and/or
when a random access preamble index field in the PDCCH order indicates all zeros, the field is reserved.

16. The method of claim 11, wherein:
the UE is configured with two Sounding Reference Signal (SRS) power control processes for the serving cell, and/or
one of the two SRS power control processes is associated with the first TCI state and another of the two SRS power control processes is associated with the second TCI state, and/or
when the UE is configured with the serving cell comprising a UL only TRP or a TRP with reduced DL functionality, the UE is configured with the two SRS power control processes for the serving cell.

17. The method of claim 11, wherein:
the UE does not report capability of supporting multi-Downlink Control Information (DCI) based multiple TRPs, and/or
the UE reports capability of supporting multi-DCI based multiple TRPs.

18. The method of claim 11, wherein the UE receives one or more Control Resource Set (CORESET) configurations associated with the serving cell, wherein a parameter for configuring CORESETPoolIndex is absent in the one or more CORESET configurations.

19. The method of claim 11, wherein:
the UE performs the PRACH transmission via the first TCI state or the second TCI state based on the field, and/or
the UE determines the transmit power of the PRACH transmission via using the first TCI state or via the second TCI state based on the field.

20. The method of claim 11, wherein:
if the UE is configured with a joint TCI state mode, both the first TCI state and the second TCI state are or correspond to joint TCI state, and/or
the UE determines the second TCI state is applied with UL functionality or is applied to one or more UL channels and/or the UE determines the second TCI state is not applied with DL functionality or is not applied to one or more DL channels, and/or
the UE determines the first TCI state is applied with DL and UL functionality or is applied to one or more UL channels and one or more DL channels.
